(19) United States
(12) Patent Application Publication
(10) Pub. No.: US 2024/0191129 A1
(43) Pub. Date: Jun. 13, 2024

(54) WATER-BASED FRICTION-REDUCING SLURRY COMPOSITIONS, FORMATION TREATING FLUIDS THEREFROM, AND METHOD FOR MAKING AND USING SAME

(71) Applicant: PfP INDUSTRIES LLC, Houston, TX (US)

(72) Inventors: Madhukar Chetty, Houston, TX (US); Nikhil Patel, Houston, TX (US); Asoke Kumar Deysarkar, Houston, TX (US)

(73) Assignee: PfP INDUSTRIES LLC, Houston, TX (US)

(21) Appl. No.: 18/380,554

(22) Filed: Oct. 16, 2023

Related U.S. Application Data
(60) Provisional application No. 63/416,333, filed on Oct. 14, 2022.
(60) Provisional application No. 63/421,621, filed on Nov. 2, 2022.

(51) Int. Cl. C09K 8/88; C09K 8/16; C09K 8/24; C09K 8/52; C09K 8/60; C09K 8/90

(52) U.S. Cl. CPC C09K 8/882; C09K 8/16; C09K 8/24; C09K 8/52; C09K 8/602; C09K 8/885; C09K 8/90; C09K 2208/22; C09K 2208/28

(57) ABSTRACT

Water-based friction reducing slurry compositions including a salt composition in an amount sufficient to result in undissolved salts in the water-based friction reducing slurry compositions designed to reduce or prevent hydration of the friction-reducing polymers in the water-based friction reducing slurry compositions during production, storage, and transportation, treating fluid compositions including a water-based friction reducing slurry compositions and methods of making the water-based friction reducing slurry compositions and the treating fluid compositions and methods of treating subterranean oil and/or gas bearing formations using the treating fluid compositions.

### RELATED APPLICATIONS

This application claims the benefit of and priority to U.S. Provisional Patent Application Ser. No. 63/416,333 filed Oct. 14, 2022 (14 Oct. 2022) and 63/421,621 filed Nov. 2, 2022 (2 Nov. 2022).

### BACKGROUND OF THE DISCLOSURE

### 1. Field of the Disclosure

Embodiments of the present disclosure relate to water-based friction reducing (WB-FR) slurry compositions and downhole fluid compositions including a WB-FR slurry composition of this disclosure, methods of making the WB-FR slurry compositions and the downhole fluid compositions including a slurry effective amount of a WB-FR slurry composition of this disclosure, methods of drilling into subterranean oil and/or gas bearing formations, and methods of treating subterranean oil and/or gas bearing formations.

In particular, embodiments of the present disclosure relate to WB-FR slurry compositions and downhole fluid compositions including a WB-FR slurry composition of this disclosure and methods of making the WB-FR slurry compositions and the downhole fluid compositions including a slurry effective amount of a WB-FR slurry composition of this disclosure, methods of drilling into subterranean oil and/or gas bearing formations, and methods of treating subterranean oil and/or gas bearing formations, wherein the WB-FR slurry compositions comprising a friction reducing (FR) base fluid, a dry particulate, water-soluble, friction reducing (DP-WS-FR) polymer composition, and an effective amount of a FR salt composition, wherein the FR salt composition reduce or prevent hydration of the DP-WS-FR polymer composition during storage and transportation. In certain embodiments, the WB-FR slurry compositions also include a FR acid composition. In other embodiments, the WB-FR slurry compositions also include a FR additive composition. In other embodiments, the WB-FR slurry compositions also include a FR surfactant composition.

### 2. Description of the Related Art

Treating fluids are used in a variety of subterranean treatment operations for a variety of different results. One subterranean treatment operation is hydraulic fracturing operations, which generally involve pumping a treating fluid (e.g., a fracturing fluid or a hydraulic fracturing fluid) into a wellbore that penetrates a subterranean oil and/or gas bearing formation under hydraulic conditions to create or enhance one or more cracks, or fractures, in the subterranean oil and/or gas bearing formation. The fracturing fluid may include particulates, often referred to as proppant particulates or simply proppants, that are deposited in the fractures. The proppants function, inter alia, to prevent the fractures from fully closing upon cassation the release of hydraulic pressure, forming conductive channels through which fluids and hydrocarbons may flow to the wellbore.

In one such approach, a slickwater hydraulic fracturing may be used. A slickwater hydraulic fracturing is a fracturing fluid that does not include a cross-linked polymer and has a relatively low viscosity as a result. Slickwater fracturing fluids may be used to generate narrow, complex fractures with low proppants concentrations. Because the viscosity of the fracturing fluid is relatively low, the proppant transport is achieved by increasing the pumping rate and pressure of the fracturing fluid. During pumping, significant energy loss often occurs due to friction between the fracturing fluid and the casing or tubing, particularly when the fracturing fluid is in turbulent flow.

Friction reducing compositions are often introduced into the slickwater fracturing during fracturing operations to minimize such energy loss due to fluid friction. The friction reducing compositions are typically uncross-linked as cross-linking often reduces friction reduction during pumping operations, and in fact, often results in increased friction. The friction reducing compositions facilitate laminar flow of the treating fluid, which causes less frictional forces and energy loss than turbulent flow of the same fluid.

While there are numerous friction reducing compositions both aqueous and non-aqueous friction reducing compositions have been developed and used, there is still a need in the art for new WB-FR slurry compositions for use in downhole fluids such as slickwater fracturing fluids, high viscosity fracturing fluids, other types of fracturing fluids, treating fluids, and drilling fluids.

### SUMMARY OF THE DISCLOSURE

### FR Slurry Compositions

### Salt Concentration Above Salt Saturation Concentration

Embodiments of this disclosure provide water-based, friction reducing (WB-FR) slurry compositions comprising a friction-reducing (FR) base fluid, a dry particulate, water-soluble, friction-reducing (DP-WS-FR) polymer composition and a FR salt effective amount of a FR salt composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation.

In certain embodiments, the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition.

In certain embodiments, the DP-WS-FR composition includes one or more DP-WS-FR polymers or a mixture to two or more DP-WS-FR polymers.

In other embodiments, the WB-FR slurry compositions further comprising a FR acid composition.

In other embodiments, the WB-FR slurry compositions further comprising a FR additive composition.

In other embodiments, the WB-FR slurry compositions further comprising a FR surfactant composition.

Salt Concentration Above Salt Saturation Concentration with FR Acid Composition

Embodiments of this disclosure provide water-based friction reducing (WB-FR) slurry compositions comprise a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation and the FR acid effective amount of a FR acid composition is sufficient to reduce or prevent ammonia generation during production, storage, and transportation.

In certain embodiments, the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition, and the FR acid effective amount is between about 0.1 wt % and about 10 wt. % based on the amount of water in the WB-FR slurry composition.

In certain embodiments, the DP-WS-FR composition includes one or more DP-WS-FR polymers or a mixture to two or more DP-WS-FR polymers.

In other embodiments, the WB-FR slurry compositions further comprising a FR additive composition.

In other embodiments, the WB-FR slurry compositions further comprising a FR surfactant composition.

Salt Concentration Below Salt Saturation Concentration with FR Acid Composition

Embodiments of this disclosure provide water-based friction reducing (WB-FR) slurry compositions comprise a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration below a salt saturation concentration at 20° C. based on the amount of water in the WB-FR slurry composition, the FR salt effective amount and the FR acid effective amount are sufficient to reduce or prevent hydration of the DP-WS-FR polymer composition during production, storage, and transportation of the WB-FR slurry composition, and the FR acid effective amount is also sufficient to reduce or prevent ammonia generation during production, storage, and transportation of the WB-FR slurry composition.

In certain embodiments, the FR salt effective amount is between about 30 wt. % up to a salt saturation concentration at 20° C. and the FR acid effective amount is between about 0.1 wt % and about 10 wt. %.

In certain embodiments, the DP-WS-FR composition includes one or more DP-WS-FR polymers or a mixture to two or more DP-WS-FR polymers.

In other embodiments, the WB-FR slurry compositions further comprising a FR additive composition.

In other embodiments, the WB-FR slurry compositions further comprising a FR surfactant composition.

### Downhole Fluid Compositions

Embodiments of this disclosure provide downhole fluid compositions comprising a downhole base fluid, a downhole fluid additive composition, and a slurry effective amount of a WB-FR slurry composition of this disclosure, wherein the slurry effective amount is sufficient to reduce frictional drag or to reduce a percent drag reduction of the downhole fluid compositions as the downhole fluid compositions are pumped from the surface through a tubular apparatus and into subterranean oil and/or gas bearing formations during formation treatment operations under formation treatment conditions or circulated through a drill string during drilling operations under drilling conditions.

Embodiments of this disclosure provide fracturing fluid compositions comprising a fracturing base fluid, a fracturing fluid additive composition, and a slurry effective amount of a WB-FR slurry composition of this disclosure, wherein the slurry effective amount is sufficient to reduce fluid friction or to reduce a percent drag reduction of the fracturing fluid compositions as the fracturing fluid compositions are pumped from the surface through a tubular apparatus and into subterranean oil and/or gas bearing during formation fracturing operations under formation fracturing conditions.

Embodiments of this disclosure provide fracturing fluid compositions comprising a fracturing base fluid, a fracturing fluid additive composition, a slurry effective amount of a WB-FR slurry composition of this disclosure, and one or more proppants, wherein the slurry effective amount is sufficient to reduce fluid friction or to reduce a percent drag reduction of the fracturing fluid compositions as the fracturing fluid compositions are pumped from the surface through a tubular apparatus and into subterranean oil and/or gas bearing formations during formation fracturing operations under formation fracturing conditions.

Embodiments of this disclosure provide drilling fluid compositions comprising a drilling base fluid, a drilling fluid additive composition, and a slurry effective amount of a WB-FR slurry composition of this disclosure, wherein the slurry effective amount is sufficient to reduce fluid friction or reduce a percent drag during drilling into subterranean oil and/or gas bearing formations under drilling conditions.

### Methods of Making WB-FR Slurry Compositions

Embodiments of this disclosure provide methods for making a WB-FR slurry composition of this disclosure comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition and a FR salt effective amount of a FR salt composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation.

In certain embodiments, the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition.

In certain embodiments, the DP-WS-FR composition includes one or more DP-WS-FR polymers or a mixture to two or more DP-WS-FR polymers.

In other embodiments, the WB-FR slurry compositions further comprising a FR acid composition.

In other embodiments, the WB-FR slurry compositions further comprising a FR additive composition.

In other embodiments, the WB-FR slurry compositions further comprising a FR surfactant composition.

Embodiments of this disclosure provide methods for making a WB-FR slurry composition of this disclosure comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation and the FR acid effective amount of a FR acid composition is sufficient to reduce or prevent ammonia generation during production, storage, and transportation.

In certain embodiments, the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition, and the FR acid effective amount is between about 0.1 wt % and about 10 wt. % based on the amount of water in the WB-FR slurry composition.

In certain embodiments, the DP-WS-FR composition includes one or more DP-WS-FR polymers or a mixture to two or more DP-WS-FR polymers.

In other embodiments, the WB-FR slurry compositions further comprising a FR additive composition.

In other embodiments, the WB-FR slurry compositions further comprising a FR surfactant composition.

Embodiments of this disclosure provide methods for making a WB-FR slurry composition of this disclosure comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration below a salt saturation concentration at 20° C. based on the amount of water in the WB-FR slurry composition, the FR salt effective amount and the FR acid effective amount are sufficient to reduce or prevent hydration of the DP-WS-FR polymer composition during production, storage, and transportation of the WB-FR slurry composition, and the FR acid effective amount is also sufficient to reduce or prevent ammonia generation during production, storage, and transportation of the WB-FR slurry composition.

In certain embodiments, the FR salt effective amount is between about 30 wt. % and a salt saturation concentration at 20° C. and the FR acid effective amount is between about 0.1 wt % and about 10 wt. %.

In certain embodiments, the DP-WS-FR composition includes one or more DP-WS-FR polymers or a mixture to two or more DP-WS-FR polymers.

In other embodiments, the WB-FR slurry compositions further comprising a FR additive composition.

In other embodiments, the WB-FR slurry compositions further comprising a FR surfactant composition.

In certain embodiments, the mixing duration may be between about 0.5 hours to about 12 hours and the mixing speed may be between about 500 rpm and 5,000 rpm.

In certain embodiments, the mixing duration may be between about 1 hour to about 10 hours and the mixing speed may be between about 750 rpm and 5,000 rpm.

In other embodiments, the mixing duration may be between about 1 hour to about 10 hours and the mixing speed may be between about 1,000 rpm and 5,000 rpm.

In other embodiments, the mixing duration may be between about 2 hours to about 8 hours and the mixing speed may be between about 2,000 rpm and 5,000 rpm.

It should be recognized that temperatures during the making steps and during storage will affect the effective amount of the salt composition to result in between about 0.25 wt. % and about 20 wt. % of undissolved salts from the salt composition in the WB-FR slurry compositions.

### Method for Treating a Formation

Embodiments of this disclosure provide methods of treating subterranean oil and/or gas bearing formations comprising: (a) adding a slurry effective amount of a WB-FR slurry composition of this disclosure to a treating fluid composition, and (b) pumping or injecting the non-proppant containing treating fluid composition into the subterranean oil and/or gas bearing formations under treating conditions (e.g., at a temperature and pressure and for a time sufficient to create and extend a treatment) until a desired formation treatment is achieved, wherein the treating composition comprises a stimulation fluid composition, a slick water fracturing fluid, a low viscosity proppant containing fracturing fluid composition, a high viscosity non-proppant containing fracturing fluid composition, a high viscosity proppant containing fracturing fluid composition, or a low or high viscosity completion fluid composition.

Embodiments of this disclosure provide methods of a fracturing subterranean oil and/or gas bearing formation comprising: (a) adding a slurry effective amount of a WB-FR slurry composition of this disclosure to a fracturing fluid composition, and (b) pumping or injecting the fracturing fluid composition into the subterranean oil and/or gas bearing formation under fracturing conditions until a desired a fracturing network is formed.

Embodiments of this disclosure provide methods of a fracturing subterranean oil and/or gas bearing formation comprising: (a) adding a slurry effective amount of a WB-FR slurry composition of this disclosure to a fracturing fluid composition, (b) adding one or more proppants, and (c) pumping or injecting the fracturing fluid composition into the subterranean oil and/or gas bearing formation under fracturing conditions until a desired a fracturing network is formed.

Embodiments of this disclosure provide methods of fracturing a formation comprising: (a) adding a slurry effective amount of a WB-FR slurry composition of this disclosure to a non-proppant-containing fracturing fluid composition, (b) pumping or injecting the non-proppant-containing treating fluid composition into subterranean oil and/or gas bearing formations under non-proppant treating conditions, (c) adding a slurry effective amount of a WB-FR slurry composition of this disclosure to a proppant-containing fracturing fluid composition, and (d) pumping or injecting the proppant-containing fracturing fluid composition into the subterranean oil and/or gas bearing formation under proppant fracturing conditions, and (e) repeating steps (b) and (d) as required to form a desired fracture network and a desired proppant placement within fracture network within the subterranean oil and/or gas bearing formation.

Methods of Drilling into a Formation

Embodiments of this disclosure provide methods of drilling into a subterranean oil and/or gas bearing formation comprising (a) adding a slurry effective amount of a WB-FR slurry composition of this disclosure to a drilling fluid composition including (i) a drilling fluid base fluid composition and (ii) a drilling fluid additive composition, and (b) circulating the drilling fluid composition during drilling operations under drilling conditions.

### BRIEF DESCRIPTION OF THE DRAWINGS OF THE DISCLOSURE

The disclosure may be better understood with reference to the following detailed description together with the appended illustrative drawings in which like elements are numbered the same:

FIG. 1 depicts a well site including a borehole and a treating fluid supply system.

FIG. 2 depicts an embodiment of a treating fluid supply system.

### DEFINITIONS USED IN THE DISCLOSURE

All terms used in this disclose and in the attached claims will be given their plain, ordinary meaning unless otherwise explicitly and clearly defined below:

The term “at least one”, “one or more”, or “one or a plurality” are interchangeable within this disclosure and refers to one item or more than one items, e.g., at least one polymer, one or more polymers, or one or a plurality of polymers means one polymer or more than one polymers. While these are open ended terms, one of ordinary skill in the art will understand in the context of the terms being used that there are practical limitations to the opened endedness of the terms. Generally, the upper limit is less than or equal to about 20, sometimes less than or equal to about 15, sometimes less than or equal to about 10, or sometimes less than or equal to about 5.

The term “about” or “approximately” refers to the fact that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” or “essentially” refers to the fact that that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value. In other embodiments, the value is within ±0.01% of the stated value.

In this disclosure, every range of values (e.g., “from about x to about y” or “from approximately x to y” or “from approximately x-y” or “between about x and about y” or “between approximate x and y” or “between approximately x-y) is to be understood as referring to the ranges including end points and all subranges between x and y, e.g., between about X and Y includes all ranges x and y, where x is greater than X and y is less than Y.

The term “gpt” or “gptg” refers to gallons per thousand gallons.

The term “pptg” or “ppt” refers to pounds per thousand gallons.

The term “ppg” refers to pounds of particulates per gallon of treating fluid.

The term “wt. %” refers to weight percent.

The term “w/w” refers to weight per weight.

The term “vol. %” refers to volume percent.

The term “v/v” refers to volume per volume.

The term “w/v” refers to weight per volume.

The term “v/w” refers to volume per weight.

The term “saturated solution” refers to a chemical solution containing the maximum concentration of a solute dissolved in the solvent and is marked by the fact that additional solute will not dissolve in a saturated solution, i.e., the solute will be undissolved or a solid in the solution.

The term “downhole fluid(s)” or “downhole fluid composition(s)” refers to any fluid used to drill and/or treat a subterranean oil and/or gas bearing formations, including drilling fluids and treating fluid compositions.

The term “drilling” refers to drilling from a surface location into to any subterranean oil and/or gas bearing formation.

The term “drilling fluid(s)” or “drilling fluid composition(s)” refer to fluids or fluid compositions used in drilling an oil and/or gas well from a surface location into to any subterranean oil and/or gas bearing formation.

The terms “treat,” “treatment,” “treating,” and grammatical equivalents thereof refer to any subterranean oil and/or gas bearing formation operation that uses a fluid or fluid composition to achieve a desired function and/or for a desired purpose. Use of these terms does not imply any particular action by the treating fluid or fluid composition.

The term “treating fluid(s)” or “treating fluid composition(s)” refers to downhole fluids used in treating subterranean oil and/or gas bearing formations including, without limitation: (a) fracturing fluid compositions including slickwater fracturing fluid compositions, high viscosity treating fluid compositions, non-proppant-containing fracturing fluid compositions, and proppant-containing fracturing fluids, (b) completion fluid compositions, (c) stimulation fluid compositions, (d) zone isolation fluid compositions, or (e) any other downhole fluid composition.

The term “fracturing” refers to the process and methods of breaking down a geological formation, i.e., the rock formation around a well bore, by pumping fluid at very high pressures, in order to increase production rates from a hydrocarbon reservoir. The fracturing methods of this disclosure use otherwise conventional techniques known in the art.

The term “under treating conditions” refers to conditions for injecting or pumping a treating fluid into a formation at a sufficient pressure, at a sufficient temperature (normally not an issue), and for a time sufficient to achieve a desired formation treatment.

The term “under fracturing conditions” refers to conditions for injecting or pumping a fracturing fluid into a formation at a sufficient pressure, at a sufficient temperature (normally not an issue), and for a time sufficient to form fractures or fissures or fracture network in the formation. When the fracturing fluid includes one or more proppants, then the conditions are also sufficient to achieve a desired proppant placement profile or concentration profile within the fractures or fissures or fracture network formed within the formation.

The term “cracks”, “microcracks”, “fissures”, “microfissures”, “fractures”, or “microfactures” refers to create or enhance openings in the formation, where the term micro refers to smaller openings in the formation. Under fracturing conditions, the enhanced or created openings of fractures will generally have an elongated profile.

The term “proppant” refers to a granular substance suspended in the fracturing fluid during the fracturing operation, which serves to keep the formation from closing back down upon itself once the pumping pressure is released. Proppants envisioned by the present disclosure include, but are not limited to, conventional proppants familiar to those skilled in the art such as sand, 20-40 mesh sand, resin-coated sand, sintered bauxite, glass beads, particular plant materials, and other solid materials using a proppant in fracturing operations.

The term “friction reducing (FR) polymers” refers to polymers used to reduce friction of a fracturing fluid as it is pumped through fracturing mechanisms into the formation to be fractured or to reduce frictional losses due to friction between an aqueous fluid in turbulent flow and tubular goods (e.g., pipes, coiled tubing, etc.) and/or the formation.

The term “FR base fluid” refers to the major component of the WB-FR slurry compositions of this disclosure (as opposed to components dissolved and/or suspended therein), and does not indicate any particular condition or property of that fluid such as its mass, amount, pH, etc.

The term “polymer” or “polymeric material” means or includes natural and synthetic homopolymers, copolymers, terpolymers, etc.

The term “copolymer,” as used herein, means natural and synthetic polymers including two or more monomers or monomeric units, e.g., terpolymers, tetrapolymers, etc.

The term “aqueous base fluid” refers to base fluids used in the water-based friction reducing additive of the present disclosure may include water from any source, which may include fresh water, saltwater (e.g., water containing one or more salts dissolved therein), brine (e.g., saturated saltwater), seawater, produced water, surface water (e.g., from a river or a pond), reclaimed water, any other water useable in downhole operations, or any combination thereof.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only and are not exhaustive of the scope of the disclosure.

### DETAILED DESCRIPTION OF THE DISCLOSURE

The inventors have found that water-based friction reducing (WB-FR) slurry compositions may be formulated including a friction reducing (FR) base fluid, a dry, particulate, water-soluble, friction reducing (DP-WS-FR) polymer composition, and an effective amount of a FR salt composition designed to reduce or prevent hydration of the DP-WS-FR polymer(s) in the WB-FR slurry composition during production, storage, and transportation. In certain embodiments, the WB-FR slurry compositions further include a FR acid composition. In certain embodiments, the WB-FR slurry compositions further include a FR additive composition. In certain embodiments, the WB-FR slurry compositions further include a FR surfactant composition. In other embodiments, the DP-WS-FR polymer composition may include a mixture of two or more DP-WS-FR polymers.

In certain embodiments, the salt effective amount of the FR salt composition is sufficient to result in undissolved salt crystals of the FR salt composition in the WB-FR slurry compositions. Alternatively, the effective amount of the salt composition is sufficient to produce a salt concentration between about 0.25 wt. % and about 20 wt. % above a salt saturation concentration at 20° C. of the salt or salts in the FR salt composition, i.e., the salt effective amount is sufficient to result in between about 0.25% and about 20% of undissolved salt in the WB-FR slurry compositions. In other embodiments, the WB-FR slurry compositions further include a FR acid effective amount of a FR acid composition, wherein the FR acid effective amount is between about 0.1 wt. % and about 10 wt. % and is sufficient to reduce or prevent hydration of the DP-WS-FR polymer(s) in the WB-FR slurry composition during production, storage, and transportation in conjunction with the FR salt composition and to reduce or eliminate generated ammonia.

In certain embodiments, the salt effective amount of the FR salt composition is below a salt saturation concentration at 20° C. of the salt or salts in the FR salt composition and the FR salt effective amount in conjunction with the FR acid effective amount are sufficient to reduce or prevent hydration of the DP-WS-FR polymer(s) in the WB-FR slurry composition during production, storage, and transportation in conjunction with the FR salt composition and to reduce or eliminate generated ammonia, which could render the WB-FR slurry compositions and the downhole fluid compositions including the WB-FR slurry compositions a safety hazard or a hazardous material. In other embodiments, the FR salt effective amount is between about 30 wt. % and a salt saturation concentration at 20° C. and the FR acid effective amount is between about 0.1 wt % and about 10 wt. %.

The WB-FR slurry compositions are designed to: (a) have improved or equivalent hydration rates when added to aqueous downhole fluid compositions compared to aqueous downhole fluid compositions that do not include undissolved salt in the WB-FR slurry compositions, (b) once hydrated, have improved or equivalent reduced frictional drag or reduced percent drag reduction (% Drag Reduction or % DR) compared to downhole fluid compositions that do not include undissolved salt or salts in the WB-FR slurry compositions, and (c) have improved or equivalent proppant delivery and placement properties compared to downhole fluid compositions that do not include the WB-FR slurry compositions. Further, the inventors believe that WB-FR slurry compositions with salts concentrations above a salt saturation concentration are unique. Additionally, the inventors believe that WB-FR slurry compositions including a FR acid composition is unique and that WB-FR slurry compositions including a FR salt composition in a FR salt effective amount below a salt saturation concentration of the salt or salts in the FR salt composition and a FR acid composition in a FR acid effective amount are unique. Moreover, the WB-FR slurry compositions may be formulated to be “green” or more environmentally friendly or more biodegradable compared to slurry compositions including oils, solvents, and non-biodegradable surfactants.

There are numerous potential advantages associated with the use of the WB-FR slurry compositions of this disclosure in: (a) downhole fluid compositions such as treating fluid compositions including slickwater fracturing fluid compositions, low viscosity fracturing fluids, high viscosity fracturing, stimulating fluid compositions, completion fluid compositions, or drilling fluid compositions and (b) methods of treating a formation or methods of drilling into a formation. One such advantage involves the improvement of friction reducing properties to downhole fluid compositions. Another advantage of the WB-FR slurry compositions of this disclosure is the compositions are easier to prepare compared to other WB-FR slurry compositions as no temperature control is generally required compared to others where the salt dissolution can be exothermic. This preparation advantage may manifest itself in time savings which equate to money savings.

In certain embodiments, the WB-FR slurry compositions of this disclosure, when added to a downhole fluid compositions such as treating fluid compositions including slickwater fracturing fluid compositions, low viscosity fracturing fluids, high viscosity fracturing, stimulating fluid compositions, completion fluid compositions, or drilling fluid compositions, results in a reduction of a fluid friction or frictional drag or a percent drag reduction (% Drag Reduction or % DR) generated as a downhole fluid compositions containing a WB-FR slurry composition of this disclosure are pumped or injected through a tubular mechanism or apparatus into one or more subterranean oil and/or gas bearing formations or reduce a friction or frictional drag or a percent drag reduction (% Drag Reduction or % DR) generated as a drilling fluid composition containing a WB-FR slurry composition of this disclosure as the drilling fluid compositions are circulated through a drill string while drilling into a formation.

In other embodiments, downhole fluid compositions including a WB-FR slurry composition of this disclosure, and methods of this disclosure reduce energy loss that results from friction between the downhole fluid compositions and the wellbore casing or tubing and injection devices if any or between the downhole fluid compositions and the drill string and other drilling equipment during drilling.

In other embodiments, downhole fluid compositions including a WB-FR slurry composition of this disclosure, and methods of using downhole fluid compositions including a WB-FR slurry composition of this disclosure will have the advantages set forth above compared to conventional friction reducing systems used in other downhole fluid compositions such as oil-based friction reducing systems due to the FR salt composition in the WB-FR slurry compositions of this disclosure.

In other embodiments, the compositions and methods of this disclosure relate to a water-based friction reducing additive that will enhance the suspension stability of the water-based friction reducing system, particularly as compared with certain conventional water-based friction reducing additives that may exhibit syneresis.

Drag reduction and proppant delivery are at least two of the primary functions of a friction reducing composition, especially the WB-FR slurry compositions of this disclosure. Using particle size to increase polymer loading also increases the hydration viscosity and the downhole viscosity creating better proppant carrying properties coupled with the amount of the FR salt composition in the WB-FR slurry compositions, which reduces or prevents hydration of the DP-WS-FR polymers in the WB-FR slurry compositions during production, storage, and transportation and which has equivalent or improve friction reduction properties and proppant delivery and placement properties compared to WB-FR slurry compositions of this disclosure.

In certain embodiments, a particle size or a particle size distribution of the DP-WS-FR polymer composition is used to control the concentration of the DP-WS-FR polymer composition that may be used in the WB-FR slurry compositions of this disclosure and ultimately in the downhole fluid compositions into which the WB-FR slurry compositions of this disclosure are added. For example, generally, the smaller the particle sizes of the DP-WS-FR polymers or the greater amount of small particles size in a particle size distribution, the higher a concentration of DP-WS-FR polymers that may be achieved.

In certain embodiments, the WB-FR slurry compositions of this disclosure include at least an aqueous FR base fluid, a FR salt composition, and a dry particulate, water-soluble, friction reducing (DP-WS-FR) polymer composition, wherein the FR salt composition reduces or prevents hydration of the DP-WS-FR polymers in the DP-WS-FR polymer composition during production, storage, and transportation of the WB-FR slurry compositions. In certain embodiments, the WB-FR slurry composition may further include a FR acid composition, a FR additive composition, a FR surfactant composition, or any mixture or combination thereof. In other embodiments, the DP-WS-FR polymer composition may include one or more DP-WS-FR polymers or a mixture of two or more DP-WS-FR polymers.

In other embodiments, the one or more FR additives or a FR additive composition may include one or more suspending and/or dispersing agents such as fumed silica, one or more clays, or any mixture or combination thereof. In other embodiments, the one or more clays may include nano-structured and/or micro-structured hydrophilic clays.

In certain embodiments, the downhole fluid compositions and methods of this disclosure include any aqueous FR base fluid or any aqueous downhole base fluid known in the art and any mixture or combination thereof. In other embodiments, the FR base fluid or the downhole base fluid do not have to possess any particular condition or any particular property such as its mass, amount, pH, etc. The FR base fluid or the downhole base fluid may comprise any water source, natural or synthetic and comprising any monovalent salt, any polyvalent salt, or any combinations of one or more monovalent salts or one or more polyvalent salts; provided that the polyvalent salts do not result in cross-linking of the DP-WS-FR polymers after hydration in low viscosity downhole fluids or slickwater downhole fracturing fluids.

In other embodiments, the density of the aqueous FR base fluid or the aqueous downhole base fluid for use in this disclosure may be adjusted, among other purposes, to provide additional particulate transport and suspension properties. In other embodiments, the pH of the aqueous FR base fluid or the aqueous downhole base fluid may be adjusted (e.g., by a buffer or other pH adjusting agent) to a specific level, which may depend on, among other factors, the types of polymers, nanoparticles, and/or other additives included in the aqueous FR base fluid or the aqueous downhole base fluid. It should be recognized that ordinary artisans based on this disclosure and their knowledge of the art, will recognize when such density and/or pH adjustments are appropriate. In other embodiments, the downhole fluid compositions of this disclosure may include a mixture of one or more base fluids and/or gases, that may result in emulsion, foam, or the like formation.

In certain embodiments, the FR additive compositions including one or more suspending/dispersing agents may increase the suspension stability of the DP-WS-FR polymers and in the downhole fluid composition including the WB-FR slurry compositions of this disclosure prior to and during hydration. For example, a suspending and/or dispersing agent may enhance the ability of the suspension to remain in a suspended state and/or resist change in the dispersed state of the WB-FR slurry composition. In other embodiments, the suspending and/or dispersing agent may reduce syneresis in the WB-FR slurry compositions of this disclosure. In other embodiments, the suspending and/or dispersing agent may enhance the solubility of the WB-FR slurry compositions of this disclosure. In other embodiments, the suspending and/or dispersing agent may enhance the elasticity of the WB-FR slurry compositions of this disclosure. In other embodiments, the suspending and/or dispersing agent may enhance the WB-FR slurry compositions of this disclosure. In other embodiments, the suspending and/or dispersing agent may include a clay. In certain embodiments, the clays include hydrophilic clays, fumed silica, or any other water suspending and/or dispersing agents. In other embodiments, the suspending and/or dispersing agent may include a mixture of a polymer and a clay.

In certain embodiments, the FR salt composition or the FR salt composition and the FR acid composition are added in amounts sufficient to reduce, decrease, or prevent a hydration rate or hydration of the DP-WS-FR polymers in the DP-WS-FR polymer compositions after addition and during production, storage, and transport of the WB-FR slurry compositions.

In other embodiments, the suspending and/or dispersing agent and the FR salt composition or the FR salt composition and the FR acid composition may increase the shelf life of the WB-FR slurry compositions of this disclosure.

In certain embodiments, the components of the present disclosure including the FR salt composition and the DP-WS-FR polymer composition may be combined together before being added to the FR base fluid composition, wherein the FR salt composition reduces or prevents hydration of the DP-WS-FR polymer composition in the WB-FR slurry compositions during production, storage, and transportation.

In other embodiments, the components of the present disclosure including the FR salt composition, the DP-WS-FR polymer composition, and the FR acid composition may be combined together before being added to the FR base fluid composition, wherein the FR salt composition and the FR acid composition reduces or prevents hydration of the DP-WS-FR polymers in the DP-WS-FR polymer composition in the WB-FR slurry compositions and the FR acid composition reduces or prevents or reacts with generated ammonia during production, storage, and transportation.

In other embodiments, the components of the present disclosure including the FR salt composition, the DP-WS-FR polymer composition, the FR acid composition, and the FR additive composition may be combined together before being added to the FR base fluid composition, wherein the FR salt composition and the FR acid composition reduces or prevents hydration of the DP-WS-FR polymers in the DP-WS-FR polymer composition in the WB-FR slurry compositions and the FR acid composition reduces or prevents or reacts with generated ammonia during production, storage, and transportation.

In other embodiments, the components of the present disclosure including the FR salt composition, the DP-WS-FR polymer composition, the FR acid composition, the FR additive composition, and the FR surfactant composition, may be combined together before being added to the FR base fluid composition, wherein the FR salt composition and the FR acid composition reduces or prevents hydration of the DP-WS-FR polymers in the DP-WS-FR polymer composition in the WB-FR slurry compositions and the FR acid composition reduces or prevents or reacts with generated ammonia during production, storage, and transportation.

In other embodiments, compositions including one or more of those components may be stored (e.g., in a tank or vessel) for a period of time before being added to the downhole fluid composition. In other embodiments, compositions including one or more of those components may be stored for up to 12 months before being added to the downhole fluid composition. In certain embodiments, the WB-FR slurry composition may also include a FR surfactant composition. In other embodiments, the DP-WS-FR polymer composition may include a mixture of two or more DP-WS-FR polymers.

In other embodiments, the FR additive compositions may increase the suspension stability of the present disclosure. For example, the FR additive compositions may enhance the ability of the present disclosure to remain in a suspended state and/or resist change in the dispersed state. In other embodiments, the WB-FR slurry compositions including the FR salt compositions, the FR acid compositions, and/or the FR additive compositions may be stable for up to 12 months before being added to a downhole fluid. In other embodiments, the WB-FR slurry compositions including the FR salt compositions, the FR acid compositions, and/or the FR additive compositions may be stable for up to 6 months before being added to a downhole fluid composition. In other embodiments, the WB-FR slurry compositions including the FR salt compositions, the FR acid compositions, and/or the FR additive compositions may be stable for at least 2 months before being added to the downhole fluid. In other embodiments, the WB-FR slurry compositions including the FR salt compositions, the FR acid compositions, and/or the FR additive compositions may be stable for at least 4 weeks before being added to the downhole fluid. In other embodiments, the WB-FR slurry compositions including the FR salt compositions, the FR acid compositions, and/or the FR additive compositions may be stable for at least 2 weeks before being added to the downhole fluid composition.

In other embodiments, the FR salt composition, the FR acid composition, the DP-WS-FR polymer composition, the FR additive composition, and/or the FR surfactant composition may be added separately to the aqueous FR base fluid to form the WB-FR slurry compositions of this disclosure.

In other embodiments, the WB-FR slurry composition may be prepared, and the amount of the WB-FR slurry composition added to a downhole fluid composition, may be directly metered into the treating fluid composition. In other embodiments, the WB-FR slurry composition may be added to the downhole fluid compositions by batch mixing or continuous (“on-the-fly”) mixing. The term “on-the-fly” is used herein to include methods of combining adding the WB-FR slurry composition in a flowing stream continuously introduced into a flowing stream of treating fluid or a component thereof so that the streams are combined and mixed while continuing to flow as a single stream as part of the ongoing treatment. Such mixing may also be described as “real-time” mixing. In other embodiments, the compositions (or one or more components thereof) may be pulsed into the treating fluid. In other embodiments, the compositions (or one or more components thereof) may be injected into a pipeline upstream of a tank or other suitable vessel containing the treating fluid composition. In other embodiments, the compositions (or one or more components thereof) may be directly added to the tank or other suitable vessel containing the treating fluid composition. Mixing duration may be between about 0.5 hours to about 12 hours and mixing speed may be between about 500 rpm and 5,000 rpm. In certain embodiments, the mixing duration may be between about 1 hour to about 10 hours and the mixing speed may be between about 750 rpm and 5,000 rpm. In other embodiments, the mixing duration may be between about 1 hour to about 10 hours and the mixing speed may be between about 1,000 rpm and 5,000 rpm. In other embodiments, the mixing duration may be between about 2 hour to about 8 hours and the mixing speed may be between about 2,000 rpm and 5,000 rpm.

In certain embodiments, the compositions or methods using the compositions of this disclosure may include adding a treating fluid additive composition to a downhole fluid composition including a WB-FR slurry composition of this disclosure. In other embodiments, the downhole fluid additive composition may be added to the downhole fluid composition after the WB-FR slurry composition of this disclosure has been added to the treating fluid composition. Examples of such treating fluid additives include, without limitation, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, antifoam agents, bridging agents, flocculants, H₂S scavengers, CO₂ scavengers, oxygen scavengers, lubricants, viscosifiers, breakers, weighting agents, relative permeability modifiers, resins, surfactants, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application.

In certain embodiments, the treating fluid compositions of this disclose comprise fracturing fluid compositions that may include one or more proppants or particulate fracture propping materials.

The treating fluid compositions of this disclosure may be introduced into a portion of a subterranean oil and/or gas bearing formation. The treating fluid compositions of this disclosure may be, for example, stimulation fluid compositions, hydraulic fracturing fluid compositions, or completion fluid compositions. In introducing a treating fluid composition of this disclosure into a portion of a subterranean oil and/or gas bearing formation, the components of the treating fluid composition may be mixed together at the surface (or offsite prior to transport to the wellsite) and introduced into the formation together, or one or more components may be separately introduced into the formation at the surface from other components such that the components mix or intermingle in a portion of the formation to form a treating fluid. In either such case, the treating fluid is deemed to be introduced into at least a portion of the subterranean oil and/or gas bearing formation for purposes of this disclosure.

This disclosure in some embodiments provides methods for using the treating fluid compositions to carry out hydraulic fracturing treatments (including fracture acidizing treatments). In other embodiments, a treating fluid composition of this disclosure may be introduced into a subterranean oil and/or gas bearing formation generally via a wellbore that penetrates the subterranean oil and/or gas bearing formation. In other embodiments, the treating fluid composition of this disclosure may be introduced at or above a pressure sufficient to create or enhance one or more fractures within the subterranean oil and/or gas bearing formation or any portion thereof. In other embodiments, the treating fluid composition may be introduced using one or more pumps. In other embodiments, the treating fluid composition used in these fracturing treatments may include a number of different types of fluids, including, without limitation, to pre-pad fluids, pad fluids, fracturing fluids, slickwater fluids, proppant-laden fluids, and the like.

In other embodiments, the treating fluid compositions of this disclosure may have a viscosity from about 50 cP or less, or alternatively, about 25 cP or less, or alternatively, about 15 cP or less. In other embodiments, the treating fluid of the present disclosure may have a viscosity from about 4 cP to about 15 cP at a shear rate of 511 s⁻¹. In other embodiments, the treating fluid of the present disclosure may have higher viscosities, e.g., up to about 1000 cP.

In certain embodiments, the viscosity of the treating fluid compositions of this disclosure may be significantly reduced (e.g., to about 1.5 cP or less) after a certain period of time, among other reasons, to facilitate pumping and/or flowback of the fluids after use. In other embodiments, the viscosity of the treating fluid compositions of this disclosure may be reduced by the addition or activation of a breaker additive (e.g., an acid or other chemical agent that may degrade the polymer), or when subjected to certain amounts of shear, heat, or other conditions. In other embodiments, the viscosity of the treating fluid compositions of this disclosure may decrease after the passage of sufficient time (e.g., within 24 hours, within 4 hours at temperatures of 140EF, or within about 0.5 hours at temperatures of 140F) without the addition of any breaker additives thereto or change of conditions.

### Composition Range Tables

### WB-FR Slurry Compositions Including Above a Saturation Concentration

The following table includes illustrative compositional ranges of the components for WB-FR slurry compositions of this disclosure having a FR salt concentration above a saturation concentration of the salt or salts in the at 20° C. based:

| | | DP- | | | | |
|---|---|---|---|---|---|---|
| FR Base | | WS-FR | FR | FR | FR | Salt:FRBF |
| Fluid | FR Salt(s)* | Polymer(s) | Acid(s) | Additive(s) | Surfactant(s) | wt. |
| wt. % | wt. % | wt. % | wt. % | wt. % | wt. % | ratio |
| remainder | 42.807 to 51.240 | 15 to 40 | 0.1 to 10 | 0.1 to 6 | 0 to 5 | 1 to 1 |
| remainder | 42.914 to 51.240 | 15 to 40 | 0.5 to 10 | 0.1 to 6 | 0 to 5 | 1 to 1.01 |
| remainder | 4.3020 to 51.240 | 15 to 40 | 1 to 10 | 0.1 to 6 | 0 to 5 | 1 to 1.02 |
| remainder | 43.127 to 51.240 | 15 to 40 | 0.1 to 7.5 | 0.1 to 6 | 0 to 5 | 1 to 1.03 |
| remainder | 43.768 to 51.240 | 15 to 40 | 0.5 to 7.5 | 0.1 to 6 | 0 to 5 | 1 to 1.04 |
| remainder | 44.835 to 51.240 | 15 to 40 | 1 to 7.5 | 0.1 to 6 | 0 to 5 | 1 to 1.05 |
| remainder | 45.903 to 51.240 | 15 to 40 | 0.1 to 5 | 0.1 to 6 | 0 to 5 | 1 to 1.10 |
| remainder | 46.970 to 51.240 | 15 to 40 | 0.5 to 5 | 0.1 to 6 | 0 to 5 | 1 to 1.1125 |
| remainder | 48.038 to 51.240 | 15 to 40 | 1 to 5 | 0.1 to 6 | 0 to 5 | 1 to 1.125 |
| remainder | 49.105 to 51.240 | 15 to 40 | 0.1 to 2.5 | 0.1 to 6 | 0 to 5 | 1 to 1.15 |
| remainder | 50.173 to 51.240 | 15 to 40 | 0.5 to 2.5 | 0.1 to 6 | 0 to 5 | 1 to 1.175 |
| remainder | 51.240 | 15 to 40 | 1 to 2.5 | 0.1 to 6 | 0 to 5 | 1 to 1.20 |

*The salt weight percent is based on the amount of base fluid in the composition.

The following table includes illustrative WB-FR slurry composition additive types and ranges of this disclosure.

| FR Additive Type | FR Additive Range (wt. % ) |
|---|---|
| suspending and/or dispersing agent | 0.1 to 5 |
| gel-bridging agent | 0.1 to 2 |

The following table includes illustrative WB-FR slurry composition surfactant types and ranges of this disclosure.

| Surfactant Type | Surfactant Range (wt. %) |
|---|---|
| cationic surfactant | 0 to 5 |
| anionic surfactant | 0 to 5 |
| zwitterionic surfactant | 0 to 5 |
| nonionic surfactant | 0 to 5 |
| any mixture of surfactants | 0 to 5 |

### Effective Amounts of the FR Salt Compositions

In other embodiments, the WB-FR slurry compositions include a FR salt effective amount of the FR salt composition resulting in between 0.25 wt. % and about 20 wt. % of undissolved salt(s) in the WB-FR slurry compositions. In other embodiments, the FR salt effective amount results in between 0.50 wt. % and about 20 wt. % of undissolved salt(s) in the WB-FR slurry compositions. In other embodiments, the FR salt effective amount results in between 0.75 wt. % and about 20 wt. % of undissolved salt(s) in the WB-FR slurry compositions. In other embodiments, the FR salt effective amount results in between 1.0 wt. % and about 20 wt. % of undissolved salt(s) in the WB-FR slurry compositions. The FR salt composition reduces or prevents hydration of the FR polymers in the WB-FR slurry compositions during production, storage, and transportation.

In other embodiments, the FR salt effective amount results in between 0.25 wt. % and about 15 wt. % of undissolved salt(s) in the WB-FR slurry compositions. In other embodiments, the FR salt effective amount results in between 0.5 wt. % and about 15 wt. % of undissolved salt(s) in the WB-FR slurry compositions. In other embodiments, the FR salt effective amount results in between 0.75 wt. % and about 15 wt. % of undissolved salt(s) in the WB-FR slurry compositions. In other embodiments, the FR salt effective amount results in between 1.0 wt. % and about 15 wt. % of undissolved salt(s) in the WB-FR slurry compositions.

In other embodiments, the FR salt effective amount results in between 0.25 wt. % and about 10 wt. % of undissolved salt(s) in the WB-FR slurry compositions. In other embodiments, the FR salt effective amount results in between 0.5 wt. % and about 10 wt. % of undissolved salt(s) in the WB-FR slurry compositions. In other embodiments, the FR salt effective amount results in between 0.75 wt. % and about 10 wt. % of undissolved salt(s) in the WB-FR slurry compositions. In other embodiments, the FR salt effective amount results in between 1.0 wt. % and about 10 wt. % of undissolved salts from the salt composition in the WB-FR slurry compositions.

In other embodiments, the FR salt effective amount results in between 0.25 wt. % and about 5 wt. % of undissolved salt(s) in the WB-FR slurry compositions. In other embodiments, the FR salt effective amount results in between 0.5 wt. % and about 5 wt. % of undissolved salt(s) in the WB-FR slurry compositions. In other embodiments, the FR salt effective amount results in between 0.75 wt. % and about 5 wt. % of undissolved salt(s) in the WB-FR slurry compositions. In other embodiments, the FR salt effective amount results in between 1.0 wt. % and about 5 wt. % of undissolved salt(s) in the WB-FR slurry compositions.

### WB-FR Slurry Compositions Including Below a Saturation Concentration

The following table includes illustrative compositional ranges for WB-FR slurry compositions of this disclosure including a salt concentration below and up to a saturation concentration of the salt or salts at 20° C.:

| FR Base | | DP-WS-FR | | FR | FR |
|---|---|---|---|---|---|
| Fluid | FR Salt(s)* | Polymer(s) | FR Acid(s) | Additive(s) | Surfactant(s) |
| wt. % | wt. % | wt. % | wt. % | wt. % | wt. % |
| remainder | 30 to 42.7 | 15 to 40 | 0.1 to 10 | 0.106 | 0 to 5 |
| remainder | 32.5 to 42.7 | 15 to 40 | 0.5 to 10 | 0.1 to 6 | 0 to 5 |
| remainder | 35 to 42.7 | 15 to 40 | 1 to 10 | 0.1 to 6 | 0 to 5 |
| remainder | 37.5 to 42.7 | 15 to 40 | 0.1 to 7.5 | 0.1 to 6 | 0 to 5 |
| remainder | 38 to 42.7 | 15 to 40 | 0.5 to 7.5 | 0.1 to 6 | 0 to 5 |
| remainder | 38.5 to 42.7 | 15 to 40 | 1 to 7.5 | 0.1 to 6 | 0 to 5 |
| remainder | 39 to 42.7 | 15 to 40 | 0.1 to 5 | 0.1 to 6 | 0 to 5 |
| remainder | 39.5 to 42.7 | 15 to 40 | 0.5 to 5 | 0.1 to 6 | 0 to 5 |
| remainder | 40 to 42.7 | 15 to 40 | 1 to 5 | 0.1 to 6 | 0 to 5 |
| remainder | 40.5 to 42.7 | 15 to 40 | 0.1 to 2.5 | 0.1 to 6 | 0 to 5 |
| remainder | 41 to 42.7 | 15 to 40 | 0.5 to 2.5 | 0.1 to 6 | 0 to 5 |
| remainder | 41.5 to 42.7 | 15 to 40 | 1 to 2.5 | 0.1 to 6 | 0 to 5 |

*The salt weight percent is based on the amount of base fluid in the composition.

The following table includes illustrative WB-FR slurry composition additive types and ranges of this disclosure.

| FR Additive Type | FR Additive Range (wt. %) |
|---|---|
| suspending and/or dispersing agent | 0.1 to 5 |
| gel-bridging agent | 0.1 to 2 |

The following table includes illustrative WB-FR slurry composition surfactant types and ranges of this disclosure.

| Surfactant Type | Surfactant Range (wt. %) |
|---|---|
| cationic surfactant | 0 to 5 |
| anionic surfactant | 0 to 5 |
| zwitterionic surfactant | 0 to 5 |
| nonionic surfactant | 0 to 5 |
| any mixture of surfactants | 0 to 5 |

### Effective Amounts of the FR Salt Compositions

In other embodiments, the WB-FR slurry compositions include a FR salt effective amount of the FR salt composition results in between 30.0 wt. % and about 42.7 wt. % of undissolved salt(s) in the WB-FR slurry compositions. In other embodiments, the FR salt effective amount results in between 32.5 wt. % and about 42.7 wt. % of undissolved salt(s) in the WB-FR slurry compositions. In other embodiments, the FR salt effective amount results in between 35.0 wt. % and about 42.7 wt. % of undissolved salt(s) in the WB-FR slurry compositions. In other embodiments, the FR salt effective amount results in between 37.5 wt. % and about 42.7 wt. % of undissolved salt(s) in the WB-FR slurry compositions. In other embodiments, the FR salt effective amount results in between 40.0 wt. % and about 42.7 wt. % of undissolved salt(s) in the WB-FR slurry compositions.

### FR Polymer Composition Concentration Ranges

In certain embodiments, the FR polymer compositions of this disclosure may be present in the WB-FR slurry compositions of this disclosure in an amount sufficient to provide a desirable level of friction reduction. In other embodiments, the FR polymer may be present in the WB-FR slurry compositions of this disclosure in an amount from about 10 wt. % to about 40 wt. % by weight of the WB-FR slurry composition, from about 10 wt. % to about 35 wt. %, from about 10 wt. % to about 30 wt. %, from about 15 wt. % to about 40 wt. %, from about 15 wt. % to about 35 wt. %, from about 15 wt. % to about 30 wt. %, from about 20 wt. % to about 40 wt. %, from about 20 wt. % to about 35 wt. %, or from about 20 wt. % to about 30 wt. %.

### WB-FR Slurry Concentration in Downhole Fluids

In certain embodiments, the methods of the present disclosure may include adding the WB-FR slurry compositions of this disclosure to a treating fluid composition, or to an aqueous fluid to form a treating fluid composition. In other embodiments, the WB-FR slurry compositions of this disclosure is present in the treating fluid composition in an amount sufficient to maintain laminar flow, when the treating fluid is pumped into the wellbore and/or one or more subterranean oil and/or gas bearing formations. In other embodiments, the WB-FR slurry compositions of this disclosure is present in the treating fluid composition in an amount sufficient to minimize turbulent eddies that are created at interior surfaces of the tubing through which the treating fluid is pumped as a thin fluid at high velocity, non-crosslinked downhole fluids. In other embodiments, the WB-FR slurry compositions of this disclosure may be present in the treating fluid in an amount from about 0.1 to about 100 gallons per thousand gallons of fluid (“gpt”). In other embodiments, the WB-FR slurry compositions of this disclosure may be present in the treating fluid composition in an amount from about 0.1 gpt to about 5 gpt, or from about 0.25 gpt to about 2 gpt. In other embodiments, the WB-FR slurry compositions of this disclosure may be present in the treating fluid in an amount less than about 3 gpt, or alternatively, less than about 2 gpt. In other embodiments, an amount of the WB-FR slurry compositions of this disclosure on the higher end of the above ranges may be desired, among other reasons, to impart adequate viscosity to the treating fluid. In other embodiments, the WB-FR slurry compositions of this disclosure may have a total concentration less than 3 gpt, or alternatively, less than about 2 gpt.

In certain embodiments, the fracturing fluid compositions of this disclosure may include proppant particulates in an amount from about 0.05 to about 12 pounds of particulates per gallon of treating fluid (“ppg”). In other embodiments, the treating fluid may include the proppant particulates in an amount from about 3 ppg to about 10 ppg. In other embodiments, the treating fluid compositions of this disclosure may include the proppant particulates in an amount from about 0.1 ppg to about 0.5 ppg, from about 0.5 ppg to about 1.0 ppg, from about 1.0 ppg to about 2.0 ppg, from about 2.0 ppg to about 3.0 ppg, from about 3.0 ppg to about 4.0 ppg, from, about 4.0 ppg to about 5.0 ppg, from about 5.0 ppg to about 6.0 ppg, from about 6.0 ppg to about 7.0 ppg, from about 7.0 ppg to about 8.0 ppg, from about 8.0 ppg to about 9.0 ppg, or from about 9.0 ppg to about 10 ppg.

It should be recognized that slickwater fracturing fluid are often used instead of crosslinked fracturing fluids to minimize treatment cost and to maximize production by creating deep penetrating fracture networks, while crosslinked fracturing fluid generate higher viscosity and subsequently create a wider but shorter fracture networks.

It should be recognized that the WB-FR slurry compositions of this disclosure may have the following benefits: (a) improved slurry properties compared to currently utilized slurries with respect to polymer concentration, slurry shelf life, slurry viscosity, and/or percent friction reduction imparted to the downhole fluid by the DP-WS-FR polymer composition; (b) the preparation process (process of making the WB-FR slurry compositions of this disclosure) may be more repeatable making the production of the slurry more uniform and consistent; (c) improved performance as compared to the same dry polymers due to improved polymer distribution in the WB-FR slurry composition downhole fluid before a significant level of polymer hydration is achieved; and (d) having a stable slurry with good properties makes handing large amounts of polymer (at the wellsite) easier and makes the addition of the polymer more accurate.

### Suitable Components for Use in the Disclosure

### FR and Treating Base Fluids

Suitable friction-reducing (FR) base fluids and treating base fluids for use in this disclosure include, without limitation, any source of water such as fresh water, saltwater (e.g., water containing one or more salts dissolved therein), brine (e.g., saturated saltwater), seawater, produced water, surface water (e.g., from a river or a pond), reclaimed water, high totally dissolved solid (TDS) containing water, any other type of water, aqueous fluids formulated using any combination of these sources of water, or any mixture or combination thereof.

### Friction-Reducing (FR) Polymers

Suitable friction-reducing polymers for use in this disclosure include, without limitation, one or more anionic polymers, one or more cationic polymers, one or more amphoteric polymers, or any combination thereof. Exemplary examples include, without limitation, one or more acrylamide copolymers, one or more anionic acrylamide copolymers, one or more cationic acrylamide copolymers, one or more nonionic acrylamide copolymers, one or more amphoteric acrylamide copolymers, one or more polyacrylamides, one or more polyacrylamide derivatives, one or more polyacrylate, one or more polyacrylate derivative, one or more polymethacrylate, one or more polymethacrylate derivatives, and any mixture or combination thereof. Exemplary examples of suitable FR polymers include, without limitation, polyacrylates, polyacrylate derivatives, polyacrylate copolymers, polymethacrylates, polymethacrylate derivatives, polymethacrylate copolymers, polyacrylamide, polyacrylamide derivatives, polyacrylamide copolymers, acrylamide copolymers, polysaccharides, polysaccharide derivatives, polysaccharide copolymers, synthetic polymers, superabsorbent polymers, and any combination thereof. Exemplary examples of water soluble FR polymers include, without limitation, polymers containing one or more of the following monomers: acrylamide, acrylic acid, methacrylic acid, vinyl acetate, vinyl sulfonic acid, N-vinyl acetamide, N-vinyl formamide, itaconic acid, acrylic acid ester, methacrylic acid ester, ethoxylated-2-hydroxyethyl acrylate, ethoxylated-2-hydroxyethyl methacrylate, 2-hydroxyethyl acrylate, 2-hydroxyethylmethyl methacrylate, 2-hydroxypropyl acrylate, 2-hydroxypropyl methacrylate, hydroxymethyl styrene, 2-acrylamido-2-methylpropane sulfonic acid (AMPS), acrylamido tertiary butyl sulfonic acid (ATBS), 2-(meth)acrylamido-2-methylpropane sulfonic acid, 2-amino-2-methyl-1-propanol (AMP), N,N-dimethylacrylamide (DMAA), a salt of any of the foregoing, and any combination thereof. In certain embodiments, the FR polymers include one or more copolymers including acrylamide and AMPS. In other embodiments, the FR polymers may comprise high molecular weight, linear polymers. In certain embodiments, the one or more friction reducing polymers include one or more monomers. The one or more monomers include acrylamide, acrylic acid, 2-acrylamido-2-methylpropane sulfonic acid, acrylamido tertiary butyl sulfonic acid, a salt of any of the foregoing, and any mixture or combination thereof. In other embodiments, the water-based FR polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000. In certain embodiments, the FR polymers may be mixed with a water-soluble guar or a derivative thereof.

### Salt Compositions

Suitable salt compositions for use in this disclosure include, without limitation, ammonium sulfate or a mixture of ammonium sulfate and one or more other salts, wherein the mixtures contain at least about 50 wt. % ammonium sulfate based on the weigh percentage of all of the salts, at least about 55 wt. %, at least about 60 wt. %, at least about 65 wt. %, at least about 70 wt. %, at least about 75 wt. %, at least about 80 wt. %, at least about 85 wt. %, at least about 90 wt. %, or at least about 95 wt. %, or any amount between 50 wt. % and 99.99 wt. %. The one or more other salts include, without limitation, one or more carbonate salts, one or more sulfate salts, one or more phosphate salts, one or more magnesium salts, one or more bromide salts, one or more formate salts, one or more acetate salts, one or more chloride salts, one or more fluoride salts, a bicarbonate salts, one or more nitrate salts, and any mixture or combination thereof. Exemplary examples of the one or more carbonate salts include, without limitation, ammonium carbonate, sodium carbonate, potassium carbonate, aluminum carbonate, magnesium carbonate, calcium carbonate, barium carbonate, strontium carbonate, zinc carbonate, other metal carbonates, or any mixture or combination thereof. Exemplary examples of the one or more phosphate salts include, without limitation, ammonium sulfate, sodium sulfate, potassium sulfate, aluminum sulfate, magnesium sulfate, calcium sulfate, barium sulfate, strontium sulfate, zinc sulfate, other metal sulfates, or any mixture or combination thereof. Exemplary examples of the one or more chloride salts include, without limitation, ammonium chloride, sodium chloride, potassium chloride, calcium chloride, magnesium chloride, strontium chloride, barium chloride, other metal chlorides, or any mixture or combination thereof. Exemplary examples of the one or more bromide salts include, without limitation, sodium bromide, potassium bromide, calcium bromide, magnesium bromide, zinc bromide, strontium bromide, other metal bromides, or any mixture or combination thereof. Exemplary examples of the one or more bicarbonates include, without limitation, sodium bicarbonate, potassium bicarbonate, other metal bicarbonates, or any mixture or combination thereof. Exemplary examples of the one or more nitrate salts include, without limitation, sodium nitrate, potassium nitrate, calcium nitrate, magnesium nitrate, zinc nitrate, strontium nitrate, other metal nitrate, or any mixture or combination thereof. The salt compositions are designed to reduce or prevent hydration of the FR polymer composition in the slurry during slurry production, storage, and transportation.

In other embodiments, the salt compositions may include, without limitation, divalent salts such as calcium and/or magnesium salts and monovalent salts such as ammonium and/or potassium salts work to prevent hydration during slurry production, storage, and transportation as well.

In other embodiments, the salt compositions may include, without limitation, phosphate based salts such as potassium phosphate and/or variants such as potassium hexametaphosphate, which are capable of reducing or preventing FR polymer hydration during slurry production, storage, and transportation.

In other embodiments, the salt compositions may include, without limitation, water-soluble potassium salts such as potassium citrate, potassium carbonate, etc., which are also capable of reducing or preventing FR polymer hydration during slurry production, storage, and transportation. However, these salts are higher cost than salt compositions based on ammonium sulfate as the major component (greater than 50%).

In other embodiments, the salt compositions may include, without limitation, multivalent salts such as zinc chloride, aluminum chloride, iron chloride, zinc sulfate, aluminum sulfate, iron sulfate, or any mixture or combination, which are also capable of reducing or preventing FR polymer hydration during slurry production, storage, and transportation.

In other embodiments, the salt compositions may include, without limitation, double salt equivalents such as magnesium ammonium sulfates, calcium ammonium sulfates, aluminum ammonium sulfates, iron ammonium sulfates, nickel ammonium sulfates, copper ammonium sulfates, similar metal ammonium salts, or any mixture or combination, which are also capable of reducing or preventing FR polymer hydration during slurry production, storage, and transportation.

### FR Additive Compositions

Suspending and/or Dispersing Agent

Suitable suspending and/or dispersing agents for use in this disclosure include, without limitation, a bentonite clay, a phyllosilicate clay, fumed silica, or any mixture or combination. In certain embodiments, the clay may include, without limitation, any water based clay, fumed silica, modified clay, or any mixture or combination thereof. In other embodiments, the clay may have nano-structures and/or micro-structures.

### Gel-Bridging Agents

Suitable gel-bridging agents for use in this disclosure include, without limitation, polyethylene glycols such as PEG 200, PEG 300, PEG 400, PEG 500, or similar polyethylene polymers, polypropylene glycols, polyethylene/propylene glycols, other polyalkylene oxide polymers, or any mixture or combination, provided that the gel-bridging agents are water soluble or water miscible at the concentration used in specific formulations.

### FR Acid Compositions

Suitable acids for use in this disclosure include, without limitation, organic monoacids, organic diacids, organic polyacids, organic hydroxy acids, citric acid, oxalic acid, ascorbic acid, isocitric acid, aconitic acid, propane-1,2,3-tricarboxylic acid, or any mixture or combination.

### MonoAcids

Suitable fatty acids for use in this disclosure include, without limitation, any saturated fatty acid or unsaturated monoacids having between 1 carbon atoms and about 8 carbon atoms, provided that the acids are water soluble or water miscible at the concentration used in specific formulations.

Exemplary saturated monaacids include, without limitation, formic acid, acetic acid, propanoic acid, butyric acid, valeric acid, caproic acid, or any mixture or combination.

### Diacids

Exemplary examples of saturate organic diacids include, without limitation, ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), heneicosa-1,21-dioic acid (japanic acid), docosanedioic acid (phellogenic acid), triacontanedioic acid (equisetolic acid), or any mixture or combination thereof, provided that the acid is water soluble or water miscible at the concentration used in specific formulations. Exemplary examples of unsaturated organic diacids include, without limitation, (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), and mixtures or combinations thereof, provided that the acids are water soluble or water miscible at the concentration used in specific formulations.

### Poly Acids

Suitable poly carboxylic acid compounds for use a pH depending release agents include, without limitation, any polycarboxylic acid compound. Exemplary examples of water immiscible polyacids include, without limitation, polymers including one or more carboxylic acid group containing monomers, where the polymers are water soluble. Exemplary example of water soluble polyacids include, without limitation, polyacrylic acid, polymethacrylic acid, polylactic acid, polyglycol acid, mixtures and combinations thereof, copolymers thereof, CARBOPOL® reagents available from Lubrizol Corporation (a registered trademark of the Lubrizol Corporation), other carboxylic acid containing polymers, or any mixture or combination thereof, provided that the acid is water soluble or water miscible at the concentration used in specific formulations.

### Hydroxy Acids

Suitable organic hydroxy acids include, without limitation, 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phaseolic acid), 9,10,18-trihydroxyoctadecanoic acid (phloionolic acid), 7,14-dihydroxydocosa-4 Z,8,10,12,16Z,19Z-hexaenoic acid (Maresin 1), 5S,12R,18R-trihydroxy-6Z,8E,10E,14Z,16E-eicosapentaenoic acid (resolvin E1), resolvin D1, 10, 17S-docosatriene, (neuroprotectin D1), or any mixture or combination, provided that the acid is water soluble or water miscible at the concentration used in specific formulations.

### Surfactants

Suitable surfactants for use in this disclosure include, without limitation, anionic surfactants, cationic surfactants, zwitterionic surfactants, nonionic surfactants, or any mixture or combination thereof, provided that the acid is water soluble or water miscible at the concentration used in specific formulations.

### Anionic Surfactants

Suitable anionic surfactants include, without limitation, anionic sulfate surfactant, alkyl ether sulfonates, alkylaryl sulfonates, or any mixture or combination thereof. In certain embodiments, the anionic surfactants include, without limitation, sodium or ammonium alcohol ether sulfate surfactants include those having the general formula R^{a}OB(CH₂CH₂O)ₙSO₃NH⁴, where R^{a} is a carbon-containing group including an alkyl group, an aryl group, an alkaryl group, an aralkyl group, or any mixture or combination thereof, provided that the acid is water soluble or water miscible at the concentration used in specific formulations. In other embodiments, the anionic surfactants include, without limitation, sodium or ammonium alcohol ether sulfate surfactants include short chain sodium or ammonium alcohol ether sulfate surfactants having between 2 and about 10 carbon atoms or between about 4 and 10 carbon atoms and long chain sodium or ammonium alcohol ether sulfate surfactants having between about 10 to about 24 carbon atoms or between about 12 and about 18 carbon atoms or between about 12 and about 14 carbon atoms, provided that the acid is water soluble or water miscible at the concentration used in specific formulations. In other embodiments, the anionic surfactants include, without limitation, sodium ammonium alcohol ether sulfate surfactants prepared by reacting 1 to 10 moles of ethylene oxide per mole of an alkanol or 3 moles of ethylene oxide per mole of an alkanol, provided that the acid is water soluble or water miscible at the concentration used in specific formulations.

Suitable alkylaryl sulfonates include, without limitation, alkyl benzene sulfonic acids and their salts, dialkylbenzene disulfonic acids and their salts, dialkylbenzene sulfonic acids and their salts, alkyltoluene/alkyl xylene sulfonic acids and their salts, alkylnaphthalene sulfonic acids/condensed alkyl naphthalene sulfonic acids and their salts, alkylphenol sulfonic acids/condensed alkylphenol sulfonic acids and their salts, or any mixture or combination thereof, provided that the acid is water soluble or water miscible at the concentration used in specific formulations.

Suitable alkyl ether sulfonates include, without limitation, alkyl ether sulfonates having the general formula R^{b}[—(O—R^{c}O)ₘ—(R^{d}O)ₙ—(R^{e})]_{y} where: R^{b}=alkyl, alkenyl, amine, alkylamine, dialkylamine, trialkylamine, aromatic, polyaromatic, cycloalkane, cycloalkene, R^{c} and R^{d}=C₂H₄ or C₃H₆ or C₄H₈, R^{d}=linear or branched C₇H₁₄SO₃X to C₃₀H₆₀SO₃X when y=1, R^{e}=linear or branched C₇H₁₄SO₃X to C₃₀H₆₀SO₃X or H when y>1 but at least one R^{d} must be linear or branched C₇H₁₄SO₃X to C₃₀H₆₀SO₃X, m is greater or equal to 1, n is greater or equal to 0, n+m=1 to 30+, y is greater or equal to 1, X=alkali metal or alkaline earth metal or ammonium or amine, provided that the acid is water soluble or water miscible at the concentration used in specific formulations.

Other suitable anionic surfactants include, without limitation, anionic surfactants include (a) carboxylates: alkyl carboxylates-fatty acid salts; carboxylate fluoro surfactants, (b) sulfates: alkyl sulfates (e.g., sodium lauryl sulfate); alkyl ether sulfates (e.g., sodium laureth sulfate), (c) sulfonates: docusates (e.g., dioctyl sodium sulfosuccinate); alkyl benzene sulfonates, (d) phosphate esters: alkyl aryl ether phosphates; alkyl ether phosphates. Sodium lauryl sulphate BP (a mixture of sodium alkyl sulfates, mainly sodium dodecyl sulfate, C₁₂H₂₅SO₄Na⁺), alkyl sulfates, alkyltrimethylammonium bromides, and/or alcohol ethoxylates, provided that the acid is water soluble or water miscible at the concentration used in specific formulations.

In certain embodiments, the one or more anionic surfactants may be present in the WB-FR slurry composition in an amount between about 0.00 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %.

In other embodiments, the one or more anionic surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Cationic Surfactants

Suitable cationic surfactants include, without limitation, Gemini, bis or di quaternary ammonium surfactants such as bis quaternary ammonium halides of bis halogenated ethane, propane, butane or higher halogenated alkanes, e.g., dichloroethane or dibromoethane, or bis halogenated ethers such as dichloroethylether (DCEE), provided that the acid is water soluble or water miscible at the concentration used in specific formulations.

Other suitable cationic surfactants include, without limitation, RN⁺H₃Cl⁻ (salt of a long-chain amine), RN⁺(CH₃)₃Cl⁻ (quaternary ammonium chloride, also known as quats), and mixtures or combinations thereof, wherein R is a alkyl group, an aryl group, an aralkyl group, an alkaryl group, cyclic analogs, heterocyclic analogs, or any mixture thereof, provided that the acid is water soluble or water miscible at the concentration used in specific formulations.

In certain embodiments, the one or more cationic surfactants may be present in the WB-FR slurry composition in an amount of about 0.0 wt. % to about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more cationic surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Zwitterionic or Amphoteric Surfactants

Suitable zwitterionic or amphoteric surfactants include, without limitation: (1) any compound having the general structure R^{f}R^{g}R^{h}N⁺—Rⁱ—CO₂⁻, where R^{f}, R^{g}, and R^{h} are the same or different carbon-containing group, amido carbon-containing group, ether carbon-containing group, or any mixture or combination thereof, and Rⁱ is an alkenyl group, alkenyloxide group, or any mixture or combination thereof, provided that the acid is water soluble or water miscible at the concentration used in specific formulations; (2) any compound having the general structure R^{j}(R^{g}R^{h}N⁺—Rⁱ—CO₂—)ₙ, where R^{g} and R^{h} are the same or different carbon-containing group, amido carbon-containing group, ether carbon-containing group, or any mixture or combination thereof, Rⁱ is an alkenyl group, alkenyloxide group or any mixture or combination thereof, and Rⁱ is a multivalent substituent having a valency n between 2 and about 6, e.g., CH₂ moiety when n is 2, a CH moiety when n is 3 and a C atom when n is 4, provided that the acid is water soluble or water miscible at the concentration used in specific formulations; (3) any compound having the general structure R¹—C(O)—N(R^{k})—R^{m}—N⁺(R^{g}R^{h})—Rⁱ—CO₂⁻, where R^{g}, R^{h}, R^{k} and R¹ are the same or different carbon-containing group, amido carbon-containing group, ether carbon-containing group, or any mixture or combination thereof, and Rⁱ and R^{m} are the same or different alkenyl group, alkenyloxide group or any mixture or combination thereof; (4) any compound having the general structure Rⁿ—[R^{o}—C(O)—N(R^{k})—R^{m}—N⁺(R^{g}R^{h})—Rⁱ—CO₂⁻]ₘ, where R^{g}, R^{h} and R^{k} are the same or different carbon-containing group, amido carbon-containing group, ether carbon-containing group, or any mixture or combination thereof, Rⁱ, R^{m} and R^{o} are the same or different alkenyl group, alkenyloxide group or any mixture or combination thereof and Rⁿ is a multivalent substituent having a valency m between 2 and about 6; other similar ammonium acid zwitterionic agent; or any mixture or combination thereof, provided that the acid is water soluble or water miscible at the concentration used in specific formulations. In other embodiments, the zwitterionic compounds are betaines such as cocamidopropyl betaine, 5-(1-piperidiniomethyl)-1H-tetrazolide, or similar zwitterionic compounds. In certain embodiments, the sulfo-betaines and related zwitterionic compounds include, without limitation, N-decyl-N,N-dimethyl-3-ammonio-1-propanesulfonate; dimethylbenzyl-(3-sulfopropyl)ammonium; dimethylethyl-(3-sulfopropyl)ammonium; dimethyl-(2-hydroxyethyl)-(3-sulfopropyl)ammonium; 4-n-hexylbenzoylamido-propyl-dimethylammoniosulfobetaine; 4-methyl-N-(3-sulfopropyl)morpholinium; 4-n-octylbenzoylamido-propyl-dimethylammoniosulfobetaine; 1-(3-Sulfopropyl)pyridium; N-tetradecyl-N,N-dimethyl-3-ammonio-1-propanesulfonate, or the like, or any mixture or combination thereof, provided that the acid is water soluble or water miscible at the concentration used in specific formulations.

Other suitable zwitterionic surfactants include, without limitation, betaines, sulfobetaines, or any mixture or combination thereof, provided that the surfactants are water soluble or water miscible at the concentration used in specific formulations. Exemplary examples include, without limitation, RN⁺H₂CH₂COO⁻, RN⁺(CH₃)₂CH₂CH₂SO₃⁻, where R is linear, branched, saturated, or unsaturated alkyl groups; linear, branched, saturated, or unsaturated C₈-C₁₉ alkyl groups; linear, branched, saturated, or unsaturated C₂₀-C₄₀ alkyl groups; sterol or steroid groups, or any mixture or combination thereof, CHAPS zwitterionic surfactants such as 3-[(3-cholamidopropyl) dimethylammonio]-1-propanesulfonate or related CHAPSO surfactants, cocamidopropyl betaine, cocamidopropyl hydroxysultaine, hydroxysultaine, miltefosine, lipophilic peptitergents, or any mixture or combination thereof, provided that the acid is water soluble or water miscible at the concentration used in specific formulations.

In certain embodiment, the one or more zwitterionic or amphoteric surfactants may be present in the WB-FR slurry composition in an amount between about 0 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more zwitterionic or amphoteric surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Nonionic Surfactants

Suitable nonionic surfactants include, without limitation, alkyl polyglycosides, polyethylene glycol hexadecyl ethers, cetostearyl alcohols, cetyl alcohol, cocamide/diethanolamine, cocamide/monoethanolamine, decyl glucosides, decyl polyglucoses, glycerol monostearates, octylphenoxypolyethoxyethanols, polyethylene glycol ethers, lauryl glucosides, maltosides, monolaurins, mycosubtilins, narrow-range ethoxylates, 4-nonylphenyl-polyethylene glycol, ethoxylated nonoxynols, polyethylene glycolnonyl phenyl ethers, onyl phenoxypolyethoxylethanols, octaethylene glycol monododecyl ethers, N-octyl beta-d-thioglucopyranosides, octyl glucosides, oleyl alcohol, polyethylene glycols derived from sunflower glycerides, pentaethylene glycol monododecyl ethers, ethoxylated dodecanols, nonionic triblock copolymers composed of a central hydrophobic chain of polyoxypropylene (poly(propylene oxide)) flanked by two hydrophilic chains of polyoxyethylene (poly(ethylene oxide)), polyethoxylated tallow amines, polyglycerol polyricinoleates, polysorbates, sorbitans, sorbitan monolaurates, sorbitan monostearates, sorbitan tristearates, stearyl alcohol, bacterial cyclic lipopeptides, hydrophilic polyethylene oxides, polyoxyethylene sorbitan monooleates, and mixtures or combinations thereof, provided that the one or more nonionic surfactants are water soluble or water miscible at the concentration used in specific formulations.

Other suitable nonionic surfactants are categorized by their hydrophilic-lipophilic balance (HLB) number, with a low value (<10) corresponding to greater lipophilicity and a higher value (>10) corresponding to higher hydrophilicity, provided that the surfactants are water soluble or water miscible at the concentration used in specific formulations. Low HLB (<10) surfactants include, without limitation, (a) alkylene glycol esters of fatty acids such as ethylene glycol esters of saturated and unsaturated C₂-C₆ carboxylic acids, propylene glycol esters of saturated and unsaturated C₂-C₆ carboxylic acids, butylene glycol esters of saturated and unsaturated C₂-C₆ carboxylic acids, high alkylene glycols of esters of saturated and unsaturated C₂-C₆ carboxylic acids, and mixtures or combinations thereof, (b) unsaturated polyglycolized glycerides such as oleoyl macrogolglycerides and linoleoyl macrogolglycerides, (c) sorbitan esters such as sorbitan monooleate, sorbitan monostearate, sorbitan monolaurate, and sorbitan monopalmitate; or (d) mixtures or combinations thereof, provided that the low HBL surfactants are water soluble or water miscible at the concentration used in specific formulations. High HLB (>10) surfactants include, without limitation, (a) polyoxyethylene sorbitan esters such as polysorbate 20, polysorbate 40, polysorbate 60, and polysorbate 80; (b) polyoxyl castor oil derivatives such as Polyoxyl 35 castor oil and Polyoxyl 40 hydrogenated castor oil; (c) polyoxyethylene polyoxypropylene block copolymer such as Poloxamer 188 and Poloxamer 407; (d) saturated polyglycolized glycerides such as lauroyl macrogolglycerides and stearoyl macrogolglycerides; (e) PEG-8 caprylic/capric glycerides such as caprylocaproyl macrogolglycerides; (f) vitamin E derivative such as tocopherol PEG succinate; or (g) mixtures or combinations thereof, provided that the surfactants are water soluble or water miscible at the concentration used in specific formulations. Other suitable nonionic surfactants include, without limitation, polyolesters, cyclic polyol esters, polyethylene glycol (PEG) esters, or any mixture or combination thereof. Exemplary examples include, without limitation, sorbitan monofatty and/or polyfatty acid esters, sorbitoal monofatty and/or polyfatty acid esters, mono fatty acid glycerides, polyethylene glycol (PEG) ester surfactants including hydrophilic gelucires such as hydrophilic GELUCIRE® 44/14, lauroyl macrogol glyceride type 1500, or other gelucires; polyglycol modified castor oils such as polyoxyl 35 hydrogenated castor oil, polyoxyl 40 hydrogenated castor oil; polyethylene oxides; polypropylene oxides; poly(ethylene oxide and propylene oxide) polymers; polysorbates such as polysorbate 20, 40, 60, 80, etc., and TWEEN® surfactants; and mixtures or combinations thereof, provided that the surfactants are water soluble or water miscible at the concentration used in specific formulations.

Exemplary examples of suitable nonionic surfactants include, without limitation, SPAN® surfactants (available from Sigma-Aldrich) such as SPAN⁷® 20, sorbitan laurate, sorbitan monolaurate, SPAN® 40, sorbitan monopalmitate, SPAN® 60, sorbitan stearate, sorbitane monostearate, SPAN® 80, sorbitane monooleate, sorbitan oleate, or other Span surfactants, TWEEN® surfactants such as TWEEN SPAN® 40, polyoxyethylene sorbitan monopalmitate, TWEEN® 60, polyethylene glycol sorbitan monostearate, TWEEN® 80, polyoxyethylene-sorbitan-20 monooleate, POE (20) sorbitan monooleate, polyethylene glycol sorbitan monooleate, polyoxyethylene sorbitan monooleate, polysorbate 80, BRIJ™ surfactants such as BRIJ™ 58, polyoxyethylene-20 hexadecyl ether, BRIJ™ 92-2-[(Z)-octadec-9-enoxy]ethanol, BRIJ™ 35, polyethoxylated lauryl alcohol (yielding a lauryl ether), BRIJ™ 700C, polyetholylated stearyl alcohol, BRIJ™ 700, polyoxyethylene stearyl ether (HLB 18.8), or the other BRIJ™ surfactants, SOLULAN™ C₂₄, 2-[[10,13-dimethyl-17-(6-methylheptan-2-yl)-2,3,4,7,8,9,11,12,14,15,16,17-dodecahydro-1H-cyclopenta[a]phenanthren-3-yl]oxy]ethanol or polyoxyethylene-24-cholesterol ether, PEG surfactantsBpolyethylene oxides, TRITON™ surfactants such as TRITON™ X-100, octylphenol ethoxylate polyoxyethylene 9.5-octlphenol, TRITON™ X-80N, alkyl-oxy-polyethylene-oxy-polypropylene-oxyethanol, or other TRITON™ surfactants, PLURONIC™ surfactants from Thermo Fisher, TERGITOL™ surfactants from Dow Chemicals, SURFONIC™ JL-80X, alkoxylated linear alcohol, ETHOFAT™ 242/25, ethoxylated tall oil, alkyl polyglycoside, polyethylene glycol hexadecyl ether (CETOMACROGOL™ 1000), cetostearyl alcohol, cetyl alcohol, cocamide DEA, cocamide MEA, decyl glucoside, decyl polyglucose, glycerol monostearate, IGEPAL® alkylphenoxypoly(ethyleneoxy)ethanols surfactants from Cameo such as IGEPAL® CA-630, ethoxylated iso-cetyl alcohol (Isoceteth-20), lauryl glucoside or dodecyl j-d-glucopyranoside, maltoside or maltose glycosides, mycosubtilin, nonylphenoxypolyethoxyethanol (NONIDET™ P-40 from Shell), 26-(4-nonylphenoxy)-3,6,9,12,15,18,21,24-octaoxahexacosan-1-ol (nonoxynol-9), nonaethylene glycol or polyethylene glycol nonyl phenyl ether (Nonoxynols), 4-nonylphenyl-polyethylene glycol (NP-40), octaethylene glycol monododecyl ether, N-octyl beta-d-thioglucopyranoside, octyl glucoside, oleyl alcohol, PEG-10 sunflower glycerides, pentaethylene glycol monododecyl ether, ethoxylated dodecanol (polidocanol), polyethoxylated tallow amine, polyglycerol polyricinoleate, stearyl alcohol, and mixtures or combinations thereof. In some embodiments, one or more nonionic surfactants comprise an ethylene glycol mono fatty acid ester, a propylene glycol mono fatty acid ester, or a combination of two or more thereof, provided that the surfactants are water soluble or water miscible at the concentration used in specific formulations. In some embodiments, one or more nonionic surfactants comprise one or more selected from sorbitan mono-, di-, and tri-fatty acid esters. In some embodiments, one or more nonionic surfactants comprise sorbitan trioleate (STO), sorbitan monooleate, or sorbitan tristearate, or a combination thereof, provided that the surfactants are water soluble or water miscible at the concentration used in specific formulations. In some embodiments, one or more nonionic surfactants comprise propylene glycol monolaurate, provided that the surfactants are water soluble or water miscible at the concentration used in specific formulations.

In certain embodiments, the one or more nonionic surfactants may be present in the WB-FR slurry composition in an amount between about 0 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more nonionic surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Sorbitan and Sorbitol Esters

Suitable sorbitan and/or sorbitol esters for use in this disclosure include, without limitation, sorbitan mono ester such as sorbitan caprylate, sorbitan undecylenate, sorbitan laurate, sorbitan palmitate, sorbitan isostearate, sorbitan oleate, sorbitan stearate, etc.; sorbitan sesquiesters such as sesquicaprylate, sorbitan sesquiisostearate, sorbitan sesquioleate, sorbitan sesquistearate, etc.; sorbitan diesters such as sorbitan diisostearate, sorbitan dioleate, sorbitan distearate, etc.; sorbitan triesters such as sorbitan triisostearate, sorbitan trioleate, sorbitan tristearate, etc.; mixed-chain sorbitan esters such as sorbitan cocoate, sorbitan olivate, sorbitan palmate, sorbitan Theobroma grandiflorum seedate, etc.; or any mixture or combination thereof. Other sorbitan or sorbitol esters include, without limitation, PEGs sorbitan and sorbitol fatty acid esters including PEG-20 sorbitan cocoate, PEG-40 sorbitan diisostearate, PEG-2 sorbitan isostearate, PEG-5 sorbitan isosteatate, PEG-20 sorbitan isostearate, PEG-40 sorbitan lanolate, PEG-75 sorbitan lanolate, PEG-10 sorbitan laurate, PEG-40 sorbitan laurate, PEG-44 sorbitan laurate, PEG-75 sorbitan laurate, PEG-80 sorbitan laurate, PEG-3 sorbitan oleate, PEG-6 sorbitan oleate, PEG-80 sorbitan palmitate, PEG-40 sorbitan perisostearate, PEG-40 sorbitan peroleate, PEG-3 sorbitan stearate, PEG-6 sorbitan stearate, PEG-40 sorbitan stearate, PEG-60 sorbitan stearate, PEG-30 sorbitan tetraoleate, PEG-40 sorbitan tetraoleate, PEG-60 sorbitan tetraoleate, PEG-60 sorbitan tetrasterate, PEG-160 sorbitan triisostearate; PEG-20 sorbitan triisostearate, Sorbeth-40 hexaoleate (Sorbeth is a tradename of SpecialChem), Sorbeth-50 hexaoleate, Sorbeth-30 tetraoleate laurate, Sorbeth-60 tetrastearate, and any mixture thereof, provided that the surfactants are water soluble or water miscible at the concentration used in specific formulations. These PEG sorbitans or sorbitols range from tan, waxy solids and amber-colored pastes to clear yellow liquids. Other exemplary nonionic surfactants include, without limitation, polyoxyethylene surfactants such as POE sorbitan monolaurate (TWEEN® 20, HLB 17), POE sorbitan monopalmitate (TWEEN® 40, HLB 15.6), POE sorbitan monostearate (TWEEN® 60, HLB 15.0), POE sorbitan monooleate (TWEEN® 80, HLB 15.0), POE sorbitan tristearate (TWEEN® 65, HLB 10.5), POE sorbitan trioleate (TWEEN® 85, HLB 11.0), POE glycerol trioleate (TAGAT® TO, HLB 11.5), POE-40-hydrogenated castor oil (solid) Cremophor RH 40, HLB 14.0 to 16.0), POE-35-castor oil (Cremophor EL (liquid), HLB 12.0-14.0), POE (10) oleyl ether (BRIJ™ 96, HLB 12.4), POE (23) lauryl ether (BRIJ™ 35, HLB 16.9), POE-vitamin E (Alpha-tocopherol TPGS, HLB 13.0), and mixtures or combinations thereof, provided that the surfactants are water soluble or water miscible at the concentration used in specific formulations.

In certain embodiments, the one or more sorbitan and/or sorbitol ester surfactants may be present in the WB-FR slurry composition in an amount between about 0 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more sorbitan and/or sorbitol ester surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Poloxamers

Suitable poloxamers include, without limitation, are nonionic triblock copolymers composed of a central hydrophobic chain of polyoxypropylene (poly(propylene oxide)) flanked by two hydrophilic chains of polyoxyethylene (poly(ethylene oxide)), provided that the surfactants are water soluble or water miscible at the concentration used in specific formulations. Poloxamers are also known by the tradenames SYNPERONIC®, PLURONIC®, and KOLLIPHOR®. Because the lengths of the polymer blocks can be customized, many different poloxamers exist that have slightly different properties, provided that the surfactants are water soluble or water miscible at the concentration used in specific formulations. For the generic term poloxamer, these copolymers are commonly named with the letter P (for poloxamer) followed by three digits: the first two digits multiplied by 100 give the approximate molecular mass of the polyoxypropylene core, and the last digit multiplied by 10 gives the percentage polyoxyethylene content (e.g., P407=poloxamer with a polyoxypropylene molecular mass of 4000 g/mol and a 70% polyoxyethylene content). For the PLURONIC® and SYNPERONIC® tradenames, coding of these copolymers starts with a letter to define its physical form at room temperature (L=liquid, P=paste, F=flake (solid)) followed by two or three digits, The first digit (two digits in a three-digit number) in the numerical designation, multiplied by 300, indicates the approximate molecular weight of the hydrophobe; and the last digit×10 gives the percentage polyoxyethylene content (e.g., L61 indicates a polyoxypropylene molecular mass of 1800 g/mol and a 10% polyoxyethylene content), provided that the surfactants are water soluble or water miscible at the concentration used in specific formulations. In the example given, poloxamer 181 (P181)=PLURONIC® L61 and SYNPERONIC® PE/L 61, provided that the surfactants are water soluble or water miscible at the concentration used in specific formulations.

In certain embodiments, the one or more poloxamers may be present in the WB-FR slurry composition in an amount between about 0 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more cationic surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Nonionic Neutral Polymers

Suitable nonionic neutral polymers include, without limitation, pH responsive nonionic polymers and temperature sensitive nonionic polymers. Exemplary examples of such pH responsive nonionic polymers include, without limitation, pH responsive dendrimers such as poly-amidoamide (PAMAM), dendrimers, poly(propyleneimine) dendrimers, poly(-lisine) ester, poly(hydroxyproline), Poly(propyl acrylic acid), poly(methacrylic acid), CARBOPOL™, EUDRAGIT™ 5-100, EUDRAGIT™ L-100, chitosan, poly(methacrylic acid) (PMMA), PMAA-PEG copolymer, N,N-dimethylaminoethyl methacrylate (DMAEMA), and any mixture thereof. Exemplary examples of temperature sensitive polymer include, without limitation, poloxamers, prolastin, poly(n-substituted acrylamide), poly(organophosphazene), cyclotriphosphazenes with poly(ethyleneglycol) and amino acid esters, block copolymers of poly(ethylene glycol)/poly(lactic-co-glycolic acid), poly(ethylene glycol) (PEG), poly(propylene glycol) (PPG), PMAA, poly(vinyl alcohol) (PVA), various silk-elastin-like polymers, poly(silamine), poly(vinyl methyl ether) (PVME), poly(vinyl methyl oxazolidone) (PVMO), poly(vinyl pyrrolidone) (PVP), poly(n-vinylcaprolactam), poly(N-vinyl isobutyl amid), poly(vinyl methyl ether), poly(N-vinylcaprolactam) (PVCL), poly(siloxyethylene glycol), poly(dimethylamino ethyl methacrylate), triblock copolymer poly(DL-lactide-co-glycolide-b-ethylene glycol-b-DL-lactide-co-glycolide) (PLGA-PEG-PLGA), cellulose derivatives, alginate, gellan, xyloglucan, and any mixture thereof, provided that the surfactants are water soluble or water miscible at the concentration used in specific formulations.

In certain embodiments, the one or more nonionic neutral polymer surfactants may be present in the WB-FR slurry composition in an amount between about 0 wt. % and about 5 wt. %, which includes an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

In other embodiments, the one or more nonionic neutral polymer surfactants are present in the WB-FR slurry composition in an amount between about 0.00 wt. % and about 4 wt. %, about 0.00 wt. % and about 3 wt. %, about 0.00 wt. % and about 2 wt. %, about 0.00 wt. % and about 1 wt. %, about 0.01 wt. % and about 5 wt. %, about 0.01 wt. % and about 4 wt. %, about 0.01 wt. % and about 3 wt. %, about 0.01 wt. % and about 2 wt. %, about 0.05 wt. % and about 5 wt. %, about 0.05 wt. % and about 4 wt. %, or about 0.05 wt. % and about 3 wt. %.

### Downhole Fluids

Suitable downhole fluids for use in this disclosure include, without limitation, drilling fluids and treating fluid compositions include, without limitation: (a) fracturing fluid compositions including slickwater fracturing fluid compositions, high viscosity treating fluid compositions, non-proppant-containing fracturing fluid compositions, and proppant-containing fracturing fluids, (b) completion fluids, (c) stimulation fluid compositions, (d) zone isolation fluid compositions, or any other downhole fluid.

### Hydratable Polymers

Suitable hydratable polymers or gelling agents that may be used in the disclosure include, without limitation, any hydratable polysaccharides that are capable of forming a gel in the presence of a crosslinking agent. Exemplary examples of hydratable polysaccharides include, without limitation, galactomannan gums, glucomannan gums, guars, derivatized guars, cellulose derivatives, and mixtures or combinations thereof. Specific examples are guar gum, guar gum derivatives, locust bean gum, Karaya gum, carboxymethyl cellulose, carboxymethyl hydroxyethyl cellulose, and hydroxyethyl cellulose. Other specific examples include, without limitation, guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. In certain embodiments, the molecular weight of the hydratable synthetic polymers are between about 10,000 to about 100,000,000. In other embodiments, the molecular weight is between about 10,000 to about 10,000,000. In other embodiments, the molecular weight is between about 10,000 to about 1,000,000.

The hydratable polymer may be present in a fracturing fluid in concentrations ranging from about 0.05 wt. % to about 10 wt. %. In certain embodiments, the polymer concentration ranges between about 0.10 wt. % and about 5.0 wt. %. In other embodiments, the polymer concentration ranges between about 0.05 w. % and about 0.7 wt. % of the aqueous fluid. In certain embodiments, the hydratable polymer is present in a range from about 0.10 wt. % to about 0.25 wtl. %. If the polymer is in the form or a slurry, then the slurry is present in an amount between about 10 gpt and about 30 gpt (gallons per thousand gallons) of the fracturing fluid. In certain embodiments, the polymer slurry amount is between about 1 gpt and about 15 gpt. In other embodiments, the polymer slurry amount is between about between about 2 gpt and about 5 gpt.

### Crosslinking Agents

Suitable crosslinking agents include, without limitation, any compound that increases the viscosity of a fluid including the hydratable polymers by chemical crosslinks, physical crosslinks, and/or cross-links the hydratable polymer by any other mechanism. For example, the gelation of a hydratable polymer may be achieved by cross-linking the polymer with metal ions including boron, zirconium, and titanium containing compounds, or any mixture or combination thereof. One class of suitable crosslinking agents is organotitanates. Another class of suitable crosslinking agents is borates. The selection of an appropriate crosslinking agent depends upon the type of treatment to be performed and the hydratable polymer to be used. The amount of the crosslinking agent used also depends upon the well conditions and the type of treatment to be introduced. However, the range is generally from about 10 ppm to about 1000 ppm of metal ion of the crosslinking agent in the hydratable polymer fluid.

Other crosslinking agents may be a borate-containing compounds, titanate-containing compounds, zirconium-containing compound, and mixtures thereof. For example, the crosslinking agent can be sodium borateHH₂O (varying waters of hydration), boric acid, borate crosslinkers (a mixture of a titanate constituent, preferably an organotitanate constituent, with a boron constituent. The organotitanate constituent can be TYZOR⁷ titanium chelate esters from E.I du Pont de Nemours & Company. The organotitanate constituent can be a mixture of a first organotitanate compound having a lactate base and a second organotitanate compound having triethanolamine base. The boron constituent can be selected from the group consisting of boric acid, sodium tetraborate, and mixtures thereof. These are described in U.S. Pat. No. 4,514,309, incorporated herein by reference, borate based ores such as ulexite and colemanite, Ti(IV) acetylacetonate, Ti(IV) triethanolamine, Zr lactate, Zr triethanolamine, Zr lactate-triethanolamine, Zr lactate-triethanolamine-triisopropanolamine, or any mixture or combination thereof. In some embodiments, the well treatment fluid composition may further comprise a proppant.

Yet other crosslinking agents that crosslink polymer to even higher viscosities and more effective at carrying proppant into the fractured formation. The borate ion has been used extensively as a crosslinking agent, typically in high pH fluids, for guar, guar derivatives and other galactomannans. See, for example, U.S. Pat. No. 3,059,909, incorporated herein by reference and numerous other patents that describe this classic aqueous gel as a fracture fluid. Other crosslinking agents include, for example, titanium crosslinkers (U.S. Pat. No. 3,888,312, incorporated herein by reference), chromium, iron, aluminum, and zirconium (U.S. Pat. No. 3,301,723, incorporated herein by reference). Of these, the titanium and zirconium crosslinking agents are typically preferred. Examples of commonly used zirconium crosslinking agents include zirconium triethanolamine complexes, zirconium acetylacetonate, zirconium lactate, zirconium carbonate, and chelants of organic alphahydroxycorboxylic acid and zirconium. Examples of commonly used titanium crosslinking agents include titanium triethanolamine complexes, titanium acetylacetonate, titanium lactate, and chelants of organic alphahydroxycorboxylic acid and titanium. The crosslinking compositions may include mixtures or combination of any of crosslinking agents disclosed herein.

### Treating Fluid Composition Additives

Suitable additional additives include, without limitation, proppants, acids, diverting agents, fluid loss control additives, gas, nitrogen, carbon dioxide, surface modifying agents, tackifying agents, foamers, corrosion inhibitors, scale inhibitors, catalysts, clay control agents, biocides, antifoam agents, bridging agents, flocculants, H₂S scavengers, CO₂ scavengers, oxygen scavengers, lubricants, viscosifiers, breakers, weighting agents, relative permeability modifiers, resins, surfactants, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application.

### Proppants

Suitable proppants for use in this disclosure include, without limitation, fly ash, silica, alumina, fumed carbon (e.g., pyrogenic carbon), carbon black, graphite, mica, titanium dioxide, metal-silicate, silicate, kaolin, talc, zirconia, boron, hollow microspheres (e.g., spherical shell-type materials having an interior cavity), glass, sand, bauxite, sintered bauxite, ceramics, sintered ceramics, calcined clays (e.g., clays that have been heated to drive out volatile materials), partially calcined clays (e.g., clays that have been heated to partially drive out volatile materials), composite polymers (e.g., thermoset nanocomposites), halloysite clay nanotubes, carbon nanotube containing materials, and any combination thereof. The proppants may be of any shape (regular or irregular) suitable or desired for a particular application. In certain embodiments, the proppants may be round or spherical in shape, although they may also take on other shapes such as ovals, capsules, rods, toroids, cylinders, cubes, or variations thereof. In other embodiments, the proppants may be relatively flexible or deformable, which may allow them to enter certain perforations, microfractures, or other spaces within a subterranean oil and/or gas bearing formation whereas solid particulates of a similar diameter or size may be unable to do so.

To facilitate a better understanding of the present disclosure, the following examples of certain aspects of particular embodiments are given. The following examples are not the only examples that could be given according to the present disclosure and are not intended to limit the scope of the disclosure or claims.

### DETAILED DESCRIPTION OF THE DRAWING

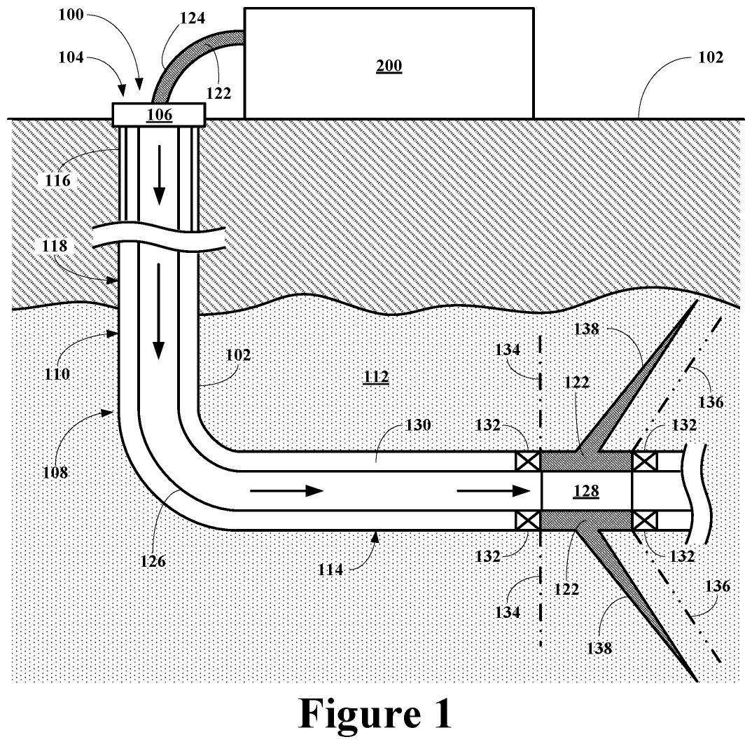

Referring now to FIG. 1, an embodiment of a wellsite, generally 100, located on a surface 102 at a location 104. The wellsite 100 includes a well head assembly 106 and a wellbore or borehole 108. The borehole 108 extends vertically from the surface 102 via a vertical section 110 thereof. Once the borehole 108 penetrates an oil and/or gas bearing subterranean formation 112, the borehole 108 extends horizontally into the formation 112 via a horizontal portion 114. Of course, it should be recognized that the borehole 108 may include horizontal, vertical, slant, curved, and other types of borehole geometries and orientations, and the fracturing treatment may be applied to an oil and/or gas subterranean zone surrounding any portion of the wellbore.

The borehole 108 also includes a casing 116 that is generally cemented in place or otherwise secured to a borehole wall 118. The borehole 108 may be uncased or include uncased sections. Perforations may also be formed in the casing 116 to allow fracturing fluids and/or other materials to flow into a portion 120 of the formation 112. In cased wells, perforations may be formed using shape charges, a perforating gun, hydro-jetting and/or other tools.

During a treating operation, the portion 120 of the formation 112 surrounding the borehole 108 will be exposed to a treating fluid 122. The treating fluid 122 will be supplied to the borehole 108 via a treating fluid supply line 124 coming from a treating fluid supply system 200. In the present configuration, the fracturing fluid 122 is forwarded to the portion 120 via a work string 126 extend from the well head assembly 106 into the borehole 108. The treating fluid supply system 200 is coupled to or associated with the work string 126 including an end assembly 128 to pump the treating fluid 122 into and through the working string 126 under treating conditions of pressure, flow rate, etc., out of the end 128, and into the portion 120. The working string 126 may include coiled tubing, jointed pipe, and/or other structures that allow fluid to flow into the borehole 108. The working string 126 may also include flow control devices, bypass valves, ports, and/or other tools or well devices that control a flow of treating fluid from the interior of the working string 126 into the portion or zone 120 of the formation 112. For example, the working string 126 may also include ports adjacent the wellbore wall 118 to directly communicate the treating fluid 122 into the portion 120 of the formation 112, and/or the working string 126 may include ports that are spaced apart (several feet to hundreds of feet apart) from the borehole wall 118 to communicate the treating fluid 122 into an annulus 130 in the wellbore between the working string 126 and the borehole wall 118.

The working string 126 and/or the borehole 108 may include one or more sets of packers 132 that seal the annulus between the working string 126 and borehole 108 to isolate the portion 120 into which the treating fluid 122 will be pumped or injected. Two of the packers 130 are disposed uphole to define an uphole boundary 134 of the portion 120 and two of the packers 130 are disposed downhole to define an end 136 of the portion 120. When the treating fluid 122 is introduced into working string 126 at a sufficient hydraulic pressure, one or more fractures 138 may be created in the portion 120. If the treating fluid is fracturing fluid including proppant, then the pressure will force the proppant-containing fracturing fluid into the portion 120 creating fractures 138. Depending on the pressure and pumping sequence, the proppant-containing fracturing fluid proppant will remain in the fractures 136 in a desired format to“prop” open the fractures 138 after pressure is removed so that fluids may flow more freely through the fractures 138 from the portion 120 into the borehole 108 and to the well head 106 for removal. In certain embodiments, multiple portions, zones, or intervals in the same formation 112 may be successively isolated and treated in a similar manner.

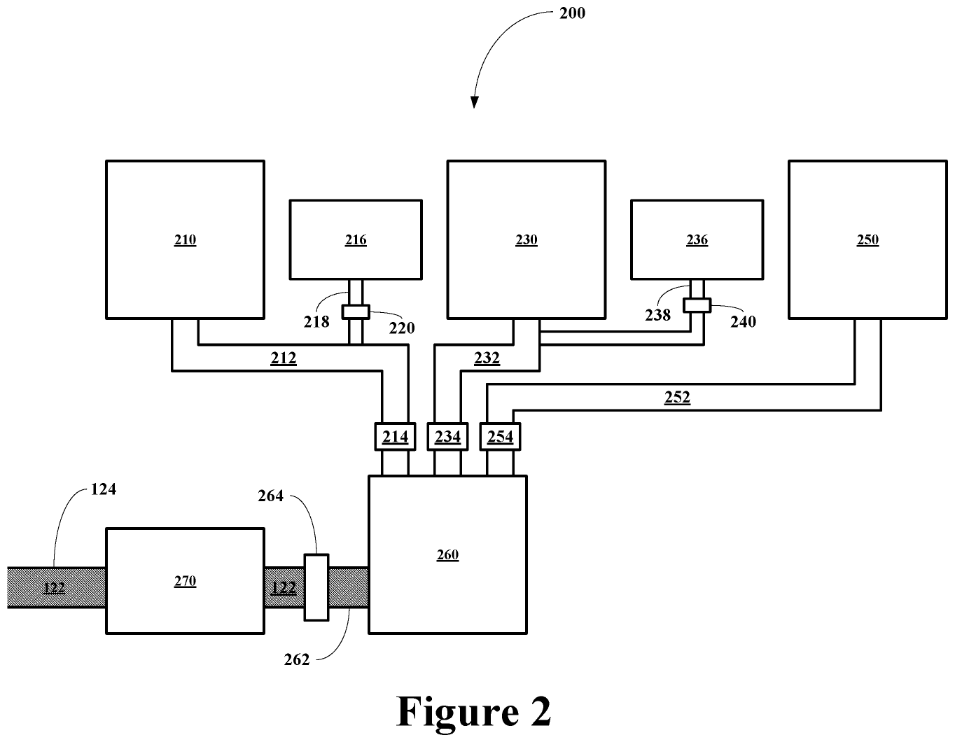

Referring now to FIG. 2, an embodiment of the treating fluid supply system 200 is shown to include a treating base fluid supply unit 210 including a treating base fluid transfer line 212 having a treating base fluid flow control valve 214 and a treating fluid additive unit 216 including a treating fluid additive transfer line 218 having a treating fluid additive flow control valve 220. The system 200 also includes a water-based, friction-reducing (WB-FR) slurry supply unit 230 including a WB-FR slurry transfer line 232 having a WB-FR slurry flow control valve 234 and a WB-FR slurry additive unit 236 including a WB-FR slurry additive transfer line 238 having a treating fluid additive flow control valve 240. The system 200 also includes a proppant supply unit 250 including a proppant transfer line 252 having a proppant flow control valve 254. Each transfer line 212, 232, and 252 are connected to a blending unit 260, which mixes the ingredients together for a time and at a mixing speed to form the treating fluid composition 122. The blending unit 260 includes a blending unit transfer line 262 having a blending unit flow control valve 264. The treating fluid composition 122 proceeds from the blending unit 260 through the transfer line 262 to a pumping unit 270, which supplies the transfer fluid composition 122 to the well head 106.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

### EXPERIMENTS OF THE DISCLOSURE

The following WB-FR slurry compositions of this disclosure were prepared using the non-limiting, illustrative blending procedure:
1. add indicated amount ammonium sulfate crystals and indicated amount of tap water to a 500 mL wide mouth plastic bottle equipped with Caframo over head stirrer;
2. stir at 2500 rpm for 0.5 hours;
3. add the indicated amount of certain components of the FR acid composition, slowly with stirring at 2500 rpm;
4. continue stirring for 0.5 hours;
5. add friction reducer powder
6. add indicated amounts of certain components of the FR additive composition, slowly with stirring at 2500 rpm; and
7. continue stirring for 1.0 hour.

### Example 1

This example illustrates the preparation of a WB-FR slurry composition of this disclosure including acrylamide/2-acrylamido-2-methylpropane sulfonic acid (PAM/AMPS) copolymer.

This example includes the following ingredients:

| Ingredient | g | wt. % | Function |
|---|---|---|---|
| Tap Water | 37.15 | 37.15 | Mobility/Medium |
| Clay | 1.0 | 1.0 | Suspending or Dispersing Agent |
| Ammonium Sulfate | 37.15 | 37.15 | Hydration Prevention Agent |
| PAM/AMPS Copolymer | 22.0 | 22.0 | Friction Reducing Agent |
| PEG 300 | 1.5 | 1.5 | Gel-Bridging Agents |
| EDTA | 1.2 | 1.2 | pH Adjusting Agents |

The composition were added in the order of appearance in accord with the general blending procedure set forth above. Ammonium sulfate crystals were visible in the slurry.

### Example 2

This example illustrates the preparation of a WB-FR slurry composition of this disclosure including acrylamide/acrylic acid (PAM/AA) copolymer.

This example includes the following ingredients:

| Ingredient | g | wt. % | Function |
|---|---|---|---|
| Tap Water | 37.15 | 37.15 | Mobility/Medium |
| Clay | 1 | 1 | Suspending or Dispersing Agent |
| Ammonium Sulfate | 37.15 | 37.15 | Hydration Prevention Agent |
| PAM/AA Copolymer | 22 | 22 | Friction Reducing Agent |
| PEG 300 | 1.5 | 1.5 | Gel-Bridging Agents |
| EDTA | 1.2 | 1.2 | pH Adjusting Agents |

The composition were added in the order of appearance in accord with the general blending procedure set forth above. Ammonium sulfate crystals were visible in the slurry.

### Example 3

This example illustrates the preparation of a WB-FR slurry composition of this disclosure including acrylamide/acrylamide ammonium salt (PAM/AMA) copolymer.

This example includes the following ingredients:

| Ingredient | g | wt. % | Function |
|---|---|---|---|
| Tap Water | 37.15 | 37.15 | Mobility/Medium |
| Clay | 1 | 1 | Suspending or Dispersing Agent |
| Ammonium Sulfate | 37.15 | 37.15 | Hydration Prevention Agent |
| PAM/AMA Copolymer | 22 | 22 | Friction Reducing Agent |
| PEG 300 | 1.5 | 1.5 | Gel-Bridging Agents |
| EDTA | 1.2 | 1.2 | pH Adjusting Agents |

The composition were added in the order of appearance in accord with the general blending procedure set forth above. Ammonium sulfate crystals were visible in the slurry.

### Example 4

This example illustrates the preparation of a WB-FR slurry composition of this disclosure including a cationic acrylamide polymer and potassium formate.

| Ingredient | wt. % | Function |
|---|---|---|
| Tap Water | 16.75 | Mobility/Medium |
| Potassium Formate | 50.24 | Hydration Prevention Agent |
| Fumed Silica | 1.340 | Suspending or Dispersing Agent |
| Citric Acid | 1.67 | Hydration Prevention Agent/pH adjuster |
| Cationic FR | 30.00 | Friction Reducing Agent |

### Examples 5 Through 7

These examples illustrate the preparation of WB-FR slurry compositions of this disclosure including acrylamide/2-acrylamido-2-methylpropane sulfonic acid (PAM/AMPS) copolymer.

These examples include the ingredients, viscosity values, and specific gravity values set forth in the following table:

| | Example 5 | Example 6 | Example 7 |
|---|---|---|---|
| Ingredient | wt. % | wt. % | wt. % |
| Tap Water | 38.60 | 35.70 | 32.75 |
| Clay | 0.80 | 0.60 | 0.50 |
| Ammonium Sulfate | 38.60 | 35.70 | 32.75 |
| PAM/AMPS Copolymer | 22.00 | 26.00 | 31.60 |
| Anhydrous Citric Acid | 2.00 | 2.00 | 2.40 |
| Viscosity (cP) | 46 | 160 | 250 |
| Specific Gravity | 1.3243 | 1.3128 | 1.2515 |

Viscosity was measured at 77° F. using a Fann 35A Viscometer with R1B1 bob at 511s⁻¹, ammonium sulfate is industrial analyzed at 21% total nitrogen and 24% total sulfur. Ammonium sulfate crystals were visible in the slurry.

### Example 8

This example illustrates the preparation of a WB-FR slurry composition of this disclosure including acrylamide/2-acrylamido-2-methylpropane sulfonic acid (PAM/AMPS) copolymer.

This example includes the following ingredients:

| Ingredient | g | wt. % | Function |
|---|---|---|---|
| Tap Water | 37.15 | 37.15 | Mobility/Medium |
| Clay | 1.0 | 1.0 | Suspending or Dispersing Agent |
| Ammonium Sulfate | 37.15 | 37.15 | Hydration Prevention Agent |
| PAM/AMPS Copolymer | 22.0 | 22.0 | Friction Reducing Agent |
| PEG 300 | 1.5 | 1.5 | Gel-Bridging Agents |
| EDTA | 1.2 | 1.2 | pH Adjusting Agents |

The composition were added in the order of appearance in accord with the general blending procedure set forth above. Ammonium sulfate crystals were visible in the slurry.

The viscosity values of the WB-FR composition of Example 8 reducing composition were measured when the WB-FR compositions were added to a synthetic water at two different gpt values. The two WB-FR compositions were mixed for 3 minutes at 1,000 rpm into 500 mL of synthetic water at the two different gpt values and the viscosities were measured using a Fann 35 viscometer. The results are tabulated in the following table.

| | | Viscosity | Viscosity | Viscosity | Viscosity |
|---|---|---|---|---|---|
| WB-FR | Amount | (1 minute) | (3 minute) | (5 minute) | (10 minute) |
| Composition | gpt | cP | cP | cP | cP |
| Example 8 | 4 | 6.6 | 6.6 | 4.8 | 4.8 |
| | 8 | 14.4 | 14.4 | 9.6 | 9.6 |

### Example 9

This example illustrates the preparation of a WB-FR slurry composition of this disclosure including acrylamide/2-acrylamido-2-methylpropane sulfonic acid (PAM/AMPS) copolymer.

This example includes the following ingredients were stirred at 2500 rpm for 1 hour via an over head stirrer as tabulated below:

| | PAM/AMPS | |
|---|---|---|
| Ammonium Sulfate | Copolymer | |
| (wt. % in tap water) | (g) | Visual observation |
| 30 | 25 | Immediate hydration to a white solid |
| | | mass, did not show any mobility |
| 35 | 25 | Highly viscous white flowing mass |
| 40 | 25 | Highly viscous white flowing mass |
| 50 | 25 | Highly viscous white flowing mass |

### EMBODIMENTS OF THE DISCLOSURE

### FR Slurry Compositions

### Salt Concentration Above Salt Saturation Concentration

Embodiment 1. A water-based, friction reducing (WB-FR) slurry composition comprising:
a friction-reducing (FR) base fluid,
a dry particulate, water-soluble, friction-reducing (DP-WS-FR) polymer composition, and
a FR salt effective amount of a FR salt composition,
wherein the FR salt effective amount is sufficient to produce a salt concentration above a salt saturation concentration at 20° C. based on the amount of water in the WB-FR slurry composition and to reduce or prevent hydration of the DP-WS-FR polymer composition during production, storage, and transportation.

Embodiment 2. The Embodiment of Embodiment 1, wherein the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition.

Embodiment 3. The Embodiment of Embodiment 1, wherein the DP-WS-FR composition includes one or more DP-WS-FR polymers or a mixture to two or more DP-WS-FR polymers.

Embodiment 4. The Embodiment of Embodiment 1, wherein the WB-FR slurry compositions further comprising a FR acid composition.

Embodiment 5. The Embodiment of Embodiment 1, wherein the WB-FR slurry compositions further comprising a FR additive composition.

Embodiment 6. The Embodiment of Embodiment 1, wherein the WB-FR slurry compositions further comprising a FR surfactant composition.

Salt Concentration Above Salt Saturation Concentration with FR Acid Composition

Embodiment 7. A water-based friction reducing (WB-FR) slurry composition comprising a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation and the FR acid effective amount of a FR acid composition is sufficient to reduce or prevent ammonia generation during production, storage, and transportation.

Embodiment 8. The Embodiment of Embodiment 7, wherein the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition, and the FR acid effective amount is between about 0.1 wt % and about 10 wt. % based on the amount of water in the WB-FR slurry composition.

Embodiment 9. The Embodiment of Embodiment 7, wherein the DP-WS-FR composition includes one or more DP-WS-FR polymers or a mixture to two or more DP-WS-FR polymers.

Embodiment 10. The Embodiment of Embodiment 7, wherein the WB-FR slurry compositions further comprising a FR additive composition.

Embodiment 11. The Embodiment of Embodiment 7, wherein the WB-FR slurry compositions further comprising a FR surfactant composition.

Salt Concentration Below Salt Saturation Concentration with FR Acid Composition

Embodiment 12. A water-based friction reducing (WB-FR) slurry composition comprising a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration below a salt saturation concentration at 20° C. based on the amount of water in the WB-FR slurry composition, the FR salt effective amount and the FR acid effective amount are sufficient to reduce or prevent hydration of the DP-WS-FR polymer composition during production, storage, and transportation of the WB-FR slurry composition, and the FR acid effective amount is also sufficient to reduce or prevent ammonia generation during production, storage, and transportation of the WB-FR slurry composition.

Embodiment 13. The Embodiment of Embodiment 12, wherein the FR salt effective amount is between about 30 wt. % up to a salt saturation concentration at 20° C. and the FR acid effective amount is between about 0.1 wt % and about 10 wt. %.

Embodiment 14. The Embodiment of Embodiment 12, wherein the DP-WS-FR composition includes one or more DP-WS-FR polymers or a mixture to two or more DP-WS-FR polymers.

Embodiment 15. The Embodiment of Embodiment 12, wherein the WB-FR slurry compositions further comprising a FR additive composition.

Embodiment 16. The Embodiment of Embodiment 12, wherein the WB-FR slurry compositions further comprising a FR surfactant composition.

### Downhole Fluid Compositions

### General Fluid Composition

Embodiment 17. A downhole fluid composition comprising a downhole base fluid, a downhole fluid additive composition, and a slurry effective amount of a WB-FR slurry composition of the Embodiments 1 through 16, wherein the slurry effective amount is sufficient to reduce frictional drag or to reduce a percent drag reduction of the downhole fluid compositions as the downhole fluid compositions are pumped from the surface through a tubular apparatus and into subterranean oil and/or gas bearing formations during formation treatment operations under formation treatment conditions or circulated through a drill string during drilling operations under drilling conditions.

Embodiment 18. The Embodiment of Embodiment 17, wherein the downhole fluid composition comprises: (a) fracturing fluid compositions including slickwater fracturing fluid compositions, high viscosity fracturing fluid compositions, non-proppant-containing fracturing fluid compositions, and proppant-containing fracturing fluids, (b) completion fluid compositions, (c) stimulation fluid compositions, (d) zone isolation fluid compositions, or (e) other downhole fluid compositions.

Fracturing Fluid Composition without Proppant

Embodiment 19. A fracturing fluid composition comprising a fracturing base fluid, a fracturing fluid additive composition, and a slurry effective amount of a WB-FR slurry composition of the Embodiments 1 through 16, wherein the slurry effective amount is sufficient to reduce fluid friction or to reduce a percent drag reduction of the fracturing fluid compositions as the fracturing fluid compositions are pumped from the surface through a tubular apparatus and into subterranean oil and/or gas bearing during formation fracturing operations under formation fracturing conditions.

Fracturing Fluid Composition with Proppant

Embodiment 20. A fracturing fluid composition comprising a fracturing base fluid, a fracturing fluid additive composition, a slurry effective amount of a WB-FR slurry composition of the Embodiments 1 through 16, and one or more proppants, wherein the slurry effective amount is sufficient to reduce fluid friction or to reduce a percent drag reduction of the fracturing fluid compositions as the fracturing fluid compositions are pumped from the surface through a tubular apparatus and into subterranean oil and/or gas bearing formations during formation fracturing operations under formation fracturing conditions.

### Drilling Fluid Composition

Embodiment 21. A drilling fluid composition comprising a drilling base fluid, a drilling fluid additive composition, and a slurry effective amount of a WB-FR slurry composition of the Embodiments 1 through 16, wherein the slurry effective amount is sufficient to reduce fluid friction or reduce a percent drag during drilling into subterranean oil and/or gas bearing formations under drilling conditions.

### Methods of Making WB-FR Slurry Compositions

### Salt Concentration Above Salt Saturation Concentration

Embodiment 22. A method of making a WB-FR slurry composition comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition and a FR salt effective amount of a FR salt composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation.

Embodiment 23. The Embodiment of Embodiment 22, wherein the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition.

Embodiment 24. The Embodiment of Embodiment 22, wherein the DP-WS-FR composition includes one or more DP-WS-FR polymers or a mixture to two or more DP-WS-FR polymers.

Embodiment 25. The Embodiment of Embodiment 22, wherein the WB-FR slurry compositions further comprising a FR acid composition.

Embodiment 26. The Embodiment of Embodiment 22, wherein the WB-FR slurry compositions further comprising a FR additive composition.

Embodiment 27. The Embodiment of Embodiment 22, wherein the WB-FR slurry compositions further comprising a FR surfactant composition.

Salt Concentration Above Salt Saturation Concentration with FR Acid Composition

Embodiment 28. A method of making a WB-FR slurry composition comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration above a salt saturation concentration at 20° C. based on the amount of water in the WB-FR slurry composition and to reduce or prevent hydration of the DP-WS-FR polymer composition during production, storage, and transportation and the FR acid effective amount of a FR acid composition is sufficient to reduce or prevent ammonia generation during production, storage, and transportation.

Embodiment 29. The Embodiment of Embodiment 28, wherein the FR salt effective amount is between about 0.25 wt. % and about 20 wt. % of the FR salt composition above the salt saturation concentration of the salts in the FR salt composition in the WB-FR slurry compositions at 20° C. based on the amount of water in the WB-FR slurry composition, i.e., the WB-FR slurry compositions include between about 0.25 wt. and about 20 wt. % of undissolved salts from the FR salt composition at 20° C. based on the amount of water in the WB-FR slurry composition, and the FR acid effective amount is between about 0.1 wt % and about 10 wt. % based on the amount of water in the WB-FR slurry composition.

Embodiment 30. The Embodiment of Embodiment 28, wherein the DP-WS-FR composition includes one or more DP-WS-FR polymers or a mixture to two or more DP-WS-FR polymers.

Embodiment 31. The Embodiment of Embodiment 28, wherein the WB-FR slurry compositions further comprising a FR additive composition.

Embodiment 32. The Embodiment of Embodiment 28, wherein the WB-FR slurry compositions further comprising a FR surfactant composition.

Salt Concentration Below Salt Saturation Concentration with FR Acid Composition

Embodiment 33. A method of making a WB-FR slurry composition comprising the steps of sequentially adding WB-FR ingredients at room temperature, wherein the WB-FR ingredients include a friction-reducing (FR) base fluid, a dry particulate, water-soluble, friction-reducing (DP-WS-FR) polymer composition, a FR salt effective amount of a FR salt composition, and a FR acid effective amount of a FR acid composition, wherein the FR salt effective amount of the FR salt composition is sufficient to produce a salt concentration below a salt saturation concentration at 20° C. based on the amount of water in the WB-FR slurry composition, the FR salt effective amount and the FR acid effective amount are sufficient to reduce or prevent hydration of the DP-WS-FR polymer composition during production, storage, and transportation of the WB-FR slurry composition, and the FR acid effective amount is also sufficient to reduce or prevent ammonia generation during production, storage, and transportation of the WB-FR slurry composition.

Embodiment 34. The Embodiment of Embodiment 33, wherein the FR salt effective amount is between about 30 wt. % and a salt saturation concentration at 20° C. and the FR acid effective amount is between about 0.1 wt % and about 10 wt. %.

Embodiment 35. The Embodiment of Embodiment 33, wherein the DP-WS-FR composition includes one or more DP-WS-FR polymers or a mixture to two or more DP-WS-FR polymers.

Embodiment 36. The Embodiment of Embodiment 33, wherein the WB-FR slurry compositions further comprising a FR additive composition.

Embodiment 37. The Embodiment of Embodiment 33, wherein the WB-FR slurry compositions further comprising a FR surfactant composition.

Embodiment 38. The Embodiment of Embodiment 33, wherein the mixing duration may be between about 0.5 hours to about 12 hours and the mixing speed may be between about 500 rpm and 5,000 rpm.

Embodiment 39. The Embodiment of Embodiment 33, wherein the mixing duration may be between about 1 hour to about 10 hours and the mixing speed may be between about 750 rpm and 5,000 rpm.

Embodiment 40. The Embodiment of Embodiment 33, wherein the mixing duration may be between about 1 hour to about 10 hours and the mixing speed may be between about 1,000 rpm and 5,000 rpm.

Embodiment 41. The Embodiment of Embodiment 33, wherein the mixing duration may be between about 2 hours to about 8 hours and the mixing speed may be between about 2,000 rpm and 5,000 rpm.

### Method for Treating a Formation

### Treating Fluid Compositions

Embodiment 42. A method of treating subterranean oil and/or gas bearing formations comprising: (a) adding a slurry effective amount of a WB-FR slurry composition of the Embodiments 1 through 16 to a treating fluid composition, and (b) pumping or injecting the non-proppant containing treating fluid composition into the subterranean oil and/or gas bearing formations under treating conditions including at a temperature and pressure and for a time sufficient to create and extend a treatment until a desired formation treatment is achieved, wherein the treating composition comprises a stimulation fluid composition, a slick water fracturing fluid, a low viscosity proppant containing fracturing fluid composition, a high viscosity non-proppant containing fracturing fluid composition, a high viscosity proppant containing fracturing fluid composition, or a low or high viscosity completion fluid composition.

### Fracturing Fluid Compositions

Embodiment 43. A method of a fracturing subterranean oil and/or gas bearing formation comprising: (a) adding a slurry effective amount of a WB-FR slurry composition of the Embodiments 1 through 16 to a fracturing fluid composition, and (b) pumping or injecting the fracturing fluid composition into the subterranean oil and/or gas bearing formation under fracturing conditions until a desired a fracturing network is formed.

Fracturing Fluid Compositions with Proppants

Embodiment 44. A method of a fracturing subterranean oil and/or gas bearing formation comprising: (a) adding a slurry effective amount of a WB-FR slurry composition of the Embodiments 1 through 16 to a fracturing fluid composition, (b) adding one or more proppants, and (c) pumping or injecting the fracturing fluid composition into the subterranean oil and/or gas bearing formation under fracturing conditions until a desired a fracturing network is formed.

Fracturing Fluid Compositions with and without Proppant

Embodiment 45. A method of fracturing a formation comprising: (a) adding a slurry effective amount of a WB-FR slurry composition of the Embodiments 1 through 16 to a non-proppant-containing fracturing fluid composition, (b) pumping or injecting the non-proppant-containing treating fluid composition into subterranean oil and/or gas bearing formations under non-proppant treating conditions, (c) adding a slurry effective amount of a WB-FR slurry composition of the Embodiments 1 through 16 to a proppant-containing fracturing fluid composition, and (d) pumping or injecting the proppant-containing fracturing fluid composition into the subterranean oil and/or gas bearing formation under proppant fracturing conditions, and (e) repeating steps (b) and (d) as required to form a desired fracture network and a desired proppant placement within fracture network within the subterranean oil and/or gas bearing formation.

Methods of Drilling into a Formation

Embodiment 46. A method of drilling into a subterranean oil and/or gas bearing formation comprising (a) adding a slurry effective amount of a WB-FR slurry composition of the Embodiments 1 through 16 to a drilling fluid composition including (i) a drilling fluid base fluid composition and (ii) a drilling fluid additive composition, and (b) circulating the drilling fluid composition during drilling operations under drilling conditions.

### FR Base Fluids

Embodiment 47. The Embodiment of any of the previous Embodiments, wherein the FR base fluid comprises a water composition.

### Water Compositions

Embodiment 48. The Embodiment of Embodiment 47, wherein the water composition comprises fresh water, saltwater, a brine, seawater, produced water, reclaimed water, high totally dissolved solid (TDS) containing water, a high TDS produced water, a high TDS flow back water, a high TDS fracturing flow back water, a brackish water, a reverse osmosis (RO) reject water, a clear brine, an aqueous fluid formulated using any combination of these water compositions, or any mixture and combination thereof.

### DP-WS-FR Polymer Compositions

Embodiment 49. The Embodiment of any of the previous Embodiments, wherein the DP-WS-FR composition comprises one or more DP-WS-FR polymers.

Embodiment 50. The Embodiment of Embodiment 49, wherein the one or more DP-WS-FR polymers comprise one or more acrylamide copolymers, one or more anionic acrylamide copolymers, one or more cationic acrylamide copolymers, one or more nonionic acrylamide copolymers, one or more amphoteric or zwitterionic acrylamide copolymers, one or more polyacrylamides, one or more derivatives of an acrylamide polymer, one or more acrylate polymers, one or more derivatives of an acrylate polymer, one or more methacrylate polymers, one or more derivatives of a methacrylate polymers, or any mixture or combination thereof.

Embodiment 51. The Embodiment of Embodiment 49, wherein the one or more DP-WS-FR polymers comprise a polyacrylate, a polyacrylate derivative, a polyacrylate copolymer, a polymethacrylate, a polymethacrylate derivative, a polymethacrylate copolymer, a polyacrylamide, a polyacrylamide derivative, a polyacrylamide copolymer, an acrylamide copolymer, a polysaccharide, a polysaccharide derivative, a polysaccharide copolymer, synthetic polymers, a superabsorbent polymer, or any mixture or combination thereof.

Embodiment 52. The Embodiment of Embodiment 49, wherein the one or more DP-WS-FR polymers comprise a polymer containing one or more monomers comprising acrylamide, acrylic acid, methacrylic acid, vinyl acetate, vinyl sulfonic acid, N-vinyl acetamide, N-vinyl formamide, itaconic acid, an ester of acrylic acid, wherein the ester group is a hydrocarbyl or a heterohydrocarbyl group, an ester methacrylic acid, wherein the ester group is a hydrocarbyl or a heterohydrocarbyl group, ethoxylated-2-hydroxyethyl acrylate, ethoxylated-2-hydroxyethyl methacrylate, 2-hydroxyethyl acrylate, 2-hydroxyethylmethyl methacrylate, 2-hydroxypropyl acrylate, 2-hydroxypropyl methacrylate, hydroxymethyl styrene, 2-acrylamido-2-methylpropane sulfonic acid (AMPS), acrylamido tertiary butyl sulfonic acid (ATBS), 2-(meth)acrylamido-2-methylpropane sulfonic acid, 2-amino-2-methyl-1-propanol (AMP), N,N-dimethylacrylamide (DMAA), a salt of any of the foregoing, or any mixture or combination thereof.

Embodiment 53. The Embodiment of Embodiment 52, wherein the one or more DP-WS-FR polymers comprise one or more copolymers including acrylamide and AMPS.

Embodiment 54. The Embodiment of Embodiment 49, wherein the one or more DP-WS-FR polymers comprise a high molecular weight, linear polymer.

Embodiment 55. The Embodiment of Embodiment 49, wherein the one or more DP-WS-FR polymers comprise one or more monomers selected from the group consisting of acrylamide, acrylic acid, 2-acrylamido-2-methylpropane sulfonic acid, acrylamido tertiary butyl sulfonic acid, a salt of any of the foregoing, or any combination thereof.

Embodiment 56. The Embodiment of Embodiment 49, wherein the one or more DP-WS-FR polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000.

Embodiment 57. The Embodiment of Embodiment 49, wherein the one or more DP-WS-FR polymer composition further comprising a water-soluble guar, a water-soluble guar derivative thereof, or any mixture or combination thereof.

### FR Salt Compositions

Embodiment 58. The Embodiment of any of the previous Embodiments, wherein the FR salt compositions comprise ammonium sulfate or a mixture of ammonium sulfate and one or more other salts.

Embodiment 59. The Embodiment of Embodiment 58, wherein the mixture comprises between about 50 wt. % and about 99.99 wt. %.

Embodiment 60. The Embodiment of Embodiment 59, wherein the mixture comprises at least about 50 wt. % ammonium sulfate, at least about 55 wt. % ammonium sulfate, at least about 60 wt. % ammonium sulfate, at least about 65 wt. % ammonium sulfate, at least about 70 wt. % ammonium sulfate, at least about 75 wt. % ammonium sulfate, at least about 80 wt. % ammonium sulfate, at least about 85 wt. % ammonium sulfate, at least about 90 wt. % ammonium sulfate, or at least about 95 wt. % ammonium sulfate based on a weight of all of the salts.

Embodiment 61. The Embodiment of Embodiment 58, wherein the one or more other salts comprise one or more carbonate salts, one or more sulfate salts, one or more phosphate salts, one or more fluoride salts, one or more chloride salts, one or more bromide salts, one or more formate salts, one or more acetate salts, one or more bicarbonate salts, one or more nitrate salts, or any mixture or combination thereof.

Embodiment 62. The Embodiment of Embodiment 61, wherein the one or more carbonate salts comprise ammonium carbonate, sodium carbonate, potassium carbonate, aluminum carbonate, magnesium carbonate, calcium carbonate, barium carbonate, strontium carbonate, zinc carbonate, other metal carbonates, or any mixture or combination thereof.

Embodiment 63. The Embodiment of Embodiment 61, wherein the one or more sulfate salts comprise ammonium sulfate, sodium sulfate, potassium sulfate, aluminum sulfate, magnesium sulfate, calcium sulfate, barium sulfate, strontium sulfate, zinc sulfate, other metal sulfates, or any mixture or combination thereof.

Embodiment 64. The Embodiment of Embodiment 61, wherein the one or more phosphate salts comprise mono, di, or tri ammonium phosphate, mono, di, or tri sodium phosphate, mono, di, or tri potassium phosphate, aluminum phosphate, magnesium phosphate, calcium phosphate, barium phosphate, strontium phosphate, zinc phosphate, other metal phosphates, or any mixture or combination thereof.

Embodiment 65. The Embodiment of Embodiment 61, wherein the one or more fluoride salts comprise ammonium fluoride, sodium fluoride, potassium fluoride, calcium fluoride, magnesium fluoride, strontium fluoride, barium fluoride, other metal fluorides, or any mixture or combination thereof.

Embodiment 66. The Embodiment of Embodiment 61, wherein the one or more chloride salts comprise ammonium chloride, sodium chloride, potassium chloride, calcium chloride, magnesium chloride, strontium chloride, barium chloride, other metal chlorides, or any mixture or combination thereof.

Embodiment 67. The Embodiment of Embodiment 61, wherein the one or more bromide salts comprise sodium bromide, potassium bromide, calcium bromide, magnesium bromide, zinc bromide, strontium bromide, other metal bromides, or any mixture or combination thereof.

Embodiment 68. The Embodiment of Embodiment 61, wherein the one or more formate salts comprise ammonium formate, sodium formate, potassium formate, magnesium formate, strontium formate, barium formate, other metal formates, or any mixture or combination thereof.

Embodiment 69. The Embodiment of Embodiment 61, wherein the one or more acetate salts comprise ammonium acetate, sodium acetate, potassium acetate, calcium acetate, magnesium acetate, strontium acetate, barium acetate, other metal acetates, or any mixture or combination thereof.

Embodiment 70. The Embodiment of Embodiment 61, wherein the one or more bicarbonates comprise sodium bicarbonate, potassium bicarbonate, other metal bicarbonates, or any mixture or combination thereof.

Embodiment 71. The Embodiment of Embodiment 61, wherein the one or more nitrate salts comprise sodium nitrate, potassium nitrate, calcium nitrate, magnesium nitrate, zinc nitrate, strontium nitrate, other metal nitrate, or any mixture or combination thereof.

Embodiment 72. The Embodiment of Embodiment 61, wherein the one or more nitrate salts comprise sodium nitrate, potassium nitrate, calcium nitrate, magnesium nitrate, zinc nitrate, strontium nitrate, other metal nitrate, or any mixture or combination thereof.

Embodiment 73. The Embodiment of Embodiment 61, wherein the one or more nitrate salts comprise sodium nitrate, potassium nitrate, calcium nitrate, magnesium nitrate, zinc nitrate, strontium nitrate, other metal nitrate, or any mixture or combination thereof.

Embodiment 74. The Embodiment of Embodiment 58, wherein the one or more other salts comprise one or more divalent salts.

Embodiment 75. The Embodiment of Embodiment 74, wherein the one or more divalent salts comprises calcium, magnesium, or any mixture or combination thereof and one or more monovalent salts comprising ammonium, sodium, potassium, or any mixture or combination thereof.

Embodiment 76. The Embodiment of Embodiment 58, wherein the one or more other salts comprise phosphate based salts including potassium phosphate salts including potassium hexametaphosphate.

Embodiment 77. The Embodiment of Embodiment 58, wherein the one or more other salts comprise water-soluble potassium salts including potassium citrate, potassium carbonate, or any mixture or combination thereof.

Embodiment 78. The Embodiment of Embodiment 58, wherein the one or more other salts comprise multivalent salts including zinc chloride, aluminum chloride, iron chloride, zinc sulfate, aluminum sulfate, iron sulfate, or any mixture or combination thereof.

Embodiment 79. The Embodiment of Embodiment 58, wherein the one or more other salts comprise magnesium ammonium sulfates, calcium ammonium sulfates, aluminum ammonium sulfates, iron ammonium sulfates, nickel ammonium sulfates, copper ammonium sulfates, similar metal ammonium salts, or any mixture or combination thereof.

### FR Acid Compositions

Embodiment 80. The Embodiment of any of the previous Embodiments, wherein the FR acid compositions comprise one or more organic monoacids, one or more organic diacids, one or more organic polyacids, one or more organic hydroxy acids, or any mixture or combination thereof.

### Monoacids

Embodiment 81. The Embodiment of Embodiment 80, wherein the one or more organic monoacids.

Embodiment 82. The Embodiment of Embodiment 81, wherein the one or more organic monoacids comprise one or more saturated monoacids, one or more unsaturated monoacids, or any mixture or combination thereof.

Embodiment 83. The Embodiment of Embodiment 82, wherein the one or more saturated or unsaturated monoacids are suitable for a human, mammal, or animal consumption.

Embodiment 84. The Embodiment of Embodiment 83, wherein the one or more saturated or unsaturated monoacids having between 1 carbon atoms and about 8 carbon atoms or any mixture or combination thereof, provided that the monoacids are water soluble or water miscible at the concentration used in specific formulations.

Embodiment 85. The Embodiment of Embodiment 84, wherein the one or more saturated or unsaturated monoacids formic acid, acetic acid, propanoic acid, butyric acid, valeric acid, or any mixture or combination thereof.

Embodiment 86. The Embodiment of Embodiment 85, unused.

Embodiment 87. The Embodiment of Embodiment 85, used.

Embodiment 88. The Embodiment of Embodiment 85, unused.

Embodiment 89. The Embodiment of Embodiment 85, unused.

Embodiment 90. The Embodiment of Embodiment 85, unused.

### Diacids

Embodiment 91. The Embodiment of Embodiment 80, wherein the one or more organic diacids comprise one or more saturated diacids, one or more unsaturated diacids, or any mixture or combination thereof, provided that the diacids are water soluble or water miscible at the concentration used in specific formulations.

Embodiment 92. The Embodiment of Embodiment 91, wherein the one or more saturated organic diacids comprises ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), heneicosa-1,21-dioic acid (japanic acid), docosanedioic acid (phellogenic acid), triacontanedioic acid (equisetolic acid), or any mixture or combination thereof, provided that the diacids are water soluble or water miscible at the concentration used in specific formulations.

Embodiment 93. The Embodiment of Embodiment 91, wherein the one or more unsaturated organic diacids include, without limitation, (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), or any mixture or combination thereof, provided that the diacids are water soluble or water miscible at the concentration used in specific formulations.

Embodiment 94. The Embodiment of Embodiment 91, wherein the one or more organic diacids comprise one or more water miscible dicarboxylic acids.

### PolyAcids

Embodiment 95. The Embodiment of Embodiment 80, wherein the one or more organic polyacids comprise one or more polycarboxylic acid compounds, provided that the polycarboxylic acid compounds are water soluble or water miscible at the concentration used in specific formulations.

Embodiment 96. The Embodiment of Embodiment 95, wherein the one or more polycarboxylic acid compounds comprise citric acid, oxalic acid, ascorbic acid, isocitric acid, aconitic acid, propane-1,2,3-tricarboxylic acid, or any mixture or combination thereof.

Embodiment 97. The Embodiment of Embodiment 95, wherein the one or more polyacids comprise one or more water soluble polyacids including a plurality of one or more carboxylic acid group containing monomers, provided that the polycarboxylic acid compounds are water soluble or water miscible at the concentration used in specific formulations.

Embodiment 98. The Embodiment of Embodiment 97, wherein the one or more water soluble organic polyacids comprise acrylic acid homopolymers, methacrylic acid homopolymers, lactic acid homopolymers, glycol acid homopolymers, copolymers including two or more monomers selected from the group consisting of acrylic acid, methacrylic acid, lactic acid, and glycol acid, provided that the polycarboxylic acid compounds are water soluble or water miscible at the concentration used in specific formulations.

Embodiment 99. The Embodiment of Embodiment 98, wherein the one or more water soluble organic polyacids further comprise one or more ethylenically unsaturated monomers; provided, however, that the amount of the ethylenically unsaturated monomers do not render the resulting polymer water insoluble.

Embodiment 100. The Embodiment of Embodiment 99, wherein the one or more ethylenically unsaturated monomers comprise ethylene, propylene, styrene, or any mixture or combination thereof.

### Hydroxy Acids

Embodiment 101. The Embodiment of Embodiment 80, wherein the one or more organic hydroxy acids comprise 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phaseolic acid), 9,10,18-trihydroxyoctadecanoic acid (phloionolic acid), 7,14-dihydroxydocosa-4Z,8,10,12,16Z,19Z-hexaenoic acid (Maresin 1), 5S,12R,18R-trihydroxy-6Z,8E,10E,14Z,16E-eicosapentaenoic acid (resolvin E1), resolvin D1, 10,17S-docosatriene, (neuroprotectin D1), or any mixture or combination thereof, provided that the hydroxy acid compounds are water soluble or water miscible at the concentration used in specific formulations.

### FR Additive Compositions

Embodiment 102. The Embodiment of any of the previous Embodiments, wherein the FR additive compositions comprise one or more pH adjusting agents alone or in combination with one or more suspending/dispersing agents, one or more gel-bridging agents, or any mixture or combination thereof.

Suspending and/or Dispersing Agent

Embodiment 103. The Embodiment of Embodiment 102, wherein the one or more suspending/dispersing agents comprise a clay, fumed silica, or any mixture or combination thereof.

Embodiment 104. The Embodiment of Embodiment 103, wherein the clay comprises a water based clay, a modified clay, a bentonite clay, a phyllosilicate, or any mixture or combination thereof.

Embodiment 105. The Embodiment of Embodiment 104, wherein the clay comprises a clay having a nano-structure, a clay having a micro-structure, or any mixture or combination thereof.

### Gel-Bridging Agents

Embodiment 106. The Embodiment of Embodiment 102, wherein the one or more gel-bridging agents comprise one or more polyethylene glycols, one or more polypropylene glycols, one or more polyethylene/propylene glycols, one or more polyalkylene oxide polymers, or any mixture or combination thereof, provided that the gel-bridging agents are water soluble or water miscible at the concentration used in specific formulations.

Embodiment 107. The Embodiment of Embodiment 106, wherein the one or more polyethylene glycols comprise PEG 200, PEG 300, PEG 400, PEG 500, higher PEG polymers, or any mixture or combination thereof, provided that the polyethylene glycols are water soluble or water miscible at the concentration used in specific formulations.

### FR Surfactant Composition

Embodiment 108. The Embodiment of any of the previous Embodiments, wherein the WB-FR slurry composition further comprises: a FR surfactant composition.

Embodiment 109. The Embodiment of Embodiment 108, wherein the FR surfactant composition comprises one or more surfactants, provided that the surfactants are water soluble or water miscible at the concentration used in specific formulations.

Embodiment 110. The Embodiment of Embodiment 109, wherein the one or more surfactants comprise one or more anionic surfactants, one or more cationic surfactants, one or more zwitterionic or amphoteric surfactants, one or more nonionic surfactants, or any mixture or combination thereof, provided that the surfactants are water soluble or water miscible at the concentration used in specific formulations.

### Anionic Surfactants

Embodiment 111. The Embodiment of Embodiment 110, wherein the one or more anionic surfactants comprise one or more anionic sulfate surfactants, one or more alkyl ether sulfonate surfactants, one or more alkylaryl sulfonate surfactants, or any mixture or combination thereof, provided that the surfactants are water soluble or water miscible at the concentration used in specific formulations.

Embodiment 112. The Embodiment of Embodiment 111, wherein the one or more anionic sulfate surfactants comprise sodium or ammonium alcohol ether sulfate surfactants having the general formula:

R^{a}O—(CH₂CH₂O)ₙSO₃NH₄

wherein R^{a} is a carbon-containing group including an alkyl group, an aryl group, an alkaryl group, an aralkyl group, or any mixture or combination thereof, provided that the surfactants are water soluble or water miscible at the concentration used in specific formulations.

Embodiment 113. The Embodiment of Embodiment 112, wherein the one or more sodium or ammonium alcohol ether sulfate surfactants comprise one or more sodium or ammonium alcohol ether sulfate surfactants having between 2 and about 10 carbon atoms, one or more sodium or ammonium alcohol ether sulfate surfactants having between about 4 and 10 carbon atoms, one or more sodium or ammonium alcohol ether sulfate surfactants having between about 11 to about 24 carbon atoms, one or more sodium or ammonium alcohol ether sulfate surfactants having between about 12 and about 18 carbon atoms, one or more sodium or ammonium alcohol ether sulfate surfactants having between about 12 and about 14 carbon atoms, or any mixture or combination thereof, provided that the surfactants are water soluble or water miscible at the concentration used in specific formulations.

Embodiment 114. The Embodiment of Embodiment 113, wherein the one or more sodium or ammonium alcohol ether sulfate surfactants comprise sodium or ammonium alcohol ether sulfate surfactants prepared by reacting 1 to 10 moles of ethylene oxide per mole of an alkanol or 3 moles of ethylene oxide per mole of an alkanol, provided that the surfactants are water soluble or water miscible at the concentration used in specific formulations.

Embodiment 115. The Embodiment of Embodiment 111, wherein the one or more alkylaryl sulfonate surfactants comprise alkyl benzene sulfonic acids and their salts, dialkylbenzene disulfonic acids and their salts, dialkylbenzene sulfonic acids and their salts, alkyltoluene/alkyl xylene sulfonic acids and their salts, alkylnaphthalene sulfonic acids/condensed alkyl naphthalene sulfonic acids and their salts, alkylphenol sulfonic acids/condensed alkylphenol sulfonic acids and their salts, or any mixture or combination thereof, provided that the surfactants are water soluble or water miscible at the concentration used in specific formulations.

Embodiment 116. The Embodiment of Embodiment 111, wherein the one or more alkyl ether sulfonate surfactants comprise alkyl ether sulfonates having the general formula:

R^{b}[—(O—R^{c}O)ₘ—(R^{d}O)ₙ—(R^{e})]_{y}

wherein R^{b}=alkyl, alkenyl, amine, alkylamine, dialkylamine, trialkylamine, aromatic, polyaromatic, cycloalkane, cycloalkene, R^{c} and R^{d}=C₂H₄ or C₃H₆ or C₄H₈, R^{d}=linear or branched C₇H₁₄SO₃X to C₃₀H₆₀SO₃X when y=1, R^{e}=linear or branched C₇H₁₄SO₃X to C₃₀H₆₀SO₃X or H when y>1 but at least one R^{d} must be linear or branched C₇H₁₄SO₃X to C₃₀H₆₀SO₃X, m is greater or equal to 1, n is greater or equal to 0, n+m=1 to 30+, y is greater or equal to 1, X=alkali metal or alkaline earth metal or ammonium or amine, or any mixture or combination thereof, provided that the surfactants are water soluble or water miscible at the concentration used in specific formulations.

Embodiment 117. The Embodiment of Embodiment 110, wherein the one or more anionic surfactants comprise: (a) carboxylates including alkyl carboxylates-fatty acid salts, carboxylate fluoro surfactants, or any mixture or combination thereof; (b) sulfates including alkyl sulfates including sodium lauryl sulfate, sodium dodecyl sulfate, or any mixture or combination thereof, alkyl ether sulfates including sodium laureth sulfate; (c) sulfonates including docusates including dioctyl sodium sulfosuccinate, alkyl benzene sulfonates including methylbenzyl sulfonate, ethylbenzene sulfonate, or any mixture or combination thereof; (d) phosphate esters including alkyl aryl ether phosphates including methylbenzene ether phosphates, ethylbenzene ether phosphoate, or any mixture or combination thereof, alkyl ether phosphates including C₁ to C₆ ether phosphates, or any mixture or combination thereof, (e) alkyltrimethylammonium bromides including tetramethylammonium bromide, ethyltrimethylammonium bromide, propyltrimethylammonium bromide, isoproplytrimethylammonium bromide, butyltrimethylammonium bromide, or any mixture or combination thereof, or any mixture or combination thereof, provided that the surfactants are water soluble or water miscible at the concentration used in specific formulations.

Embodiment 118. The Embodiment of Embodiments 111 through 117, wherein the one or more anionic surfactants may be present in the WB-FR slurry composition in an amount between about 0.00 wt. % and about 5 wt. % including an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %.

Embodiment 119. The Embodiment of Embodiments 111 through 117, wherein the one or more anionic surfactants are present in the WB-FR slurry composition in an amount between about 0 wt. % and about 4 wt. %, between about 0 wt. % and about 3 wt. %, between about 0 wt. % and about 2 wt. %, between about 0 wt. % and about 1 wt. %, between about 0.1 wt. % and about 5 wt. %, between about 0.1 wt. % and about 4 wt. %, between about 0.1 wt. % and about 3 wt. %, between about 0.1 wt. % and about 2 wt. %, between about 0.5 wt. % and about 5 wt. %, about 1 wt. % and about 4 wt. %, or between about 1 wt. % and about 3 wt. %.

### Cationic Surfactants

Embodiment 120. The Embodiment of Embodiment 110, wherein the one or more cationic surfactants comprise gemini, bis, or di quaternary ammonium surfactants including bis quaternary ammonium halides of bis halogenated ethane, propane, butane or higher halogenated alkanes, dichloroethane, dibromoethane, bis halogenated ethers including dichloroethylether (DCEE), or any mixture or combination thereof, provided that the surfactants are water soluble or water miscible at the concentration used in specific formulations.

Embodiment 121. The Embodiment of Embodiment 120, wherein the bis quaternary ammonium halides are prepared from substituted dimethyl tertiary amines, where the substituent includes between about 4 and about 30 carbon atoms, between about 6 and about 24 carbon atoms, or between about 8 and about 24 carbon atoms, and where one or more of the carbon atoms can be replace by an oxygen atom in the form of an ether and/or hydroxyl moiety and/or a nitrogen atom in the form of an amido moiety, or any mixture or combination thereof.

Embodiment 122. The Embodiment of Embodiment 121, wherein the bis quaternary ammonium halides are prepared from one or more naturally occurring acids including one or more fatty acids, one or more synthetic acids, one or more modified naturally occurring acids, or any mixture or combination thereof, provided that the surfactants are water soluble or water miscible at the concentration used in specific formulations.

Embodiment 123. The Embodiment of Embodiment 122, unused.

Embodiment 124. The Embodiment of Embodiment 120, wherein the bis quaternary ammonium halides are prepared from disubstituted methyltertiaryamines, where the substituents include between about 4 and about 30 carbon atoms, between about 6 and about 24 carbon atoms, or between about 8 and about 24 carbon atoms, and where one or more of the carbon atoms can be replace by an oxygen atom in the form of an ether and/or hydroxyl moiety and/or a nitrogen atom is the form of an amido moiety, such as amidopropyltertiary amines, derived from the reaction of dimethyl aminopropylamine (DMAPA) or similar terminated primary-tertiary diamines, reacted with the above mentioned oils or their corresponding fatty acids, or hydroxy acids, or any mixture or combination thereof, provided that the surfactants are water soluble or water miscible at the concentration used in specific formulations.

Embodiment 125. The Embodiment of Embodiment 110, wherein the one or more cationic surfactants comprise dimer acids or anhydrides including alkylsubstituted maleic anhydride, alkylsubstituted diethylmalonic acid, or alkylsubstituted higher diacids such as azelaic acid (C9), trimer acids as NTA (nitriloacetic acid), and aconitic acid and trimetellic anhydride are useful though producting a higher trimer, the tertiary amine may be accomplished by reaction of a diamine with a fatty acid or oil, reacting with one amine and then converting the other primary amine to tertiary by the addition of tetrahydrofuran, ethylene oxide, propylene oxide, butylene oxide, epichlorohydrin, or the like and further where the terminal hydrogens of the primary amine may be alkylated using formaldehyde/formic acid mixtures, provided that the surfactants are water soluble or water miscible at the concentration used in specific formulations.

Embodiment 126. The Embodiment of Embodiment 110, wherein the one or more cationic surfactants comprise compounds of the general formula RN⁺H₃Cl⁻, RN⁺(CH₃)₃Cl⁻, or any mixture or combination thereof, wherein R is a alkyl group, an aryl group, an aralkyl group, an alkaryl group, cyclic analogs, heterocyclic analogs, or any mixture thereof having between 6 and 40 carbon atoms and oxygen atoms, provided that the surfactants are water soluble or water miscible at the concentration used in specific formulations.

Embodiment 127. The Embodiment of Embodiments 120 through 126, wherein the one or more cationic surfactants may be present in the WB-FR slurry compositions in an amount of about 0.1 wt. % to about 5 wt. % including an amount of about 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

Embodiment 128. The Embodiment of Embodiments 120 through 126, wherein the one or more cationic surfactants are present in the WB-FR slurry composition in an amount between about 0 wt. % and about 5 wt. % including about 0 wt. % and about 4 wt. %, about 0 wt. % and about 3 wt. %, about 0 wt. % to about 2 wt. %, about 0 wt. % and about 1 wt. %, about 0.1 wt. % and about 5 wt. %, about 0.1 wt. % and about 4 wt. %, about 0.1 wt. % and about 3 wt. %, about 0.1 wt. % and about 2 wt. %, about 0.5 wt. % and about 5 wt. %, about 0.5 wt. % and about 4 wt. %, or about 0.5 wt. % and about 3 wt. %.

### Zwitterionic or Amphoteric Surfactants

Embodiment 129. The Embodiment of Embodiment 110, wherein the one or more zwitterionic, one or more amphoteric surfactants, or any mixture or combination thereof, provided that the surfactants are water soluble or water miscible at the concentration used in specific formulations.

Embodiment 130. The Embodiment of Embodiment 129, wherein the one or more amphoteric surfactants comprise one or more acetate surfactants, one or more betaine surfactants, one or more glycinate surfactants, one or more imidazoline surfactants, one or more propionate surfactants, one or more other amphoteric surfactants, or any mixture or combination thereof, provided that the surfactants are water soluble or water miscible at the concentration used in specific formulations.

Embodiment 131. The Embodiment of Embodiment 129, wherein the one or more zwitterionic surfactants or the one or more amphoteric surfactants comprise: (a) one or more compounds of the general formula R^{f}R^{g}R^{h}N⁺—Rⁱ—CO₂⁻, where R^{f}, R^{g}, and R^{h} are the same or different carbon-containing group, amido carbon-containing group, ether carbon-containing group, or any mixture or combination thereof, and Rⁱ is an alkenyl group, alkenyloxide group or any mixture or combination thereof; (b) one or more compounds of the general formula R^{j}(R^{g}R^{h}N⁺—Rⁱ—CO₂⁻)ₙ, where R^{g} and R^{h} are the same or different carbon-containing group, amido carbon-containing group, ether carbon-containing group, or any mixture or combination thereof, Rⁱ is an alkenyl group, alkenyloxide group or any mixture or combination thereof, and R^{j} is a multivalent substituent having a valency n between 2 and about 6, including a CH₂ moiety when n is 2, a CH moiety when n is 3 and a C atom when n is 4; (c) one or more compounds of the general formula R¹—C(O)—N(R^{k})—R^{m}—N⁺(R^{g}R^{h})—Rⁱ—CO₂⁻, where R^{g}, R^{h}, R^{k} and R¹ are the same or different carbon-containing group, amido carbon-containing group, ether carbon-containing group, or any mixture or combination thereof, and Rⁱ and R^{m} are the same or different alkenyl group, alkenyloxide group, or any mixture or combination thereof; (d) one or more compounds of the general formula Rⁿ—[R^{o}—C(O)—N(R^{k})—R^{m}—N⁺(R^{g}R^{h})—Rⁱ—CO₂⁻]ₘ, where R^{g}, R^{h} and R^{k} are the same or different carbon-containing group, amido carbon-containing group, ether carbon-containing group, or any mixture or combination thereof, Rⁱ, R^{m} and R^{o} are the same or different alkenyl group, alkenyloxide group or any mixture or combination thereof and Rⁿ is a multivalent substituent having a valency m between 2 and about 6; or (e) any mixture or combination thereof, provided that the surfactants are water soluble or water miscible at the concentration used in specific formulations.

Embodiment 132. The Embodiment of Embodiment 129, wherein the one or more zwitterionic surfactants comprise one or more zwitterionic betaines, one or more sulfo-betaines, one or more quaternary salts, one or more amino acids, one or more other compounds capable of forming or in the form of a zwitterion, or any mixture or combination thereof, provided that the surfactants are water soluble or water miscible at the concentration used in specific formulations.

Embodiment 133. The Embodiment of Embodiment 132, wherein the one or more zwitterionic betaines comprise cocamidopropyl betaine, 5-(1-piperidiniomethyl)-1H-tetrazolide, or any mixture or combination thereof, provided that the surfactants are water soluble or water miscible at the concentration used in specific formulations.

Embodiment 134. The Embodiment of Embodiment 132, wherein the one or more sulfo-betaines comprise N-decyl-N,N-dimethyl-3-ammonio-1-propanesulfonate, dimethylbenzyl-(3-sulfopropyl) ammonium; dimethylethyl-(3-sulfopropyl) ammonium; dimethyl-(2-hydroxyethyl)-(3-sulfopropyl)ammonium; 4-n-hexylbenzoylamido-propyl-dimethylammoniosulfobetaine; 4-methyl-N-(3-sulfopropyl)morpholinium; 4-n-octylbenzoylamido-propyl-dimethylammonio sulfobetaine; 1-(3-sulfopropyl)pyridium; N-tetradecyl-N,N-dimethyl-3-ammonio-1-propanesulfonate, or any mixture or combination thereof, provided that the surfactants are water soluble or water miscible at the concentration used in specific formulations.

Embodiment 135. The Embodiment of Embodiment 132, wherein the one or more quaternary salts comprise one or more compounds of the general formulas RN⁺H₂CH₂COO⁻ and RN⁺(CH₃)₂CH₂CH₂SO₃⁻, wherein R is linear, branched, saturated, or unsaturated alkyl groups; linear, branched, saturated, or unsaturated C₈-C₁₉ alkyl groups; linear, branched, saturated, or unsaturated C₂₀-C₄₀ alkyl groups; sterol or steroid groups, or any mixture or combination thereof, CHAPS zwitterionic surfactants including 3-[(3-cholamidopropyl) dimethylammonio]-1-propanesulfonate or related CHAPSO surfactants, cocamidopropyl betaine, cocamidopropyl hydroxysultaine, hydroxysultaine, miltefosine, lipophilic peptitergents, or any mixture or combination thereof, provided that the surfactants are water soluble or water miscible at the concentration used in specific formulations.

Embodiment 136. The Embodiment of Embodiment 132, unused.

Embodiment 137. The Embodiment of Embodiment 136, unused.

Embodiment 138. The Embodiment of Embodiment 137, unused.

Embodiment 139. The Embodiment of Embodiments 129 through 138, wherein the one or more zwitterionic or the one or more amphoteric surfactants may be present in the WB-FR slurry compositions in an amount of about 0.1 wt. % to about 5 wt. % including an amount of about 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %, including increments therein.

Embodiment 140. The Embodiment of Embodiments 129 through 138, wherein the one or more zwitterionic or one or more amphoteric surfactants may be present in the WB-FR slurry composition in an amount of at between 0 wt. % and 5 wt. % in an amount between about 0 wt. % and about 5 wt. % including about 0 wt. % and about 4 wt. %, about 0 wt. % and about 3 wt. %, about 0 wt. % to about 2 wt. %, about 0 wt. % and about 1 wt. %, about 0.1 wt. % and about 5 wt. %, about 0.1 wt. % and about 4 wt. %, about 0.1 wt. % and about 3 wt. %, about 0.1 wt. % and about 2 wt. %, about 0.5 wt. % and about 5 wt. %, about 0.5 wt. % and about 4 wt. %, or about 0.5 wt. % and about 3 wt. %.

### Nonionic Surfactants

Embodiment 141. The Embodiment of Embodiment 110, wherein the one or more nonionic surfactants comprise one or more alkyl polyglycosides, one or more polyethylene glycol alkyl ethers, one or more polyethylene glycol hexadecyl ethers, one or more decyl polyglucose surfactants, octylphenoxypolyethoxyethanol surfactants, polyethylene glycol ether surfactants, alkyl maltoside surfactants, one or more 4-nonylphenyl-polyethylene glycol surfactants, one or more ethoxylated nonoxynol surfactants, one or more polyethylene glycol nonyl phenyl ether surfactants, one or more nonyl phenoxypolyethoxylethanol surfactants, one or more polyethylene glycols derived from sunflower glyceride surfactants, one or more ethoxylated dodecanol surfactants, one or more nonionic triblock copolymers composed of a central hydrophobic chain of polyoxypropylene (poly(propylene oxide)) flanked by two hydrophilic chains of polyoxyethylene (poly(ethylene oxide)), one or more polyethoxylated tallow amine surfactants, one or more polyglycerol polyricinoleate surfactants, one or more polysorbate surfactants, one or more sorbitan surfactants, one or more sorbitol ester surfactants, one or more bacterial cyclic lipopeptide surfactants, one or more hydrophilic polyethylene oxide surfactants, one or more poloxamer surfactants, one or more nonionic neutral polymer surfactants, or any mixture or combination thereof, provided that the surfactants are water soluble or water miscible at the concentration used in specific formulations.

Embodiment 142. The Embodiment of Embodiment 110, wherein the one or more nonionic surfactants comprise cetostearyl alcohol, cetyl alcohol, cocamide/diethanolamine, cocamide/monoethanolamine, decyl glucoside, glycerol monostearate, lauryl glucoside, monolaurin, mycosubtilin, octaethylene glycol monododecyl ether, N-octyl beta-d-thioglucopyranoside, octyl glucoside, oleyl alcohol, pentaethylene glycol monododecyl ethers, stearyl alcohol, or any mixture or combination thereof, provided that the surfactants are water soluble or water miscible at the concentration used in specific formulations.

Embodiment 143. The Embodiment of Embodiment 110, wherein the one or more nonionic surfactants are categorized by their hydrophilic-lipophilic balance (HLB) number, with a low value (<10) corresponding to greater lipophilicity and a higher value (>10) corresponding to higher hydrophilicity. Low HLB (<10) emulsifier include, without limitation, (a) alkylene glycol esters of fatty acids such as ethylene glycol esters of saturated and unsaturated C₈-C₂₄ fatty acids, propylene glycol esters of saturated and unsaturated C₈-C₂₄ fatty acids, butylene glycol esters of saturated and unsaturated C₈-C₂₄ fatty acids, high alkylene glycols of esters of saturated and unsaturated C₈-C₂₄ fatty acids, and mixtures or combinations thereof, (b) unsaturated polyglycolized glycerides such as oleoyl macrogolglycerides and linoleoyl macrogolglycerides, (c) sorbitan esters such as sorbitan monooleate, sorbitan monostearate, sorbitan monolaurate, and sorbitan monopalmitate; or (d) mixtures or combinations thereof, provided that the surfactants are water soluble or water miscible at the concentration used in specific formulations.

Embodiment 144. The Embodiment of Embodiment 143, wherein the HLB number has a HLB number greater than (>10), provided that the surfactants are water soluble or water miscible at the concentration used in specific formulations.

Embodiment 145. The Embodiment of Embodiment 144, wherein the one or more nonionic surfactants having a HLB number >10 comprise: (a) polyoxyethylene sorbitan esters such as polysorbate 20, polysorbate 40, polysorbate 60, and polysorbate 80; (b) polyoxyl castor oil derivatives including Polyoxyl 35 castor oil, Polyoxyl 40 hydrogenated castor oil, or other Polyoxy castor oil products available from Thermo Fisher Scientific Inc. (Polyoxy is a trade name of Thermo Fisher Scientific Inc.); (c) polyoxyethylene polyoxypropylene block copolymers including Poloxamer 188, Poloxamer 407, or Poloxamer polyoxyethylene polyoxypropylene block copolymers; (d) saturated polyglycolized glycerides including lauroyl macrogolglycerides and stearoyl macrogolglycerides; (e) polyethylene glycol (PEG)-8 caprylic/capric glycerides including caprylocaproyl macrogolglycerides; (f) vitamin E derivative such as tocopherol PEG succinate; (g) polyolesters; (h) cyclic polyol esters; (i) PEG esters; or (j) any mixture or combination thereof, provided that the surfactants are water soluble or water miscible at the concentration used in specific formulations.

Embodiment 146. The Embodiment of Embodiment 141, wherein the sorbitan monofatty ester surfactants, the sorbitan polyfatty acid ester surfactants, the sorbitol monofatty acid ester surfactants, the sorbitol polyfatty acid esters, the mono fatty acid glyceride surfactants, and the polyethylene glycol (PEG) ester surfactants comprise hydrophilic and hydrophobic GELUCIRE® surfactants available from GATTEFOSSÉ (GELUCIRE® is a registered trademark of GATTEFOSSÉ) including GELUCIRE® 44/14, GELUCIRE® 43/01, GELUCIRE® 39/01, GELUCIRE® 33/01, or other GELUCIRE® surfactants; polyglycol modified castor oils including polyoxyl 35 hydrogenated castor oil, polyoxyl 40 hydrogenated castor oil; polyethylene oxides; polypropylene oxides; poly(ethylene oxide and propylene oxide) copolymers; polysorbates including polysorbate 20, 40, 60, 80, or other polysorbate surfactants, and TWEEN® surfactants available from Merck KGaA (TWEEN® is a registered trademark of Merck KGaA); or any mixture or combination thereof, provided that the surfactants are water soluble or water miscible at the concentration used in specific formulations.

Embodiment 147. The Embodiment of Embodiment 141, wherein the one or more nonionic surfactants comprise SPAN® surfactants available from Sigma-Aldrich (SPAN® is a registered trademark of Sigma-Aldrich) including SPAN® 20 (a sorbitan laurate, sorbitan monolaurate), SPAN® 40 (a sorbitan monopalmitate), SPAN® 60 (a sorbitan stearate, sorbitane monostearate), SPAN® 80 (a) sorbitane monooleate, sorbitan oleate), or other SPAN® surfactants, PEP (20) sorbitan monooleate, polyethylene glycol sorbitan monooleate, polyoxyethylene sorbitan monooleate, polysorbate 80, BRIJ™ surfactants available from Thermo Fisher Scientific Inc. (BRIJ™ is a trademark of Thermo Fisher Scientific Inc.) including BRIJ™ 58 (polyoxyethylene-20 hexadecyl ether), BRIJ™ (a 92-2-[(Z)-octadec-9-enoxy]ethanol), BRIJ™ 35 (polyethoxylated lauryl alcohol B yielding a lauryl ether, BRIJ™ 700 (polyetholylated stearyl alcohol), BRIJ™ 700 (polyoxyethylene stearyl ether (HLB 18.8)), other BRIJ™ surfactants, Solulan™ lanolin derivative surfactants available from Lubrizol (Solulan™ is a trademark of Lubrizol), TRITON™ surfactants available from Dow (TRITON™ is a trademark of Dow), PLURONIC™ surfactants available from Thermo Fisher (PLURONIC™ is a trademark of Thermo Fisher), TERGITOL™ surfactants available from Dow Chemicals (TERGITOL™ is a trademark of Dow), SURFONIC™ surfactants available from Palmer Holland (is a trademark of Palmer Holland), ETHOFAT™ surfactants available from Univar Solutions Inc. (ETHOFAT™ is a trademark of Univar Solutions Inc.), alkyl polyglycoside surfactants, polyethylene glycol hexadecyl ether, cetostearyl alcohol, cetyl alcohol, cocamide DEA, cocamide MEA, decyl glucoside, decyl polyglucose, glycerol monostearate, IGEPAL® surfactants available from Sigma-Aldrich (IGEPAL® is a registered trademark of Sigma-Aldrich), lauryl glucoside surfactants, dodecyl β-d-glucopyranoside surfactants, maltoside or maltose glycoside surfactants, mycosubtilin, nonylphenoxypolyethoxyethanol surfactants, 26-(4-nonylphenoxy)-3,6,9,12,15,18,21,24-octaoxahexacosan-1-ol (nonoxynol-9), nonaethylene glycol or polyethylene glycol nonyl phenyl ether (Nonoxynols), 4-nonylphenyl-polyethylene glycol (NP-40), octaethylene glycol monododecyl ether, N-octyl beta-d-thioglucopyranoside, octyl glucoside, oleyl alcohol, PEG-10 sunflower glycerides, pentaethylene glycol monododecyl ether, ethoxylated dodecanol (polidocanol), polyethoxylated tallow amine, polyglycerol polyricinoleate, stearyl alcohol, or any mixture or combination thereof, provided that the surfactants are water soluble or water miscible at the concentration used in specific formulations.

Embodiment 148. The Embodiment of Embodiment 141, wherein the one or more nonionic surfactants comprise an ethylene glycol mono fatty acid ester, a propylene glycol mono fatty acid ester, or any mixture or combination thereof, provided that the surfactants are water soluble or water miscible at the concentration used in specific formulations.

Embodiment 149. The Embodiment of Embodiment 141, wherein the one or more nonionic surfactants comprise one or more sorbitan mono-fatty acid esters, one or more di-fatty acid esters, one or more tri-fatty acid esters, or any mixture or combination thereof, provided that the surfactants are water soluble or water miscible at the concentration used in specific formulations.

Embodiment 150. The Embodiment of Embodiment 141, wherein the one or more nonionic surfactants comprise propylene glycol monolaurate, provided that the surfactants are water soluble or water miscible at the concentration used in specific formulations.

Embodiment 151. The Embodiment of Embodiment 141, wherein the one or more nonionic surfactants comprise sorbitan trioleate, sorbitan monooleate, sorbitan tristearate, or any mixture or combination thereof, provided that the surfactants are water soluble or water miscible at the concentration used in specific formulations.

### Sorbitan and Sorbitol Esters

Embodiment 152. The Embodiment of Embodiment 141, wherein the one or more sorbitan and/or sorbitol esters comprise one or more sorbitan mono ester, one or more sorbitan sesquiesters, one or more sorbitan diesters, one or more sorbitan triesters, one or more mixed-chain sorbitan esters, or any mixture or combination thereof, provided that the surfactants are water soluble or water miscible at the concentration used in specific formulations.

Embodiment 153. The Embodiment of Embodiment 152, wherein:
the one or more sorbitan mono esters comprise sorbitan caprylate, sorbitan undecylenate, sorbitan laurate, sorbitan palmitate, sorbitan isostearate, sorbitan oleate, sorbitan stearate, or any mixture or combination thereof;
the one or more sorbitan sesquiesters comprise sesquicaprylate, sorbitan sesquiisostearate, sorbitan sesquioleate, sorbitan sesquistearate, or any mixture or combination thereof; the one or more sorbitan diesters comprise sorbitan diisostearate, sorbitan dioleate, sorbitan distearate, or any mixture or combination thereof;
the one or more sorbitan triesters comprise sorbitan triisostearate, sorbitan trioleate, sorbitan tristearate, or any mixture or combination thereof; or
the mixed-chain sorbitan esters comprise sorbitan cocoate, sorbitan olivate, sorbitan palmate, or any mixture or combination thereof,
provided that the surfactants are water soluble or water miscible at the concentration used in specific formulations.

Embodiment 154. The Embodiment of Embodiment 153, wherein the one or more sorbitan or sorbitol esters comprise one or more PEGs sorbitans, one or more PEGs sorbitol fatty acid esters, or any mixture or combination thereof, provided that the surfactants are water soluble or water miscible at the concentration used in specific formulations.

Embodiment 155. The Embodiment of Embodiment 154, wherein the one or more PEGs sorbitol fatty acid esters comprise PEG-20 sorbitan cocoate, PEG-40 sorbitan diisostearate, PEG-2 sorbitan isostearate, PEG-5 sorbitan isosteatate, PEG-20 sorbitan isostearate, PEG-40 sorbitan lanolate, PEG-75 sorbitan lanolate, PEG-10 sorbitan laurate, PEG-40 sorbitan laurate, PEG-44 sorbitan laurate, PEG-75 sorbitan laurate, PEG-80 sorbitan laurate, PEG-3 sorbitan oleate, PEG-6 sorbitan oleate, PEG-80 sorbitan palmitate, PEG-40 sorbitan perisostearate, PEG-40 sorbitan peroleate, PEG-3 sorbitan stearate, PEG-6 sorbitan stearate, PEG-40 sorbitan stearate, PEG-60 sorbitan stearate, PEG-30 sorbitan tetraoleate, PEG-40 sorbitan tetraoleate, PEG-60 sorbitan tetraoleate, PEG-60 sorbitan tetrasterate, PEG-160 sorbitan triisostearate; PEG-20 sorbitan triisostearate, Sorbeth-40 hexaoleate, Sorbeth-50 hexaoleate, Sorbeth-30 tetraoleate laurate, Sorbeth-60 tetrastearate, or any mixture or combination thereof, provided that the surfactants are water soluble or water miscible at the concentration used in specific formulations.

### Poloxamers

Embodiment 156. The Embodiment of Embodiment 141, wherein the one or more poloxamer surfactants comprise nonionic triblock copolymers composed of a central hydrophobic chain of polyoxypropylene (poly(propylene oxide)) flanked by two hydrophilic chains of polyoxyethylene (poly(ethylene oxide)), provided that the surfactants are water soluble or water miscible at the concentration used in specific formulations.

### Nonionic Neutral Polymers

Embodiment 157. The Embodiment of Embodiment 141, wherein the one or more nonionic neutral polymer surfactants comprise one or more pH responsive nonionic polymers, one or more temperature sensitive nonionic polymers, or any mixture or combination thereof, provided that the surfactants are water soluble or water miscible at the concentration used in specific formulations.

Embodiment 158. The Embodiment of Embodiment 157, wherein the one or more pH responsive nonionic polymers comprise one or more pH responsive dendrimers, provided that the surfactants are water soluble or water miscible at the concentration used in specific formulations.

Embodiment 159. The Embodiment of Embodiment 158, wherein the one or more pH responsive dendrimers comprise poly-amidoamide (PAMAM), dendrimers, poly(propyleneimine) dendrimers, poly(-lisine) ester, poly(hydroxyproline), poly(propyl acrylic acid), poly(methacrylic acid), chitosan, poly(methacrylic acid) (PMMA), PMAA-PEG copolymer, N,N-dimethylaminoethyl methacrylate (DMAEMA), or any mixture or combination thereof, provided that the surfactants are water soluble or water miscible at the concentration used in specific formulations.

Embodiment 160. The Embodiment of Embodiment 158, wherein the one or more temperature sensitive polymers comprise poloxamers, prolastin, poly(n-substituted acrylamide), poly(organophosphazene), cyclotriphosphazenes with poly(ethyleneglycol) and amino acid esters, block copolymers of poly(ethylene glycol)/poly(lactic-co-glycolic acid), poly(ethylene glycol) (PEG), poly(propylene glycol) (PPG), PMAA, poly(vinyl alcohol) (PVA), various silk-elastin-like polymers, poly(silamine), poly(vinyl methyl ether) (PVME), poly(vinyl methyl oxazolidone) (PVMO), poly(vinyl pyrrolidone) (PVP), poly(n-vinylcaprolactam), poly(N-vinyl isobutyl amid), poly(vinyl methyl ether), poly(N-vinylcaprolactam) (PVCL), poly(siloxyethylene glycol), poly(dimethylamino ethyl methacrylate), triblock copolymer poly(DL-lactide-co-glycolide-b-ethylene glycol-b-DL-lactide-co-glycolide) (PLGA-PEG-PLGA), cellulose derivatives, alginate, gellan, xyloglucan, or any mixture or combination thereof, provided that the surfactants are water soluble or water miscible at the concentration used in specific formulations.

Embodiment 161. The Embodiment of Embodiments 141 through 160, the one or more nonionic surfactants may be present in the WB-FR slurry composition in an amount between about 0.00 wt. % and about 5 wt. % including an amount of about 0.00, 0.10, 0.20, 0.30, 0.40, 0.50, 0.60, 0.70, 0.80, 0.90, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %.

Embodiment 162. The Embodiment of Embodiments 141 through 160, wherein one or more nonionic surfactants may be present in the WB-FR slurry composition in an amount of at between 0 wt. % and 5 wt. % in an amount between about 0 wt. % and about 5 wt. % including about 0 wt. % and about 4 wt. %, about 0 wt. % and about 3 wt. %, about 0 wt. % to about 2 wt. %, about 0 wt. % and about 1 wt. %, about 0.1 wt. % and about 5 wt. %, about 0.1 wt. % and about 4 wt. %, about 0.1 wt. % and about 3 wt. %, about 0.1 wt. % and about 2 wt. %, about 0.5 wt. % and about 5 wt. %, about 0.5 wt. % and about 4 wt. %, or about 0.5 wt. % and about 3 wt. %.

### Downhole Fluids

Embodiment 163. The Embodiment of any of the previous Embodiments, wherein the downhole fluid composition comprise a drilling fluid composition and a treating fluid composition, the treating fluid composition including: (a) a fracturing fluid composition including a slickwater fracturing fluid composition, a high viscosity treating fluid composition, a low or high viscosity non-proppant-containing fracturing fluid composition, and a low or high viscosity proppant-containing fracturing fluid composition, (b) a low or high viscosity completion fluid composition, (c) a low or high viscosity stimulating fluid composition, (d) a low or high viscosity zone isolation fluid composition, or (e) any other downhole fluid composition.

### Downhole Fluid Base Fluids

Embodiment 164. The Embodiment of Embodiment 163, wherein the downhole fluid base fluid composition comprises a water composition.

### Water Compositions

Embodiment 165. The Embodiment of Embodiment 164, wherein the water composition comprises fresh water, saltwater, a brine, seawater, produced water, reclaimed water, high totally dissolved solid (TDS) containing water, a high TDS produced water, a high TDS flow back water, a high TDS fracturing flow back water, a brackish water, a reverse osmosis (RO) reject water, a clear brine, an aqueous fluid formulated using any combination of these water compositions, or any mixture and combination thereof.

### Hydratable Polymers

Embodiment 166. The Embodiment of Embodiments 163 through 165, wherein the high viscosity treating fluid composition includes one or more hydratable polymers or gelling agents comprise one or more hydratable polysaccharides that are capable of forming a gel in the presence of a crosslinking agent.

Embodiment 167. The Embodiment of Embodiment 166, wherein the one or more hydratable polysaccharides comprises galactomannan gums, glucomannan gums, guars, derivatized guars, cellulose derivatives, and any mixture or combination thereof.

Embodiment 168. The Embodiment of Embodiment 167, wherein the one or more hydratable polysaccharides comprise guar gum, guar gum derivatives, locust bean gum, Karaya gum, carboxymethyl cellulose, carboxymethyl hydroxyethyl cellulose, and hydroxyethyl cellulose.

Embodiment 169. The Embodiment of Embodiment 168, wherein the one or more hydratable polysaccharides comprise guar gums, hydroxypropyl guar, carboxymethyl hydroxypropyl guar, carboxymethyl guar, and carboxymethyl hydroxyethyl cellulose.

Embodiment 170. The Embodiment of Embodiment 169, wherein the one or more hydratable polysaccharides comprise polyvinyl alcohol, polyacrylamides, poly-2-amino-2-methyl propane sulfonic acid, and various other synthetic polymers and copolymers.

Embodiment 171. The Embodiment of Embodiments 166, wherein the one or more hydratable polymers or gelling agents have molecular weights between about 10,000 to about 100,000,000, between about 10,000 to about 10,000,000, or between about 10,000 to about 1,000,000.

Embodiment 172. The Embodiment of Embodiments 166 through 171, wherein the one or more hydratable polymers or gelling agents may be present in a fracturing fluid in a concentrations range between about 0.05 wt. % and about 10 wt. %, between about 0.10 wt. % and about 5.0 wt. %, between about 0.05 w. % and about 0.7 wt. %, between about 0.10 wt. % and about 0.25 wt. % of the aqueous fluid.

### Crosslinking Agents

Embodiment 173. The Embodiment of Embodiments 163 through 172, wherein the high viscosity treating fluid composition further includes one or more crosslinking agents.

Embodiment 174. The Embodiment of Embodiment 173, wherein the one or more crosslinking agents comprise any compound that increases the viscosity of a fluid including the hydratable polymers by chemical crosslinks, physical crosslinks, and/or cross-links the hydratable polymer by any other mechanism.

Embodiment 175. The Embodiment of Embodiment 174, wherein the gelation of a hydratable polymer may be achieved by cross-linking the polymer with metal ions including boron, zirconium, and titanium containing compounds, or any mixture or combination thereof.

Embodiment 176. The Embodiment of Embodiment 175, wherein the one or more crosslinking agents comprise one or more organotitanates.

Embodiment 177. The Embodiment of Embodiment 176, wherein the one or more crosslinking agents comprise one or more borates.

Embodiment 178. The Embodiment of Embodiment 177, wherein the one or more crosslinking agents comprise are present in an amount depending upon the well conditions and the type of treatment to be introduced.

Embodiment 179. The Embodiment of Embodiment 178, wherein the amount of the crosslinking agents range between about 10 ppm to about 1000 ppm of metal ion of the crosslinking agent in the hydratable polymer fluid.

Embodiment 180. The Embodiment of Embodiment 147, wherein the one or more crosslinking agents comprise borate-containing compounds, titanate-containing compounds, zirconium-containing compounds, or any mixture or combination thereof.

Embodiment 181. The Embodiment of Embodiment 180, wherein the borate-containing compounds comprise sodium borateHH₂O (varying waters of hydration), sodium tetraborate, boric acid, ulexite, colemanite, other borate crosslinker agents, or any mixture or combination thereof.

Embodiment 182. The Embodiment of Embodiment 181, wherein the titanate-containing compounds comprise Ti(IV) acetylacetonate, Ti(IV) triethanolamine, a mixture of a first organotitanate compound having a lactate base and a second organotitanate compound having triethanolamine base, or any mixture or combination thereof.

Embodiment 183. The Embodiment of Embodiment 182, wherein the zirconium-containing compounds comprise Zr lactate, Zr triethanolamine, Zr lactate-triethanolamine, Zr lactate-triethanolamine-triisopropanolamine, or any mixture or combination thereof.

Embodiment 184. The Embodiment of Embodiments 163 through 183, wherein the one or more crosslinking agent are present in an amount that depends upon the well conditions and the type of treatment to be introduced.

Embodiment 185. The Embodiment of Embodiment 184, wherein the amount of the one or more crosslinking agents ranges between about 10 ppm and about 1000 ppm of metal ion in the one or more crosslinking agents based on the hydratable polymers in the high viscosity treating fluid composition, and any subrange therein.

### Treating Fluid Additives

Embodiment 186. The Embodiment of Embodiments 163 through 185, wherein the treating fluid additives include, without limitation, proppants, acids, diverting agents, fluid loss control additives, gas, nitrogen, carbon dioxide, surface modifying agents, tackifying agents, foamers, corrosion inhibitors, scale inhibitors, catalysts, clay control agents, biocides, antifoam agents, bridging agents, flocculants, H₂S scavengers, CO₂ scavengers, oxygen scavengers, lubricants, viscosifiers, breakers, weighting agents, relative permeability modifiers, resins, surfactants, wetting agents, coating enhancement agents, filter cake removal agents, antifreeze agents, or any mixture or combination thereof.

### Proppants

Embodiment 187. The Embodiment of Embodiment 186, wherein the proppants for use in this disclosure include, without limitation, fly ash, silica, alumina, fumed carbon, carbon black, graphite, mica, titanium dioxide, metal-silicate, silicate, kaolin, talc, zirconia, boron, hollow microspheres, glass, sand, bauxite, sintered bauxite, ceramics, sintered ceramics, calcined clays, partially calcined clays, composite polymers, halloysite clay nanotubes, carbon nanotube containing materials, or any mixture or combination thereof.

Embodiment 188. The Embodiment of Embodiment 187, wherein the proppants may be of any regular and/or irregular shape suitable or desired for a particular application.

Embodiment 189. The Embodiment of Embodiment 188, wherein the proppants comprise a round or spherical shape, an oval shape, a capsule shape, a rod shape, a toroidal shape, a cylindrical shape, a cube shape, any variations of these shapes, or any mixture or combination thereof.

Embodiment 190. The Embodiment of Embodiment 189, wherein the proppants are relatively flexible or deformable, which may allow the proppants to enter certain perforations, microfractures, or other spaces within a subterranean oil and/or gas bearing formation whereas solid particulates of a similar diameter or size may be unable to do so.

Embodiment 191. The Embodiment of Embodiments 187 through 190, wherein the one or more proppants are present in the treating fluid composition or a drilling fluid composition in an amount between about 0.05 ppg to about 12 ppg, between about 3 ppg and about 10 ppg, between about 0.1 ppg and about 0.5 ppg, between about 0.5 ppg and about 1.0 ppg, between about 1.0 ppg and about 2.0 ppg, between about 2.0 ppg to about 3.0 ppg, between about 3.0 ppg and about 4.0 ppg, between about 4.0 ppg to about 5.0 ppg, between about 5.0 ppg and about 6.0 ppg, between about 6.0 ppg and about 7.0 ppg, between about 7.0 ppg and about 8.0 ppg, between about 8.0 ppg and about 9.0 ppg, or between about 9.0 ppg and about 10 ppg.

### WB-FR Slurry Composition Component Compositional Ranges

WB-FR Slurry Compositions with Above Salt Saturation Concentration at 20° C.

### Without a FR Acid Composition

Embodiment 192. The Embodiment of any of the previous Embodiments, wherein, for a WB-FR slurry composition having a salt concentration above a salt saturation concentration at 20° C., the WB-FR slurry composition comprises a FR base fluid amount of a FR base fluid, a DP-WS-FR polymer amount of a DP-WS-FR polymer composition, and a FR salt effective amount of a FR salt composition.

Embodiment 193. The Embodiment of Embodiment 192, wherein:
the DP-WS-FR polymer amount is between about 15 wt. % and about 40 wt. % based on the weight of the WB-FR slurry composition or any subrange therein,
the FR salt effective amount is between about 42.807 wt. % and about 51.240 wt. % of a FR salt composition based on the amount of FR base fluid in the WB-FR slurry composition, and
a remaining wt. % is made up of the FR base fluid.

Embodiment 194. The Embodiment of Embodiment 193, wherein:
the FR salt effective amount is between about 42.914 wt. % and about 51.240 wt. %, or between about 4.3020 wt. % and about 51.240 wt. %, or between about 43.127 wt. % and about 51.240 wt. %, or between about 43.768 wt. % and about 51.240 wt. %, or between about 44.835 wt. % and about 51.240 wt. %, or between about 45.903 wt. % and about 51.240 wt. %, or between about 46.970 wt. % and about 51.240 wt. %, or between about 48.038 wt. % and about 51.240 wt. %, or between about 49.105 wt. % and about 51.240 wt. %, or between about 50.173 wt. % and about 51.240 wt. %, or about 51.240 wt. %, or any subrange therein.

Embodiment 195. The Embodiment of Embodiment 194, wherein the WB-FR slurry composition further includes a FR acid amount of a FR acid composition, the FR acid amount being between about 0.1 wt. % and about 10 wt. % or any subrange therein.

Embodiment 196. The Embodiment of Embodiments 194 to 195, wherein the WB-FR slurry composition further includes a FR additive amount of a FR additive composition, the FR additive amount being between about 0.1 wt. % and about 6 wt. % or any subrange therein.

Embodiment 197. The Embodiment of Embodiments 194 to 196, wherein the WB-FR slurry composition further includes a FR surfactant amount of a FR surfactant composition, the FR surfactant amount being between about 0.1 wt. % and about 10 wt. % or any subrange therein.

### With a FR Acid Composition

Embodiment 198. The Embodiment of any of the previous Embodiments, wherein, for a WB-FR slurry composition having a salt concentration above a salt saturation concentration at 20° C., the WB-FR slurry composition comprises a FR base fluid amount of a FR base fluid, a DP-WS-FR polymer amount of a DP-WS-FR polymer composition, a FR salt effective amount of a FR salt composition, and a FR acid amount of a FR acid composition.

Embodiment 199. The Embodiment of Embodiment 198, wherein:
the DP-WS-FR polymer amount is between about 15 wt. % and about 40 wt. % based on the weight of the WB-FR slurry composition,
the FR salt effective amount is between about 42.807 wt. % and about 51.240 wt. % of a FR salt composition based on the amount of FR base fluid in the WB-FR slurry composition,
the FR acid amount is between about 0.1 wt. % and about 10 wt. %, and
a remaining wt. % is made up of the FR base fluid.

Embodiment 200. The Embodiment of Embodiment 199, wherein:
the FR salt effective amount is between about 42.914 wt. % and about 51.240 wt. %, or between about 4.3020 wt. % and about 51.240 wt. %, or between about 43.127 wt. % and about 51.240 wt. %, or between about 43.768 wt. % and about 51.240 wt. %, or between about 44.835 wt. % and about 51.240 wt. %, or between about 45.903 wt. % and about 51.240 wt. %, or between about 46.970 wt. % and about 51.240 wt. %, or between about 48.038 wt. % and about 51.240 wt. %, or between about 49.105 wt. % and about 51.240 wt. %, or between about 50.173 wt. % and about 51.240 wt. %, or about 51.240 wt. %, or any subrange therein, and
the FR acid effective amount is between about 0.25 wt. % and about 10 wt. %, or between about 0.5 wt. % and about 10 wt. %, or between about 0.75 wt. % and about 10 wt., or between about 1 wt. % and about 10 wt. %, or between about 0.1 wt. % and about 7.5 wt. %, or between about 0.25 wt. % and about 7.5 wt. %, or between about 0.5 wt. % and about 7.5 wt. %, or between about 0.75 wt. % and about 7.5 wt., or between about 1 wt. % and about 7.5 wt. %, or between about 0.1 wt. % and about 5 wt. %, or between about 0.25 wt. % and about 5 wt. %, or between about 0.5 wt. % and about 5 wt. %, or between about 0.75 wt. % and about 5 wt., or between about 1 wt. % and about 5 wt. %, or any subrange therein.

Embodiment 201. The Embodiment of Embodiments 199 to 200, wherein the WB-FR slurry composition further includes a FR additive amount of a FR additive composition, the FR additive amount being between about 0.1 wt. % and about 6 wt. %, or any subrange therein.

Embodiment 202. The Embodiment of Embodiments 199 to 201, wherein the WB-FR slurry composition further includes a FR surfactant amount of a FR surfactant composition, the FR surfactant amount being between about 0.1 wt. % and about 10 wt. %, or any subrange therein.

WB-FR Slurry Compositions with Below Salt Saturation Concentration at 20° C.

Embodiment 203. The Embodiment of any of the previous Embodiments, wherein, for a WB-FR slurry composition having a salt concentration below a salt saturation concentration at 20° C., the WB-FR slurry composition comprises a FR base fluid amount of a FR base fluid, a DP-WS-FR polymer amount of a DP-WS-FR polymer composition, a FR salt effective amount of a FR salt composition, and a FR acid amount of a FR acid composition.

Embodiment 204. The Embodiment of Embodiment 203, wherein:
the DP-WS-FR polymer amount is between about 15 wt. % and about 40 wt. % based on the weight of the WB-FR slurry composition,
the FR salt effective amount is between about 42.807 wt. % and about 51.240 wt. % of a FR salt composition based on the amount of FR base fluid in the WB-FR slurry composition, and
a remaining wt. % is made up of the FR base fluid.

Embodiment 205. The Embodiment of Embodiment 204, wherein:
the FR salt effective amount is between about 42.914 wt. % and about 51.240 wt. %, or between about 4.3020 wt. % and about 51.240 wt. %, or between about 43.127 wt. % and about 51.240 wt. %, or between about 43.768 wt. % and about 51.240 wt. %, or between about 44.835 wt. % and about 51.240 wt. %, or between about 45.903 wt. % and about 51.240 wt. %, or between about 46.970 wt. % and about 51.240 wt. %, or between about 48.038 wt. % and about 51.240 wt. %, or between about 49.105 wt. % and about 51.240 wt. %, or between about 50.173 wt. % and about 51.240 wt. %, or about 51.240 wt. %, or any subrange therein, and
the FR acid effective amount is between about 0.25 wt. % and about 10 wt. %, or between about 0.5 wt. % and about 10 wt. %, or between about 0.75 wt. % and about 10 wt., or between about 1 wt. % and about 10 wt. %, or between about 0.1 wt. % and about 7.5 wt. %, or between about 0.25 wt. % and about 7.5 wt. %, or between about 0.5 wt. % and about 7.5 wt. %, or between about 0.75 wt. % and about 7.5 wt., or between about 1 wt. % and about 7.5 wt. %, or between about 0.1 wt. % and about 5 wt. %, or between about 0.25 wt. % and about 5 wt. %, or between about 0.5 wt. % and about 5 wt. %, or between about 0.75 wt. % and about 5 wt., or between about 1 wt. % and about 5 wt. %, or any subrange therein.

Embodiment 206. The Embodiment of Embodiments 204 to 205, wherein the WB-FR slurry composition further includes a FR additive amount of a FR additive composition, the FR additive amount being between about 0.1 wt. % and about 6 wt. %, or any subrange therein.

Embodiment 207. The Embodiment of Embodiments 204 to 206, wherein the WB-FR slurry composition further includes a FR surfactant amount of a FR surfactant composition, the FR surfactant amount being between about 0.1 wt. % and about 10 wt. %, or any subrange therein.

### FR Additive Composition Compositional Ranges

Embodiment 208. The Embodiment of any of the previous Embodiments, wherein the FR additive composition comprises between about 0.1 wt. % and about 6 wt. % of the suspending and/or dispersing agent, and/or between about 0.1 wt. % and about 6 wt. % of the gel-bridging agent; provided however, that the total amount of the FR additive composition is not more that about 6 wt. % based on the WB-FR slurry composition.

### FR Polymer Composition Compositional Ranges

Embodiment 209. The Embodiment of any of the previous Embodiments, wherein the DP-WS-FR polymer composition may be present in the WB-FR slurry compositions in a DP-WS-FR polymer amount sufficient to provide a desirable level of friction reduction.

Embodiment 210. The Embodiment of Embodiment 209, wherein the DP-WS-FR polymer amount is between about 10 wt. % to about 40 wt. % by weight of the WB-FR slurry composition, between about 10 wt. % and about 35 wt. %, between about 10 wt. % and about 30 wt. %, between about 15 wt. % and about 40 wt. %, between about 15 wt. % and about 35 wt. %, between about 15 wt. % and about 30 wt. %, between about 20 wt. % and about 40 wt. %, between about 20 wt. % and about 35 wt. %, or between about 20 wt. % and about 30 wt. %, or any subrange therein.

### Properties and Advantages of Using the WB-FR Slurry Composition

Embodiment 211. The Embodiment of any of the previous Embodiments, wherein the WB-FR slurry composition may be designed to: (a) minimize a fluid frictional drag or a percentage of drag reduction (% DR) for a given downhole fluid composition under given downhole conditions; (b) optimize a fluid frictional drag or a percentage of % DR for a given downhole fluid composition under given downhole conditions; (c) achieve and/or maintain a fluid frictional drag or a percentage of % DR for a given downhole fluid composition under given downhole conditions; (d) provide environmentally friendly WB-FR slurry compositions; (e) provide biodegradable WB-FR slurry compositions; (f) reduce, decrease, or eliminate hydration of the DP-WS-FR polymers during production, storage, and transportation; (f) reduce or decrease hydration rates of the DP-WS-FR polymers during production, storage, and transportation; (g) achieve and/or maintain laminar flow as a downhole fluid is pumped into the wellbore and/or into one or more subterranean oil and/or gas bearing formations; (h) minimize turbulent eddies that are created at interior surfaces of the tubing through which a downhole fluid composition fluid is pumped; (i) achieve and/or maintain laminar flow as a downhole fluid is circulated in the wellbore while drilling; (j) minimize turbulent eddies that are created at interior surfaces of the drilling string through which a downhole fluid composition fluid is circulated; (k) provide an easier production process as temperature control in not generally an issue; (1) provide lower cost WB-FR slurry compositions; or (m) any combination thereof.

### WB-FR Slurry Composition Compositional Ranges

Embodiment 212. The Embodiment of any of the previous Embodiments, wherein the WB-FR slurry composition is present in a downhole fluid composition in a WB-FR slurry amount between about 0.1 gpt and about 100 gpt, between about 0.1 gpt to about 75 gpt, between about 0.1 gpt to about 50 gpt, between about 0.1 gpt to about 25 gpt, between about 0.1 gpt to about 20 gpt, between about 0.1 gpt to about 15 gpt, between about 0.1 gpt to about 10 gpt, between about 0.1 gpt and about 5 gpt, between about 0.1 gpt and about 4 gpt, between about 0.1 gpt and about 3 gpt, between about 0.1 gpt and about 2 gpt, or between about 0.1 gpt and about 1 gpt, or any subrange therein.

### CLOSING PARAGRAPH OF THE DISCLOSURE

Therefore, the present disclosure is well adapted to attain the ends and advantages mentioned as well as those that are inherent therein. The embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

We claim:

1. A water-based, friction reducing (WB-FR) slurry composition comprising:
a friction-reducing (FR) base fluid,
a dry particulate, water-soluble, friction-reducing (DP-WS-FR) polymer composition, and
a FR salt effective amount of a FR salt composition,
wherein the FR salt effective amount is sufficient to reduce or prevent hydration of the DP-WS-FR polymer composition during production, storage, and transportation.

2. The composition of claim 1, wherein:
the FR salt effective amount is sufficient to produce a salt concentration above a salt saturation concentration at 20° C. based on the amount of water in the WB-FR slurry composition.

3. The composition of claim 2, wherein:
the FR base fluid comprises a water composition comprising fresh water, saltwater, a brine, seawater, produced water, reclaimed water, high totally dissolved solid (TDS) containing water, a high TDS produced water, a high TDS flow back water, a high TDS fracturing flow back water, a brackish water, a reverse osmosis (RO) reject water, a clear brine, an aqueous fluid formulated using any combination of these water compositions, or any mixture and combination thereof;
the DP-WS-FR polymer composition comprises one or more DP-WS-FR polymers comprising one or more acrylamide copolymers, one or more anionic acrylamide copolymers, one or more cationic acrylamide copolymers, one or more nonionic acrylamide copolymers, one or more amphoteric or zwitterionic acrylamide copolymers, one or more polyacrylamides, one or more derivatives of an acrylamide polymer, one or more acrylate polymers, one or more derivatives of an acrylate polymer, one or more methacrylate polymers, one or more derivatives of a methacrylate polymers, or any mixture or combination thereof;
the one or more DP-WS-FR polymers further comprise a polyacrylate, a polyacrylate derivative, a polyacrylate copolymer, a polymethacrylate, a polymethacrylate derivative, a polymethacrylate copolymer, a polyacrylamide, a polyacrylamide derivative, a polyacrylamide copolymer, an acrylamide copolymer, a polysaccharide, a polysaccharide derivative, a polysaccharide copolymer, a synthetic polymer, a superabsorbent polymer, or any mixture or combination thereof;
the one or more DP-WS-FR polymers further comprise a polymer containing one or more monomers comprising acrylamide, acrylic acid, methacrylic acid, vinyl acetate, vinyl sulfonic acid, N-vinyl acetamide, N-vinyl formamide, itaconic acid, an ester of acrylic acid, an ester methacrylic acid, an ethoxylated acrylate, a hydroxyalkyl acrylate, an ethoxylated methacrylate, a hydroxyalkyl styrene, 2-acrylamido-2-methylpropane sulfonic acid (AMPS), acrylamido tertiary butyl sulfonic acid (ATBS), 2-acrylamido-2-methylpropane sulfonic acid, acrylamido tertiary butyl sulfonic acid, 2-(meth)acrylamido-2-methylpropane sulfonic acid, 2-amino-2-methyl-1-propanol (AMP), N,N-dimethylacrylamide (DMAA), a salt of any of the foregoing, or any mixture or combination thereof, wherein the ester group is a hydrocarbyl or a heterohydrocarbyl group;
the FR salt composition comprises ammonium sulfate or a mixture of ammonium sulfate and one or more other salts, the one or more other salts comprising:
one or more carbonate salts comprising ammonium carbonate, sodium carbonate, potassium carbonate, aluminum carbonate, magnesium carbonate, calcium carbonate, barium carbonate, strontium carbonate, zinc carbonate, other metal carbonate, or any mixture or combination thereof;
one or more sulfate salts comprising ammonium sulfate, sodium sulfate, potassium sulfate, aluminum sulfate, magnesium sulfate, calcium sulfate, barium sulfate, strontium sulfate, zinc sulfate, other metal sulfates, or any mixture or combination thereof;
one or more phosphate salts comprising mono, di, or tri ammonium phosphate, mono, di, or tri sodium phosphate, mono, di, or tri potassium phosphate, aluminum phosphate, magnesium phosphate, calcium phosphate, barium phosphate, strontium phosphate, zinc phosphate, other metal phosphates, or any mixture or combination thereof;
one or more fluoride salts comprising ammonium fluoride, sodium fluoride, potassium fluoride, calcium fluoride, magnesium fluoride, strontium fluoride, barium fluoride, other metal fluorides, or any mixture or combination thereof;
one or more chloride salts comprising ammonium chloride, sodium chloride, potassium chloride, calcium chloride, magnesium chloride, strontium chloride, barium chloride, other metal chlorides, or any mixture or combination thereof;
one or more bromide salts comprising sodium bromide, potassium bromide, calcium bromide, magnesium bromide, zinc bromide, strontium bromide, other metal bromides, or any mixture or combination thereof;
one or more formate salts comprising ammonium formate, sodium formate, potassium formate, magnesium formate, strontium formate, barium formate, other metal formates, or any mixture or combination thereof;
one or more acetate salts comprising ammonium acetate, sodium acetate, potassium acetate, calcium acetate, magnesium acetate, strontium acetate, barium acetate, other metal acetates, or any mixture or combination thereof;
one more bicarbonate salts comprising sodium bicarbonate, potassium bicarbonate, other metal bicarbonates, or any mixture or combination thereof;
one or more nitrate salts comprising sodium nitrate, potassium nitrate, calcium nitrate, magnesium nitrate, zinc nitrate, strontium nitrate, other metal nitrate, or
any mixture or combination thereof; or
any mixture or combination thereof.

4. The composition of claim 3, wherein:
the FR salt effective amount is between about 0.25 wt. % and about 20 wt. % of the FR salt composition above the salt saturation concentration of the salts in the FR salt at 20° C., or any subrange therein;
the mixture comprises between about 50 wt. % and about 99.99 wt. %, the mixture comprises at least about 50 wt. % ammonium sulfate, at least about 55 wt. % ammonium sulfate, at least about 60 wt. % ammonium sulfate, at least about 65 wt. % ammonium sulfate, at least about 70 wt. % ammonium sulfate, at least about 75 wt. % ammonium sulfate, at least about 80 wt. % ammonium sulfate, at least about 85 wt. % ammonium sulfate, at least about 90 wt. % ammonium sulfate, or at least about 95 wt. % ammonium sulfate based on a weight of all of the salts, or any subrange therein; and/or
the one or more DP-WS-FR polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000, or any subrange therein.

5. The composition of claim 4, wherein the one or more DP-WS-FR polymer composition further comprising a water-soluble guar, a water-soluble guar derivative thereof, or any mixture or combination thereof.

6. The composition of claim 5, further comprising:
a FR acid composition comprising one or more organic monoacids, one or more organic diacids, one or more organic polyacids, one or more organic hydroxy acids, or any mixture or combination thereof;
a FR additive composition comprising:
one or more suspending/dispersing agents comprising a clay, fumed silica, or any mixture or combination thereof;
one or more gel-bridging agents comprising one or more polyethylene glycols, one or more polypropylene glycols, one or more polyethylene/propylene glycols, one or more polyalkylene oxide polymers, or any mixture or combination thereof, provided that the one or more gel-bridging agents are water soluble or water miscible at the concentration used in specific formulations;
a FR surfactant composition comprising one or more surfactants including one or more anionic surfactants, one or more cationic surfactants, one or more zwitterionic or amphoteric surfactants, one or more nonionic surfactants, or any mixture or combination thereof, provided that the one or more surfactants agents are water soluble or water miscible at the concentration used in specific formulations; or
any combination thereof.

7. The composition of claim 6, wherein:
the one or more organic monoacids comprise one or more saturated or unsaturated monoacids comprising:
the one or more saturated or unsaturated monoacids having between 1 carbon atoms and about 8 carbon atoms, or any mixture or combination thereof, provided that the monoacids are water soluble or water miscible at the concentration used in specific formulations;
the one or more saturated or unsaturated monoacids formic acid, acetic acid, propanoic acid, butyric acid, valeric acid, or any mixture or combination thereof;
the one or more organic diacids comprise one or more saturated or unsaturated dicarboxylic acids comprising:
one or more saturated diacids comprises ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), heneicosa-1,21-dioic acid (japanic acid), docosanedioic acid (phellogenic acid), triacontanedioic acid (equisetolic acid), or any mixture or combination thereof;
one or more unsaturated diacids include, without limitation, (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), or any mixture or combination thereof, provided that one or more unsaturated diacids are water soluble or water miscible at the concentration used in specific formulations;
one or more diacids comprise one or more water immiscible dicarboxylic acids having hydrocarbyl or hydrocarbenyl groups having between 8 and 50 carbon atoms; or
any mixture or combination thereof;
the one or more organic polycarboxylic acids comprising:
citric acid, oxalic acid, ascorbic acid, isocitric acid, aconitic acid, propane-1,2,3-tricarboxylic acid, or any mixture or combination thereof;
one or more water soluble polycarboxylic acids comprising acrylic acid homopolymers, methacrylic acid homopolymers, lactic acid homopolymers, glycol acid homopolymers, copolymers including two or more monomers selected from the group consisting of acrylic acid, methacrylic acid, lactic acid, and glycol acid and one or more ethylenically unsaturated monomers comprising ethylene, propylene, styrene, or any mixture or combination thereof; provided, however, that the amount of the ethylenically unsaturated monomers do not render the resulting polymer water insoluble;
the one or more organic hydroxy acids comprising 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phaseolic acid), 9,10,18-trihydroxyoctadecanoic acid (phloionolic acid), 7,14-dihydroxydocosa-4 Z,8,10,12,16Z,19Z-hexaenoic acid, 5S,12R,18R-trihydroxy-6Z,8E,10E,14Z,16E-eicosapentaenoic acid, resolvin D1, 10,17S-docosatriene; or any mixture or combination thereof, provided that hydroxy acids are water soluble or water miscible at the concentration used in specific formulations;
the one or more clays comprise a water-based clay, a modified clay, a bentonite clay, a phyllosilicate, or any mixture or combination thereof;
the one or more clays comprise clays having a nano-structure, clays having a micro-structure, or any mixture or combination thereof;
the one or more polyethylene glycols comprise PEG 200, PEG 300, PEG 400, PEG 500, higher PEG polymers, provided that the one or more polyethylene are water soluble or water miscible at the concentration used in specific formulations; or
any mixture or combination thereof.

8. The composition of claim 7, wherein:
the FR acid composition may be present in an amount between about 0.1 wt. % to about 10 wt. % based on the weight of the WB-FR slurry composition sufficient to reduce or elimination any generated ammonia during production, storage, and transportation;
the FR additive composition may be present in an amount between about 0.1 wt. % to about 6 wt. % based on the weight of the WB-FR slurry composition; and/or
the FR surfactant compositions may be present in an amount between about 0.1 wt. % to about 5 wt. % based on the weight of the WB-FR slurry composition;
provided that the acids in the FR acid composition are water soluble or water miscible at the concentration used in specific formulations, the non-solid components in the FR additive composition are water soluble or water miscible at the concentration used in specific formulations, and the surfactants in the FR surfactant composition are water soluble or water miscible at the concentration used in specific formulations.

9. The composition of claim 8, wherein the WB-FR slurry composition may be designed to: (a) minimize a fluid frictional drag or a percentage of drag reduction (% DR) for a given downhole fluid composition under given downhole conditions; (b) optimize a fluid frictional drag or a percentage of % DR for a given downhole fluid composition under given downhole conditions; (c) achieve and/or maintain a fluid frictional drag or a percentage of % DR for a given downhole fluid composition under given downhole conditions; (d) provide environmentally friendly WB-FR slurry compositions; (e) provide biodegradable WB-FR slurry compositions; (f) reduce, decrease, or eliminate hydration of the DP-WS-FR polymers during production, storage, and transportation; (f) reduce or decrease hydration rates of the DP-WS-FR polymers during production, storage, and transportation; (g) achieve and/or maintain laminar flow as a downhole fluid is pumped into the wellbore and/or into one or more subterranean oil and/or gas bearing formations; (h) minimize turbulent eddies that are created at interior surfaces of the tubing through which a downhole fluid composition fluid is pumped; (i) achieve and/or maintain laminar flow as a downhole fluid is circulated in the wellbore while drilling; (j) minimize turbulent eddies that are created at interior surfaces of the drilling string through which a downhole fluid composition fluid is circulated; (k) provide an easier production process as temperature control in not generally an issue; (l) provide lower cost WB-FR slurry compositions; or (m) any combination thereof.

10. A water-based, friction reducing (WB-FR) slurry composition comprising:
a friction-reducing (FR) base fluid,
a dry particulate, water-soluble, friction-reducing (DP-WS-FR) polymer composition,
a FR salt effective amount of a FR salt composition, and
a FR acid effective amount of a FR acid composition,
wherein the FR salt effective amount and the FR acid effective amount are sufficient to reduce, decrease, or prevent hydration of the DP-WS-FR polymer composition during production, storage, and transportation and the FR acid effective amount is sufficient to reduce or elimination any generated ammonia during production, storage, and/or transportation.

11. The composition of claim 10, wherein:
the FR salt effective amount is between about 30 wt. % up to a salt saturation concentration at 20° C. base on the weight of the FR base fluid in the WB-FR slurry composition, and
the FR acid effective amount is between about 0.1 wt % and about 10 wt. % based on the amount of water in the WB-FR slurry composition.

12. The composition of claim 11, wherein:
the FR base fluid comprises a water composition comprising fresh water, saltwater, a brine, seawater, produced water, reclaimed water, high totally dissolved solid (TDS) containing water, a high TDS produced water, a high TDS flow back water, a high TDS fracturing flow back water, a brackish water, a reverse osmosis (RO) reject water, a clear brine, an aqueous fluid formulated using any combination of these water compositions, or any mixture and combination thereof;
the DP-WS-FR polymer composition comprises one or more DP-WS-FR polymers comprising one or more acrylamide copolymers, one or more anionic acrylamide copolymers, one or more cationic acrylamide copolymers, one or more nonionic acrylamide copolymers, one or more amphoteric or zwitterionic acrylamide copolymers, one or more polyacrylamides, one or more derivatives of an acrylamide polymer, one or more acrylate polymers, one or more derivatives of an acrylate polymer, one or more methacrylate polymers, one or more derivatives of a methacrylate polymers, or any mixture or combination thereof;
the one or more DP-WS-FR polymers further comprise a polyacrylate, a polyacrylate derivative, a polyacrylate copolymer, a polymethacrylate, a polymethacrylate derivative, a polymethacrylate copolymer, a polyacrylamide, a polyacrylamide derivative, a polyacrylamide copolymer, an acrylamide copolymer, a polysaccharide, a polysaccharide derivative, a polysaccharide copolymer, a synthetic polymer, a superabsorbent polymer, or any mixture or combination thereof;
the one or more DP-WS-FR polymers further comprise a polymer containing one or more monomers comprising acrylamide, acrylic acid, methacrylic acid, vinyl acetate, vinyl sulfonic acid, N-vinyl acetamide, N-vinyl formamide, itaconic acid, an ester of acrylic acid, an ester methacrylic acid, an ethoxylated acrylate, a hydroxyalkyl acrylate, an ethoxylated methacrylate, a hydroxyalkyl styrene, 2-acrylamido-2-methylpropane sulfonic acid (AMPS), acrylamido tertiary butyl sulfonic acid (ATBS), 2-acrylamido-2-methylpropane sulfonic acid, acrylamido tertiary butyl sulfonic acid, 2-(meth)acrylamido-2-methylpropane sulfonic acid, 2-amino-2-methyl-1-propanol (AMP), N,N-dimethylacrylamide (DMAA), a salt of any of the foregoing, or any mixture or combination thereof, wherein the ester group is a hydrocarbyl or a heterohydrocarbyl group;
the FR salt composition comprises ammonium sulfate or a mixture of ammonium sulfate and one or more other salts, the one or more other salts comprising:
one or more carbonate salts comprising ammonium carbonate, sodium carbonate, potassium carbonate, aluminum carbonate, magnesium carbonate, calcium carbonate, barium carbonate, strontium carbonate, zinc carbonate, other metal carbonate, or any mixture or combination thereof;
one or more sulfate salts comprising ammonium sulfate, sodium sulfate, potassium sulfate, aluminum sulfate, magnesium sulfate, calcium sulfate, barium sulfate, strontium sulfate, zinc sulfate, other metal sulfates, or any mixture or combination thereof;
one or more phosphate salts comprising mono, di, or tri ammonium phosphate, mono, di, or tri sodium phosphate, mono, di, or tri potassium phosphate, aluminum phosphate, magnesium phosphate, calcium phosphate, barium phosphate, strontium phosphate, zinc phosphate, other metal phosphates, or any mixture or combination thereof;
one or more fluoride salts comprising ammonium fluoride, sodium fluoride, potassium fluoride, calcium fluoride, magnesium fluoride, strontium fluoride, barium fluoride, other metal fluorides, or any mixture or combination thereof;
one or more chloride salts comprising ammonium chloride, sodium chloride, potassium chloride, calcium chloride, magnesium chloride, strontium chloride, barium chloride, other metal chlorides, or any mixture or combination thereof;
one or more bromide salts comprising sodium bromide, potassium bromide, calcium bromide, magnesium bromide, zinc bromide, strontium bromide, other metal bromides, or any mixture or combination thereof;
one or more formate salts comprising ammonium formate, sodium formate, potassium formate, magnesium formate, strontium formate, barium formate, other metal formates, or any mixture or combination thereof;
one or more acetate salts comprising ammonium acetate, sodium acetate, potassium acetate, calcium acetate, magnesium acetate, strontium acetate, barium acetate, other metal acetates, or any mixture or combination thereof;
one more bicarbonate salts comprising sodium bicarbonate, potassium bicarbonate, other metal bicarbonates, or any mixture or combination thereof;
one or more nitrate salts comprising sodium nitrate, potassium nitrate, calcium nitrate, magnesium nitrate, zinc nitrate, strontium nitrate, other metal nitrate, or any mixture or combination thereof; or
any combination thereof;
FR acid composition comprising one or more organic monoacids, one or more organic diacids, one or more organic polyacids, one or more organic hydroxy acids, or any mixture or combination thereof;
the one or more organic monoacids comprise one or more saturated or unsaturated monoacids comprising:
the one or more saturated or unsaturated monoacids having between 1 carbon atoms and about 8 carbon atoms, or any mixture or combination thereof, provided that the monoacids are water soluble or water miscible at the concentration used in specific formulations;
the one or more saturated or unsaturated monoacids formic acid, acetic acid, propanoic acid, butyric acid, valeric acid, or any mixture or combination thereof;
the one or more organic diacids comprise one or more saturated or unsaturated dicarboxylic acids comprising:
one or more saturated diacids comprises ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid, nonanedioic acid (azelaic acid), decanedioic acid (sebacic acid), undecanedioic acid, dodecanedioic acid, tridecanedioic acid (brassylic acid), hexadecanedioic acid (thapsic acid), heneicosa-1,21-dioic acid (japanic acid), docosanedioic acid (phellogenic acid), triacontanedioic acid (equisetolic acid), or any mixture or combination thereof, provided that the diacids are water soluble or water miscible at the concentration used in specific formulations;
one or more unsaturated diacids include, without limitation, (Z)-butenedioic acid (maleic acid), (E)-butenedioic acid (fumaric acid), (Z and E)-pent-2-enedioic acid (glutaconic acid), 2-decenedioic acid, dodec-2-enedioic acid (traumatic acid), (2E,4E)-hexa-2,4-dienedioic acid (muconic acid), or any mixture or combination thereof;
one or more diacids comprise one or more water immiscible dicarboxylic acids having hydrocarbyl or hydrocarbenyl groups, provided that the diacids are water soluble or water miscible at the concentration used in specific formulations; or
any mixture or combination thereof;
the one or more organic polycarboxylic acids comprising:
citric acid, oxalic acid, ascorbic acid, isocitric acid, aconitic acid, propane-1,2,3-tricarboxylic acid, or any mixture or combination thereof;
one or more water soluble polycarboxylic acids comprising acrylic acid homopolymers, methacrylic acid homopolymers, lactic acid homopolymers, glycol acid homopolymers, copolymers including two or more monomers selected from the group consisting of acrylic acid, methacrylic acid, lactic acid, and glycol acid and one or more ethylenically unsaturated monomers comprising ethylene, propylene, styrene, or any mixture or combination thereof; provided, however, that the amount of the ethylenically unsaturated monomers do not render the resulting polymer water insoluble;
the one or more organic hydroxy acids comprising 2-hydroxyoleic acid, 2-hydroxytetracosanoic acid (cerebronic acid), 2-hydroxy-15-tetracosenoic acid (hydroxynervonic acid), 2-hydroxy-9-cis-octadecenoic acid, 3-hydroxypalmitic acid methyl ester, 2-hydroxy palmitic acid, 10-hydroxy-2-decenoic acid, 12-hydroxy-9-octadecenoic acid (ricinoleic acid), 1,13-dihydroxy-tetracos-9t-enoic acid (axillarenic acid), 3,7-dihydroxy-docosanoic acid (byrsonic acid), 9,10-dihydroxyoctadecanoic acid, 9,14-dihydroxyoctadecanoic acid, 22-hydroxydocosanoic acid (phellonic acid), 2-oxo-5,8,12-trihydroxydodecanoic acid (phaseolic acid), 9,10,18-trihydroxyoctadecanoic acid (phloionolic acid), 7,14-dihydroxydocosa-4 Z,8,10,12,16Z,19Z-hexaenoic acid, 5S,12R,18R-trihydroxy-6Z,8E,10E,14Z,16E-eicosapentaenoic acid, 10,17S-docosatrien, or any mixture or combination thereof, provided that the hydroxy acids are water soluble or water miscible at the concentration used in specific formulations; or
any mixture or combination thereof; or
any mixture or combination thereof.

13. The composition of claim 12, wherein:
the FR salt effective amount is between about 0.25 wt. % and about 20 wt. % of the FR salt composition above the salt saturation concentration of the salts in the FR salt at 20° C., or any subrange therein;
the mixture comprises between about 50 wt. % and about 99.99 wt. %, the mixture comprises at least about 50 wt. % ammonium sulfate, at least about 55 wt. % ammonium sulfate, at least about 60 wt. % ammonium sulfate, at least about 65 wt. % ammonium sulfate, at least about 70 wt. % ammonium sulfate, at least about 75 wt. % ammonium sulfate, at least about 80 wt. % ammonium sulfate, at least about 85 wt. % ammonium sulfate, at least about 90 wt. % ammonium sulfate, or at least about 95 wt. % ammonium sulfate based on a weight of all of the salts, or any subrange therein; and/or
the one or more DP-WS-FR polymers have molecular weights ranging from about 100,000 to about 40,000,000, from about 200,000 to about 35,000,000, from about 300,000 to about 30,000,000, from about 400,000 to about 25,000,000, or from about 500,000 to about 20,000,000, or any subrange therein.

14. The composition of claim 13, wherein the one or more DP-WS-FR polymer composition further comprising a water-soluble guar, a water-soluble guar derivative thereof, or any mixture or combination thereof.

15. The composition of claim 14, further comprising:
a FR additive composition comprising:
one or more suspending/dispersing agents comprising one or more clays, fumed silica, or any mixture or combination thereof; and/or
one or more gel-bridging agents comprising one or more polyethylene glycols, one or more polypropylene glycols, one or more polyethylene/propylene glycols, one or more polyalkylene oxide polymers, or any mixture or combination thereof, provided that the polypropylene glycols are water soluble or water miscible at the concentration used in specific formulations;
a FR surfactant composition comprising one or more surfactants including one or more anionic surfactants, one or more cationic surfactants, one or more zwitterionic or amphoteric surfactants, one or more nonionic surfactants, or any mixture or combination thereof, provided that the surfactants are water soluble or water miscible at the concentration used in specific formulations; or
any combination thereof.

16. The composition of claim 15, wherein:
the FR additive composition may be present in an amount between about 0.1 wt. % to about 6 wt. % based on the weight of the WB-FR slurry composition; and/or
the FR surfactant compositions may be present in an amount between about 0.1 wt. % to about 5 wt. % based on the weight of the WB-FR slurry composition.

17. The composition of claim 16, wherein the WB-FR slurry composition may be designed to: (a) minimize a fluid frictional drag or a percentage of drag reduction (% DR) for a given downhole fluid composition under given downhole conditions; (b) optimize a fluid frictional drag or a percentage of % DR for a given downhole fluid composition under given downhole conditions; (c) achieve and/or maintain a fluid frictional drag or a percentage of % DR for a given downhole fluid composition under given downhole conditions; (d) provide environmentally friendly WB-FR slurry compositions; (e) provide biodegradable WB-FR slurry compositions; (f) reduce, decrease, or eliminate hydration of the DP-WS-FR polymers during production, storage, and transportation; (f) reduce or decrease hydration rates of the DP-WS-FR polymers during production, storage, and transportation; (g) achieve and/or maintain laminar flow as a downhole fluid is pumped into the wellbore and/or into one or more subterranean oil and/or gas bearing formations; (h) minimize turbulent eddies that are created at interior surfaces of the tubing through which a downhole fluid composition fluid is pumped; (i) achieve and/or maintain laminar flow as a downhole fluid is circulated in the wellbore while drilling; (j) minimize turbulent eddies that are created at interior surfaces of the drilling string through which a downhole fluid composition fluid is circulated; (k) provide an easier production process as temperature control in not generally an issue; (l) provide lower cost WB-FR slurry compositions; or (m) any combination thereof.

18. A downhole fluid composition comprising:
a downhole base fluid,
a downhole fluid additive composition including a treating fluid composition or a drilling fluid composition, and
a slurry effective amount of a WB-FR slurry composition of claims 1, 2, 3, 4, 5, 6, 7, 8, 9, 10, 11, 12, 13, 14, or 15,
wherein the effective amount is sufficient to reduce fluid friction of the downhole fluid composition as it is pumped from the surface through a tubular apparatus and into a subterranean oil and/or gas bearing formation or as it is circulated through a drill string while drilling into a subterranean oil and/or gas bearing formation, and
wherein the FR salt composition or the FR salt composition and the reduce or prevent hydration of the DP-WS-FR polymer composition during the WB-FR slurry composition production, storage, and transportation.

19. The composition of claim 18, wherein the WB-FR slurry composition is present in a treating fluid composition or a drilling fluid composition in an amount between about 0.1 gpt and about 100 gpt, between about 0.1 gpt to about 75 gpt, between about 0.1 gpt to about 50 gpt, between about 0.1 gpt to about 25 gpt, between about 0.1 gpt to about 20 gpt, between about 0.1 gpt to about 15 gpt, between about 0.1 gpt to about 10 gpt, between about 0.1 gpt and about 5 gpt, between about 0.1 gpt and about 4 gpt, between about 0.1 gpt and about 3 gpt, between about 0.1 gpt and about 2 gpt, or between about 0.1 gpt and about 1 gpt.

20. The composition of claim 19, wherein the treating fluid composition includes one or more proppants present in an amount between about 0.05 ppg to about 12 ppg, between about 3 ppg and about 10 ppg, between about 0.1 ppg and about 0.5 ppg, between about 0.5 ppg and about 1.0 ppg, between about 1.0 ppg and about 2.0 ppg, between about 2.0 ppg to about 3.0 ppg, between about 3.0 ppg and about 4.0 ppg, between about 4.0 ppg to about 5.0 ppg, between about 5.0 ppg and about 6.0 ppg, between about 6.0 ppg and about 7.0 ppg, between about 7.0 ppg and about 8.0 ppg, between about 8.0 ppg and about 9.0 ppg, or between about 9.0 ppg and about 10 ppg.
